(19) United States
(12) Patent Application Publication
(10) Pub. No.: US 2022/0245109 A1
(43) Pub. Date: Aug. 4, 2022

(54) Methods and systems for state navigation

(71) Applicant: Hamid Hatami-Hanza, Thornhill (CA)

(72) Inventor: Hamid Hatami-Hanza, Thornhill (CA)

(73) Assignee: Hamid Hatami-Hanza, Thornhill, ON (CA)

(21) Appl. No.: 17/574,263

(22) PCT Filed: Jul. 20, 2020
(86) PCT No.: PCT/CA2020/051000

§ 371 Date: Jan. 12, 2022

Related U.S. Application Data
(60) Provisional application No. 62/876,753, filed on Jul. 21, 2019.

(51) Int. Cl. G06F 16/22; G06N 7/00

(52) U.S. Cl. CPC G06F 16/22; G06N 7/005

(57) ABSTRACT

Methods and systems are given to build and enable systems to acquire knowledge from bodies of data in order to become capable of showing sane, rational, and credible behavior or output. Such systems includes software and/or hardware artifacts and/or stationary or mobile machines such as vehicles, robots, transportation systems, and in general systems with intelligent state-navigation capabilities. Aspects of this disclosure are to provide technical frame- works, methods, and systems to build artificially intelligent beings with explainability and interpretability.

### CROSS-REFERENCED TO RELATED APPLICATIONS

The present application is a U.S. National Stage Application of International Patent Application No. PCT/CA2020051000 filed on Jul. 20, 2020, which claims priority to, and the benefit of, the U.S. provisional patent application No. 62/876,753 filed on Jul. 21, 2019, entitled “Methods And Systems For State Navigation”, the disclosure of both of which are incorporated herein by reference hereby in entirety.

### FIELD OF INVENTION

This invention generally relates to information processing, knowledge discovery, artificial general intelligence, and in one aspect relates to autonomous mobile systems and machines such as vehicles, robots, and transportations systems.

### BACKGROUND OF THE INVENTION With the recent advent of artificial intelligence and the resulting applications therefrom, systems with broader intelligent capabilities are desired.

### SUMMARY OF THE INVENTION

Current intelligent systems, and autonomous/automated machines in particular, using current machine learning technologies, are still lacking an efficient, robust, sane, interpretable, explainable, and dependable operations and navigation in physical or data/state/decision spaces.

Therefore, there is a need to enhance the art of artificial intelligence in general and, for instance, autonomous navigation in particular, with more robust, dependable, efficient, and interpretable methods than the current machine learning technologies.

Accordingly, in this disclosure we introduce novel concepts, formulations, algorithms, systems and frame-work/s to make knowledgeable machines which are implemented in several embodiments to make machines of higher utilities without the shortcomings of the current machine learning and artificial intelligence practices and technologies.

Moreover, according to one or more embodiments of current disclosure, intelligent systems of interest in the industry and people's life such as, decision making, autonomous systems, autonomous moving systems, content generation, control systems, question answering, knowledge discovery, investigation of bodies of knowledge/data, are modeled, architectured, and implemented as systems comprising at least one state navigator, in which the systems will respond in various forms in response of an input query or set of data in which a machine or a system changes its state from a current state to a next or a future state. Methods are given to enable the systems to navigate through spaces either physical spaces and/or a state space.

We follow the definitions, given in the definition section of the detailed description of this disclosure, to become able to deal with all types of different data of different nature that we call them state components of a state space, or state components of a system of knowledge, or state components of a body of knowledge, or state components of a body of data, or state components of a universe of state navigation. Also in general we call a body of data as a “composition of state components”. In the preferred embodiments of the current disclosure, for efficiency and ease of implementation of teachings of the invention, state components are grouped in different sets each set is assigned with a predefined order.

In one preferred embodiment of the current disclosure, the state components of an intelligent system (i.e. state components of a body of knowledge, state components of a composition, state components of a universe corresponding to a composition) is a vector which is corresponded to a column of a participation matrix as will be described in details in the detailed descriptions.

According to one aspect and embodiment of the current invention/s we argue that state navigation is a complete and general case of intelligent actions for which this disclosure aims to address and give one or more solutions, methods, and systems.

In another aspect of present invention, methods, mathematical models, and algorithms are given to make a machine become knowledgeable, skillful, and almost conscious of its surrounding and become able to make sound decisions on its own. Accordingly, methods are given for teaching, training, or educating and building such machines

In another aspect methods are given to enable the machines to interact with human users, more readily, and/or be controllable by human when needed.

Yet in another aspect methods and systems are given for visual characterization, object recognition, and automatic descriptions of visual scenes.

According to another embodiment of the present invention methods are given to particularly enable and build knowledgeable mobile machines capable of making autonomous decisions which are rational, stable, interpretable, predictable, and can navigate through the space and places.

According to another aspect of the teachings of the present invention any composition of state components is viewed as an unknown system or system of knowledge from which valuable knowledge can be learnt or extracted by investigation of such compositions. The purpose of the investigation is to obtain as much information and knowledge, about such an unknown system, as possible.

The present invention therefore investigate the “compositions of state components” or a “body” or a “system of knowledge” (as is called from time to time in this disclosure) by providing the investigation methods for identifying the most significant constituent state components for a given body of knowledge or the given compositions in respect to one or more significance aspect/s. The significance aspects generally include the “intrinsic significance aspects” and/or “associational/relational significance aspects”. These measures are called “value significance measures” (VSM/s in short), “association strength measures” (or ASM for short), “relational/associational” type measures, and various combinations of them (referred herein as XY_VSM in general form) that are used to find and spot the aspectual significant parts or partitions of the composition for further investigation and/or further processing and/or presentation to a client.

According to one general embodiment of the disclosed methods of the present invention, a composition of state components or a body of knowledge is break down to its constituent state components and labeled/assigned with different orders, from which one or more array of data, respective of the information of the participations of the constituent state components of different orders into each other, are formed. The data therefore is used to evaluate various “value significance” values of the constituent state components of the different order according to the disclosed measures of various aspects of significance.

Accordingly, in one aspect of the present invention, measure/s are given for valuation of value significances of the state components of the composition based on their significance role which is calculated from the participations pattern/s of the state components of the composition.

In another aspect various measures of association strength are given from which the relations of state components of the composition can be revealed. Algorithms and formulations and calculation methods are given to evaluate such association strength according to various exemplary association aspects.

According to another aspect of the invention, we also put a value of significance on each SC based on the amount of information that they contribute to the composition and also by the amount of information that composition is giving about the SCs. Several forms of conditional occurrence probabilities of state components of the compositions are also computed which are used for state navigation and state projections.

According to another aspect of the present invention measures are given for evaluating the “causal association strengths” of the state components of different orders to each other or to one or more target state component. The causal association strengths are instrumental in knowledge discovery, evidence based decision making, as well as navigating a system's state into space in an interpretable manner. These measures are also very instrumental in estimating an optimal state-action for an autonomous system.

According to another aspects of the present inventions, methods and systems are disclosed for state navigation by a system.

According to another aspect of the present inventions, methods and system are disclosed for investigation of visual compositions in order to detect, recognize, and classify visual objects and make pluralities of standard data objects corresponding to or representing a plurality of visual objects.

In another aspect of the present invention, knowledge retrieval, question answering, and utterances and man-machine conversation is modeled as a space navigating instance. The knowledge is gained from a body of knowledge which is considered as sequences of state components of body of knowledge and relationships that is discovered by the teachings of the current invention is used to effectively communicate with other agent in a manner which is credible, context aware, informative, and having high degree of relevancy. Furthermore a coupled-mode utterance model is disclosed for continues natural conversation during a converse session. The conversation can be aimed at one or more various conversation objectives such as conversation to reveal new knowledge, educational conversation, entertaining conversation and the like using various association strength measures between the state components of one or more system of knowledge. For instance an entertaining conversation session can be initiated between machine and a human client by accessing to and investigating/learning from a body of knowledge comprising a large collections of movie scripts or a corpus of novels written by well-known writers. Further, the exemplary systems of the current disclosure, can learn, through exercising the teaching of current invention, the intricacies and relationships and utterance structures of a spoken natural language such as English language. Similarly, in another instance, a conversation session can be initiated for medical related knowledge discovery and knowledge retrieval using a system of knowledge comprised of corpuses of medical literature and so on.

According to another aspect of the present invention measures are given for evaluating the “relational association strengths” of the state components of different orders to each other or to one or more target state component.

According to another aspect of the present invention measures are given for evaluating the “relational value significances” of the state components of different orders to each other or to one or more target state component.

According to another aspect of the invention, various measures are given to evaluate the “novelty value significances” of the state components of the composition or the body of knowledge. Method/s are, therefore, given for efficient calculations, processing, and presentation of the results.

According to yet another aspect of the invention various measures of the “relational novelty value significances” are given for evaluating novel value significance in relation to one or more target state components of the composition or the body of knowledge.

According to yet another aspect of the invention various measures of the “associational novelty value significances” are given for evaluating novelty value significance in relation to one or more target state components of the composition or the body of knowledge.

According to yet another aspect of the invention various measures of the intrinsic “novelty value significances” are given for evaluating novel value significance in relation to one or more target state components of the composition or the body of knowledge.

In another aspect the novelty value is assigned to a predetermined list of state components (e.g. some special words that usually are used to express a novelty or a reasoning or concluding remarks, such as ‘therefore, consequently, in spite of, however, but, and the likes.) These are called special significance conveyers to amplify or dampen the significances of such special SCs of a composition in the final output or result.

Furthermore, specific examples and general forms and methods are given as how to synthesize a desired from of a value significance measure and how to build and calculate the respective filter for that value significance measure by combining one or more of the vsm vectors of one or more types. These various “value significance measures” then can be employed in many applications and generally the applications with space navigation modelling, for which at least one aspectual significance measure is of interest and importance.

Along the present disclosure, using the participation information of one more sets of lower order SCs into one more sets of the same or higher order SCs, the present invention provide a unified method and process of investigating the compositions of state components, modeling an unknown system, and obtaining as much worthwhile information and knowledge as possible about the system or the composition or the body of knowledge. The obtained knowledge and the derivatives data objects from the body of knowledge or the composition state components then are used in various embodiments to yield practical knowledgeable systems which, for example, can navigate and project through state spaces.

### BRIEF DESCRIPTION OF THE DRAWINGS

FIG. 1: shows one exemplary block diagram of a system or a software artifact that generates various outputs from a body of knowledge or a composition according to one embodiment of the present invention.

FIGS. 1a and 1b: illustrate the concept of compositions as attempts to describe their universes: FIG. 1a, shows the interne as one composition (the largest) trying to describe our universe, and FIG. 1b, shows that any other composition can also be viewed as an attempt to describe a smaller universe, i.e. its own universe.

FIG. 2: shows one exemplary illustration of the concept of association strength of a pair of SCs according to one embodiment of the present invention.

FIG. 3: shows one exemplary embodiment of a directed asymmetric network or graph corresponding to a composition of state components.

FIG. 4: shows a block diagram of one preferred embodiment of the method and the algorithm for calculating a number of exemplary “Value Significance Measures” of different types for the state components of a composition according to one embodiment of the present invention.

FIG. 5: shows one exemplary block diagram of the method and the algorithm of building the State component Maps (SCM) from the Association Strength Matrix (ASM) which is built for and from an input composition according to one embodiment of the present invention.

FIGS. 6a, 6b, 6c, show the exemplary values and one way of representing the values of the different conveyers of the different types of the “value significance measures”.

FIG. 7: shows one exemplary instance of implementing the formulations and algorithm/s illustrating one way of using the “participation matrix” (PM) and the “association strength matrix” (ASM) to calculate two different types of the associations strength of the SCs of order 2 to the SCs of the order 1, according to one embodiment of the present invention. This figure is to demonstrate the use of various VSM vectors (filters) in the calculations.

FIG. 8: is an schematic view of the system and method of building at least two participation matrixes and calculating VSM for lth order partition, SC^{l}, to calculate the “Value Significance Measures” (VSM) of other partitions of the compositions, SC^{l+r}, and storing them for further use by the application servers according to one embodiment of the present invention.

FIG. 9: a block diagram of an exemplary application and the associated system for ranking, filtering, storing, indexing, clustering the crawled webpages from the internet using “Value Significance Measures” (VSM) according to one embodiment of the present invention.

FIG. 10 is an exemplary system of investigating module for investigation of composition of state components providing one or more desired result/data/output according to one embodiment of the present invention.

FIG. 10-1 is an exemplary application of the current disclosure in investigation and navigation of news content.

FIG. 11: is a block diagram of an exemplary application for investigation of a body of data or knowledge corresponding to a collection state positions of a system in a predefined state space or state universe.

FIG. 12: is another exemplary system of using the investigator of a body of data or knowledge corresponding to a collection of state positions of a system in a state space or state universe, further having a module or having access to a module which provide contextual data for a given state, according to the present invention.

FIG. 13: is another exemplary system of using the investigator of a body of data or knowledge corresponding to a collection of state positions of a system in a predefined state space or state universe, further having a module or having access to a module which provide contextual data for a given state and one or more visual data investigators further providing contextual data for the given state of the system, according to the present invention.

FIGS. 14-a and 14-b shows an exemplary embodiment of collecting and assembling a body of data from a driven vehicle at time steps wherein the vehicle is equipped with various sensory, processing, control, and communication devices. Data gathered or recorded at any time step tᵢ is considered as a state component with a predefined order of l, ie. SCᵢ^{l}.

FIGS. 15-a and 15-b: An exemplary illustration of a body of data or knowledge corresponding to states of a system partitioned over a time sequence and illustrates how this string of data is partitioned to build the corresponding participation matrixes, according to one embodiment of the present.

FIG. 16 shows high level process flow of preparing/building the instrumental data objects, from a body of knowledge corresponding to the state components of a composition or a body of data, for investigation, state transitioning, and space navigation.

FIGS. 17-1 and 17-2: describes stages of knowledge extraction, state estimation, and optimal state navigations.

FIG. 18: shows a block diagram of a system for investigation of a Body of knowledge (BOK) comprising one or more collections of images and learn about existence of real world objects from the images by employing the investigation methods of the present invention to identifies and/or classifies and/or clustered and/or building secondary sets/list group of partitions and their corresponding representation data objects, corresponding to the whole and/or newly found partitions of the BOK and storing them in a knowledge base to be used or consulted by other agents, for instance, for identifications of objects in visual compositions such as images or movie frames.

FIG. 18-1: shows schematically one exemplary illustration of how to partition an image into its constituent visual state components (VSC) of different orders according to one exemplary embodiment of the present invention.

FIGS. 18-2 to 18-4: further illustrates, graphically, the operation of investigation system of FIG. 16 and showing the concepts of primary and secondary partitioning, corresponding secondary data objects, and what the knowledge base of the system of FIG. 16 is storing, as a knowledge of the real world, learned from investigating a body of knowledge of collection of images, according to exercising one exemplary embodiment of the investigation system/s of bodies of knowledge of the present invention.

FIG. 19: shows an exemplary application and realization of the disclosed method/s using a neural network in which the connection weight between neurons is adjusted using the various association strengths measures/values according to the teaching of this disclosure.

FIGS. 20-1, 20-2 shows the concept of coupled utterance model wherein two agents enter into a conversation and navigate through various discourses while keeping/navigating the context along the conversation.

### DETAILED DESCRIPTION

A system of knowledge, here, means a composition or a body of knowledge or a body of data (as will be referred from time to time) in any field, narrow or wide, composed of data symbols such as alphabetical/numerical characters, any array of data, binary or otherwise, or any string of characters/data etc.

As defined along this disclosure, the constituent parts of the bodies of knowledge are called “State Components” (SCs). The state components further are grouped into different sets assigned or labeled with orders as will be explained in the definition of section of this disclosure.

An example of a body of knowledge, according to the given definitions, is a picture or a video signal. A picture or a video frame consists of colored pixels that have participated in a picture to form and convey the information about the picture. Apparently some colored pixels of the picture are more significant in that picture. Moreover their combination or the way or the pattern that they participate together in any small parts or segments of that picture are also important in the way the pixels are conveying the information about the picture to an observer's eyes or a camera.

Yet example of a composition or a body of knowledge could be a string of genetic codes, a DNA string, or a DNA strand, and the like.

Moreover any system, simple or complicated, can be identified and explained by its constituent parts and the relation between the parts. Additionally, any system or body of knowledge can also be represented by network/s or graph/s that shows the connection and relations of the individual parts of the system. The more accurate and detailed the identification of the parts and their relations the better the system is defined and designed and ultimately the better the corresponding tangible systems will function. Most of the information about any type of existing or new systems can be found in the body of many textual compositions. Nevertheless, these vast bodies of knowledge are unstructured, dispersed, and unclear for non-expert in the field.

The present invention is to investigate such bodies of knowledge for various practical purposes. Moreover as will be explained we consider a body of knowledge as a composition of state components of different orders and the system of knowledge is viewed as the navigation trajectories of one or more of state components (possibly of different order) in a state space. Knowing or finding out how and/or when and/or why a state component of particular order is moved from one point (a set of state component of particular order can form a state space and a point in a state space/s is a state component of body of data having a predefined order) to another point, enables us to build machines that can navigate through such space reliably and rationally.

The purpose of the investigation is to model and gain as much information and knowledge about an unknown system comprised of state components while at least one source of the information about such a system is a given composition of state components wherein the composition is readable by a computer. Therefore, some information about such an unknown system is supposedly embedded in a body of knowledge or system of knowledge or generally in the given composition. The investigator, hence, will have to be able to capture or produce as much knowledge about the system from the information in the given composition.

Consequently, according to the present disclosure, the investigation is performed according to at least one important aspect in the investigation of bodies of knowledge (i.e. compositions).

The “important aspects of the investigation”, can, for example, be one or more of the following objectives:

1. identifying and recognizing the most significant constitutes parts of the bodies of knowledge according to at least one “significance aspect”,

2. identifying the associated constituent parts of the bodies of knowledge, and

3. identifying and/or finding (through discovery and/or reasoning) the informative constituent parts and informative combinations of the constituent part of the composition by, for example, finding or composing the expressions that show a relationship between two or more of constituent parts of the bodies of knowledge; and

4. building a knowledgeable system which can navigate through state space in response to an input/query.

Each of these “important aspect” or stages (1, 23, and 4 in the above) of the investigation, of course, can further be break down to two or more stages or steps or be combined together to perform a desirable investigation goal or to define the “investigation important aspect”.

Therefore depends on the goal of the investigation the “investigation important aspect” can be defined and performed in more detailed processes. The present invention gives a number of such investigation goals and the methods of achieving the desired outcome. Moreover, the present invention provides a variety of tools and investigation methods that enables a user to deal with the task of investigations of compositions of state components for any kind of goals and any types of the composition.

The “significance aspects”, based on which the significances of the SCs of compositions are defined and calculated, are various that can be looked at. For instance one “significance aspect” could be an intrinsic significance of an SC which shows the overall or intrinsic significance of an SC in a body of knowledge. Another significance aspect can be considered to be a significant aspect in relation or relative to one or more of the SCs of the body of knowledge.

Yet another significance aspect is considered to be an intrinsic novelty value of a SC in a body of knowledge or a composition. And yet another significance aspect is defined as a relative or relational novelty value of a SC related to one or more of the SCs of the body of knowledge or a composition.

Many other desirable significance aspects might be defined by different people depends on the application and the goal of the investigation of a composition or body of knowledge. Also any combinations of such significance aspects can be regarded as a significance aspect.

Accordingly a “significance aspect” is the orientation that one can use to reason on how to put a significance value on a state component of a composition or a body of knowledge.

In other words, a significance aspect is a qualitative quality that can polarize or differentiate the state components and be used to define value significance measures and consequently suggest or construct various value functions or significance weighting functions on the state components of a composition or a body of knowledge.

These functions, individually or in combination, therefore can be employed and utilized to spot and/or filter out one or more state components of a composition or a body of knowledge for different purposes and applications or generally for investigation of bodies of knowledge.

For instance, in accordance with one aspect of the present disclosure for investigation of the compositions of state components, a general form of evaluating “value significances” of the state components of a composition or a body of knowledge or a network is given along with a number of exemplified such value significances and their applications.

Furthermore exemplary algorithms and systems are given to be used for providing the respective data and/or such application/s as one or more services to the computer program agents as well as human users.

As will be explained in next section, having constructed one or more data structures (e.g. arrays of data) indicative of relations of constituent part, it will become necessary and desirable to spot the significant part and/or separate the parts that their significance is defined in relation to a target part. Thereby relational value significances are defined here. The relational value significances are instrumental in clustering a collection of compositions or clustering partitions of a composition in regards to one or more of a target SC or the parts of the system of knowledge.

Such a method will speed up the research process and knowledge discovery, and design cycles by guiding the users to know the substantiality of each part in the system. Consequently dealing with all parts of the system based on the value significance priority or any other predetermined criteria can become a systematic process and more yielding to automation.

Applications of such methods and systems would be many and various. For example let's say after or before a conference, with many expert participants and many presented papers, one wants to compare the submitted contributing papers, draw some conclusions, and/or get the direction for future research or find the more important subjects to focus on, he or she could use the system, employing the disclosed methods, to find out the value significance of each concept along with their most important associations and interrelations. This is not an easy task for the individuals who do not have many years of experience and a wide breadth of knowledge in the respective domain of knowledge.

Or consider a market research analyst who is assigned to find out the real value of an enterprise by researching the various sources of information. Or rank an enterprise among its competitors by identifying the strength and weakness of the enterprise constituent parts or partitions.

Many other consecutive applications such as searching engines, summarization, distillation, etc. can be performed, enhanced, and benefit from having an estimation of the value significance of the partitions of the body of knowledge and a thorough investigation method of such compositions.

A particular case of interest in this disclosure is system of knowledge composed of various types of data and symbols which is gathered by an artisan to use as training or learning material to build autonomous machines of high utility such as autonomous moving robots (e.g. a self-driving car). As described in the next section such system of knowledge or body of data is gathered . . . for instance through recording all types of sensory data, control data, environmental data, visual data command data, conversation, and natural language text or speeches and all types of such conceivable and desired forms of data that are present or relevant during the course of data recording and gathering. For instance one may desire to gather all such data from a car which is driven by one or more human drivers and collect the data, as exemplified, during a 1000 hours derive in various situations, context, environments, etc.

Obviously such body of data can be gathered from many different derivers and cars and, as a result, a really humongous body of data can be gathered.

The current disclosure teaches how one can use these immense data to enable a moving robots, such as a car, derive autonomously by knowing the knowledge of the world and universe and can move from one state to another state along the time (i.e. navigating through its state space to become able to navigate in the physical space-time as we expect from human driven car, or a human).

Basically all such systems of knowledge or data, therefore, can be viewed as sequences of state descriptions (technically a state vector in a multidimensional space which is almost always a Hilbert space) regardless of type and form of the actual data.

Moreover in modern real life we have to deal with mixtures of different types of data (textual, numerical, visual, etc.) all in one body of data or as we prefer one body of knowledge. Formulating and conceiving effective and useful solution to utilize such complex data both in types and nature and in terms of volume become very tedious and not easy to implement or comprehend by an artisan.

In practice name-spacing and naming computer readable objects has a great impact on the complexity of a software artifact which consequently impact the complexity of the hardware that is coupled with or utilizes such software. Any unnecessary complexity contribute to lower the reliability and stability of the realized system.

For instance one may prefer to refer to all of these data as a “data” or “dataset/s” but we found that these commonly used terms because of their history and legacy quickly can make people confused about the meaning of the data and its instances. As an example, one may have difficulty to realize that a textual string is also a type of data or specifications of a feature of a data space is also a data. Things can get confusing for an artisan especially in the field of computer related industry and products and technology because the term data has been used for many things interchangeably and wherein sometimes they have clear definitions and sometimes they do not. Many terms (e.g. the word “term” itself) have been defined along the history which their interpretation only become clear in a narrow context of specialized domain knowledge.

The current disclosure on the other hand, in its preferred embodiments, is about identifying knowledge, gain knowledge and process knowledge through investigation of large bodies of data and not merely interested in processing data for processing data.

Therefore, we realized that (like any other new or novel fields of science and technology) we have to act as own lexicographer and define our terminology and invent our own name-spacing in order to enable an artisan to practice the teachings of this disclosure.

Accordingly the definitions, here, are not intended to be philosophical nor abstract but to unify the methods and formulations for the practical and tangible, applications, systems, operations, and data storages carrying instrumental data about certain subject or areas of importance to human life.

Now in order to describe the disclosure in details we first define a number of terms that are used frequently throughout this description. For instance, the information bearing symbols are called “State Components” and are defined herein below, along with others terms, in the definitions sections.

### I—Definitions

1. STATE COMPONENT: symbol or signal referring to a thing (tangible or otherwise) worthy of knowing about. Therefore State Component (SC) means generally any string of characters, but more specifically, characters, letters, numbers (e.g. integer, real or complex, Boolean, binary, etc.), words, binary codes, bits, mathematical functions, sound signal tracks, video signal tracks, electrical signals, chemical molecules such as DNAs and their parts, or any combinations of them, and more specifically all such string combinations that indicates or refer to an entity, concept, quantity, and the incidences of such entities, concepts, and quantities. In this disclosure State Component/s and the abbreviation SC or SCs are used interchangeably.

2. ORDERED STATE COMPONENTS: State Components (or SCs) can be divided into sets with different orders depends on their length, attribute, and function. Basically the order is assigned to a group or a set of state components usually having at least one common predefined attribute, property, attribute, or characteristic. Usually the orders in this disclosure are denoted with alpha numerical characters such as 0, 1, 2, etc. or with alphanumerical characters as superscripts of an state component (e.g. an SC of order one is denoted by SC¹, and an SC of order two is denoted by SC² and the like) etc. or any other combination of characters so as to distinguish one group or set of state components, having at least one common predefined characteristic, with another set or group of state components having another at least one common characteristic. This order/s will also be reflected in denoting/corresponding the data objects or the mathematical objects in the formulations of the present invention to distinguish these data objects in relation to their corresponding state component set or its order, as will be used and introduced throughout this disclosure. For instance, for state components of textual nature, one may characterize or label letters as zeroth order SC, words or multiple word phrases as the first order, sentences or multiple word phrases as the second order, paragraphs as the third order, pages or chapters as the fourth order, documents as the fifth order, corpuses as the sixth order SC and so on. As seen the order can be assigned to a group or set of state components usually based on at least one common predefined characteristic of the members of the set. So a higher order SC is a combination of, or a set of, lower order SCs or lower order SCs are members of a higher order SC. Equally one can order the genetic codes in different orders of state components. For instance, the 4 basis of a DNA molecules as the zeroth order SC, the base pairs as the first order, sets of pieces of DNA as the second order, genes as the third order, chromosomes as the fourth order, genomes as the fifth order, sets of similar genomes as the sixth order, sets of sets of genomes as the seventh order and so on. Yet the same can be defined for information bearing signals such as analogue and digital signals representing audio or video information. For instance for digital signals representing a signal, bits (electrical One and Zero) can be defined as zeroth order SC, the bytes as first order, any sets of bytes as third order, and sets of sets of bytes, e.g. a frame, as fourth order SC and so on. Yet in another instance for a picture or a video frame, the pixels with different color can be regarded as first order SC (the RGB values of a pixel can be regarded as zeroth order SCs), a set whose members contain two or more number of pixels (e.g. a segment of a picture) can be regarded as SCs of second order, a set whose members composed of two or more such segments as third order SC, a set whose members contain or composed of two or more such third order SCs as fourth order SC, a whole frame as fifth order SC, and a number of frames (like a certain period of duration of a movie such as a clip) as sixth order and so on. Therefore definitions of orders for state components are arbitrary set of initial definitions that one can stick to in order to make sense of the methods and mathematical formulations presented herein and being able to interpret the consequent results or outcomes in more sensible and familiar language. Each state component therefore can be denoted with its order and its index in the set or the list of state components of same order. For instance SCᵢ^{k} refers to ith member or ith state component of the set of state components of order k.

More importantly State components can be stored, processed, manipulated, and transported by transferring, transforming, and using matter or energy (equivalent to matter) and hence the SC processing is an instance of physical transformation of materials and energy.

3. STATE: a state component composed of one or more lower order state components. Usually the state refers to the higher order state component in a given set/s of state components. Therefor state can be defined and/or selected from one or more state components. For instance a state of a system of knowledge (e.g. a body of data) maybe defined as a set of lower order state components of the system of knowledge with highest number of members (i.e. the largest set of SCs of the system.)

4. STATE TRANSITION: state transition refers to one or more changes (e.g. replacement of a lower order SC with another lower order SC of a higher order SC, deleting a SC, adding a SC, and any combination of these operations) in a constituent lower order state components of a of higher order state component.

5. COMPOSITION: is an SC composed of constituent state components of lower or the same order, particularly text documents written in natural language documents, genetic codes, encryption codes, a body of data, numerical values, and strings of numerical values, data files, voice files, video files, and any mixture thereof. A collection, or a set, of compositions is also a composition. Therefore a composition is in fact a State Component of particular order which can be broken down to lower order constituent State Components. One preferred exemplary composition in this description, for the ease of explanation is a set of data objects containing state components, for example a webpage, papers, documents, books, a set of webpages, sets of PDF articles, multimedia files, or even simply words and phrases. Moreover, compositions and bodies of knowledge are basically the same and are used interchangeably in this disclosure. A composition is also an state according the definitions above. Compositions are distinctly defined here for assisting the description in more familiar language than a technical language using only the defined SCs notations.

6. PARTITIONS OF A COMPOSITION: a partition of a composition, in general, is a part or whole, i.e. a subset, of a composition or a collection of compositions. Therefore, a partition is also a State Component having the same or lower order than the composition as an SC. More specifically in the case of textual compositions, parts or partitions of a composition can be chosen to be characters, words, phrases, any predefined length number of words, sentences, paragraphs, chapters, webpage, documents, etc. A partition of a composition is also any string of symbols representing any form of information bearing signals such as audio or videos, texts, DNA molecules, genetic letters, genes, a state of a system in a moment of time, and any combinations thereof. However one preferred exemplary definition of a partition of a composition in this disclosure is a component of the state of a system, a state of a system (e.g. a vector in the state space of a system), or a number of states of the system under investigation or while running, and the like. Moreover partitions of a collection of compositions can include one or more of the individual compositions. Partitions are also distinctly defined here for assisting the description in more familiar language than a technical language using only the general SCs definitions.

7. SIGNIFICANCE MEASURE: assigning a quantity, a number, a feature, or a metric for a SC from a set of SCs so as to assist to distinguishing or selecting one or more of the SCs from the set. More conveniently and in most cases the significance measure is a type of numerical quantity assigned to a partition of a composition. Therefore significance measures are functions of SCs and one or more of other related mathematical objects, wherein a mathematical object can, for instance, be a mathematical object containing information of participations of SCs in each other, whose values are used in the decisions about the constituent SCs of a composition. For instance, “Relational, and/or associational, and/or novel significances” are one form or a type of the general “significance measures” concept and are defined according to one or more aspects of interest and/or in relation to one or more SCs of the composition.

8. FILTRATION/SUMMARIZATION: is a process of selecting one or more SC from one or more sets of SCs according to predefined criteria with or without the help of value significance and ranking metric/s. The selection or filtering of one or more SC from a set of SCs is usually done for the purposes of representation of a body of data by a summary as an indicative of that body in respect to one or more aspect of interest. Specifically, therefore, in this disclosure searching through a set of partitions or compositions, and showing the search results according to the predetermined criteria is considered a form of filtration/summarization. In this view finding an answer to a query, e.g. question answering, or finding a composition related or similar to an input composition etc. is also a form of searching through a set of partitions and therefore are a form of summarization or filtration according to the given definitions here.

9. UNIVERSES OF COMPOSITIONS AND STATE OF UNIVERSE: Universe: in this disclosure “universe” is frequently used and have few intended interpretation: when “universe x” (x is a number or letter or word or combination thereof) is used, it mean the universe of one or more compositions, that is called x, and contains none, one or more state components. By “real universe” or “our universe” we mean our real life universe including everything in it (physical and its notions and/or so called abstract and its notions) which is the largest universe intended and exist. Furthermore, “universal” refers to the real universe. Also we might use the term “state of universe” that is referring to the largest state components of the composition corresponded to the universe under investigation/navigation.

10. THE USAGE OF QUOTATION MARKS “ ”: throughout the disclosure several compound names of concepts, variable, functions and mathematical objects and their abbreviations (such as “participation matrix”, or PM for short, “Co-Occurrence Matrix”, or COM for short, “value significance measure”, or VSM for short, and the like) will be introduced, either in singular or plural forms, that once or more is being placed between the quotation marks (“ ”) for identifying them as one object (or a regular expression that is used in this disclosure frequently) and must not be interpreted as being a direct quote from the literatures outside this disclosure.

Furthermore, in the following description, numerous specific details are set forth in order to provide a thorough understanding of the present embodiments. It will be apparent, however, to ones having ordinary skill in the art that some of the specific detail need not be employed to practice the present embodiments. In other instances, well-known materials or methods have not been described in detail in order to avoid obscuring the present embodiments.

1. Reference throughout this specification to “one embodiment”, “an embodiment”, “one example” or “an example” means that a particular feature, structure or characteristic described in connection with the embodiment or example is included in at least one embodiment of the present embodiments. Thus, appearances of the phrases “in one embodiment”, “in an embodiment”, “for instance”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.
2. Embodiments in accordance with the present embodiments may be implemented as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present embodiments may take the form of a computer program product embodied in any tangible medium of expression having computer-usable program code embodied in the medium.
3. Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a solid state based storage devices (e.g. SSD, MVNe, etc.), a portable compact disc read-only memory (CDROM), an optical storage device, and a magnetic storage device. Computer program code for carrying out operations of the present embodiments may be written in any combination of one or more programming languages.
4. Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).
5. The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.
6. As used herein, the terms “comprises,” “comprising,” “includes,” “including,” “has,” “having,” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.
7. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).
8. Additionally, any examples or illustrations given herein are not to be regarded in any way as restrictions on, limits to, or express definitions of any term or terms with which they are utilized. Instead, these examples or illustrations are to be regarded as being described with respect to one particular embodiment and as being illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such no limiting examples and illustrations includes, but is not limited to: “for example,” “for instance,” “e.g.,” and “in one embodiment.”
9. The subject matter of the detailed description herein may be implemented, for instances, as computer-controlled apparatuses and machines, a computer process, a computing and data processing systems comprising one or more data processing or computing devices, or as an article of manufacture such as computer-readable storage medium.

Now the invention is disclosed in details in reference to the accompanying Figures and exemplary cases and embodiments in the following subsections.

### II—Description

In this disclosure we argue that any collection or forms of data or a system of knowledge can be viewed as movement of a system through a state space. Further it is argued that state components of any given real life body of data are interrelated whose type and specificity of the relations can be learned from the given body of data.

One goal of investigation of a body of data is to learn and extract the knowledge therein in order to utilize that knowledge to build or construct knowledgeable systems capable of, for instance, autonomously make decision, navigate through physical spaces or state spaces, and/or converse and communicate intelligibly with other agents or human.

This section of present invention discloses a systematic, machine implemented, process efficient and scalable method's of building, making, and operating knowledgeable machines for variety of tasks and, in a particular example, space (e.g. 4D space or state space) navigators and the corresponding autonomous moving systems with cognition/knowledge of real world.

To build machine of higher utility and services various methods of machine learning are employed. Currently people use and propose various form of machine learning which are mostly based on liner regression, logistic regression, support vector machines, and neural networks in general and deep learning in particular.

In this disclosure it is noticed and argued that all the current machine learning methods/algorithms/technologies and modeling/formulations can be shown to have their roots in the principal component analysis (PCA) of a data set (i.e. the training data) from which one tries to teach machines to perform some tasks which might be considered intelligible. Said practiced methods and technologies mostly involve classification, recognition of patterns, and prediction/suggestion/decision of some sort.

In performing principal component analysis (PCA) one need to calculate a covariance matrix corresponding to a collected data set. The covariance matrix is usually calculated after, preferably, normalizing the data set statistically, (e.g. assuming a normal distribution of values of independent variables (features) of the data set (or the training data) so that the mean of the distribution is zero and the standard deviation and/or its variance to unity). The aim of PCA therefore is to find distinguished principal vectors to form a new space with fewer dimensions than the original data set (the principal vectors ideally become the basis of this new space from which all the data points (data vectors) can be decomposed to).

While the PCA methods works well most of the time for small data sets and well-crafted features (the features or the dimensions of the space corresponding to the original data sets usually are hand crafted and already have a good clarity and contrast, although not as good as having a orthonormal basis) wherein each data point in its space convey as much information as they can. A good practice to build a good initial collection of data or dataset, for instance, is by designing the acquisition of experimental data using orthogonal arrays in advance. Accordingly for these types of data sets one cam usually find distinguished principal components which can convey most of the information of original data but in a space with fewer dimensions.

Technically, the principal components are the eigenvectors corresponding to the largest eigenvalues of said covariance matrix which were derived or made or calculated from raw original collection of data. The assumption is that principal components are distinguishable so that the interrelationships of the original data can be expressed in their terms clearly without losing much information. The aim obviously is to select few principal components that the information of the original collection of data can be efficiently and sufficiently expressed.

However, in building systems of substantial values (such as self-driving cars, natural language processing, medical diagnostics, crime investigations, knowledge discovery, autonomous machines with physical movements etc.) and problems or data sets of practical or real life situations with real values in practice, the data points and the dimensions of the data points space are very large (sometimes infinite). In these real life situations data points are crowded and have so many mutual dependencies making them hard to cluster them based on few components.

Accordingly, in this disclosure it is noticed and argued that the resultant covariance matrix of such collection/s of data looks like a matrix with random valued entries. The argument for this statement is intuitive. In fact when there are many components/elements/causes/associations that can affect a particular observation (i.g. a data point or a state vector in a state space) the covariance or correlations between these points should look like a data observed in random processes (refer to central limit theorem). This obviously leads to an inherent ambiguity and confusions that science has been facing all along its history. Moreover, the theoretical and mathematical proofs of possibility of learnability from such large datasets usually determine an upper limits which is usually beyond the reach of machines of reasonable processing power and therefore does not help or provide a guideline in practice.

As a/the result, the eigenvalues and eigenvectors of such matrix (a matrix with randomly distributed entries) are also random looking making it hard to select the principal components for such matrix resulting in rendering these methods ineffective in uncontrolled environments and real world situations. Therefore the PCA analysis for large data sets, or bodies of data, is not effective.

However no data is generated in real world out of the principle of inner working of our universe which seems to be consistent and according to some known and some unknown regularities but surely not of arbitrary (at least in macroscopic classical situations). Accordingly no real data is random, in its mathematical definitions, and all data of interest corresponding to some measureable variables (such as, for instance, temperature, pressure, gravity, electric field, control signals of an autonomous vehicle, or physiological states of human beings, or any other variable conceived important) are not random at all in principal. These values of such variables are in fact the parameters and quantities that we are seeking to observe and measure their significances. Therefore any prior assumption about these factors or variables, or state components as we call throughout this disclosure, is detriment to discovering the knowledge about true nature, significance and implications of such factors and their observed values.

Another popular approach toward machine learning and artificial intelligence in general is to use neural networks to perform some intelligible tasks. Neural networks building blocks are based on linear regression (e.g. the rule of perceptron) and logistics regression decision making which are trained by using large data sets (usually labeled by human). Linear regression involves optimization of a large number of unknown parameters in a predefined types of relationship that eventually can minimize an error or a cost function. The possibilities of fitting a regression function to reasonably fit both the training and testing of a large set of data are endless and the hypothesis set for such function is practically infinite. A network of combined linear regression blocks (e.g. a deep neural network) will have even a larger number of possibilities of combinations of such unknown parameters. A successfully trained neural network shows one of these possibilities that could satisfy the loss function objectives.

Moreover there cannot be found any rational architectural, design rules, and disciplines for implementation of such networks which in turn results in adding more ambiguity still. For the same reason, intelligent system based on deep learning neural networks works well by overfitting the neural networks in practice. An overfitting network can easily find itself in a state which is not desirable making the resulting systems unreliable and sometimes unstable with unknown consequences. Deep learning/neural networks alone, therefore, is not the right way in building mission critical and human life dependent machines. Moreover, training of neural networks of non-trivial values need a large body of annotated data which again make them costly, unpredictable in new situations, and unsuitable for many applications and computer-controlled systems and machines.

Use of Bayesian networks has also been suggested and promoted to be able to solve the challenge of building intelligent machines. Bayesian networks, and Bayesian inferences on the other hand works best if the feature, conditional probabilities, and related priori are provided by experts making the methods and Bayesian networks hard and expensive to adapt or be used in new situations. In constructing a Bayesian network corresponding to a data-set, each data-set has to be treated differently with complicated and twisted reasoning which again can potentially make the resulting system unreliable since errors in large Bayesian networks can propagate and give incorrect results and hence unintended consequences. So far there is no successful methods to utilize large data-sets or large bodies of data to build a Bayesian Network efficiently.

The implication, therefore, is that the current machine learning methods and so called artificial intelligence systems and algorithms are inherently limited in their effectiveness and capability to solve the problems aiming at achieving real intelligence.

Therefore, there is a need for some other fundamentally novel approaches toward achieving the goals of making machines intelligible. In this disclosure we argue that a true intelligent beings are knowledgeable and intelligence is a result of knowledge of the world either imbedded in the genes or learned through experience, education and/or training. In other words a true intelligent machines should be knowledgeable. To particularly make the machines knowledgeable alternative ways of extracting knowledge from a collection of data are needed in order to build knowledgeable machines capable of performing tasks which requires degrees of intelligence and specially if exhibiting general intelligence is desired.

The methods and systems of the present invention can further be used for applications ranging from document classification, search engine document retrieval, news analysis, knowledge discovery and research trajectory optimization, autonomous decision making and navigations, question answering, computer conversation, spell checking, summarization, categorizations, clustering, distillation, automatic composition generation, genetics and genomics, signal and image processing, to novel applications in economical systems by evaluating a value for economical entities, crime investigation, financial applications such as financial decision making, credit checking, decision support systems, stock valuation, target advertising, and as well measuring the influence of a member in a social network, and/or any other problem that can be represented by graphs and for any group of entities with some kind of relations or association.

Although the methods are general with broad applications, implications, and implementation strategies and technique, the disclosure is described by way of specific exemplary embodiments to consequently describe the methods, implications, and applications in the simplest forms of embodiments and senses.

According to the teachings of the present invention any compositions of state components is viewed as an unknown system or system of knowledge that the purpose of the investigation is to obtain as much information and knowledge about such an unknown system.

The present invention therefore investigate the “compositions of state components” or a “body of data” or a “body/system of knowledge” (as is called from time to time in this disclosure) by providing the investigation methods for identifying the most significant constituent state components and their relationships which are conceptualized by various “association strength measures” (ASMs) for a given body of knowledge or the given compositions in respect to one or more significance aspect/s.

In what follows the invention is described in several sections and steps which in light of the previous definitions would be sufficient for those ordinary skilled in the art to comprehend and implement the methods, the systems and the applications thereof.

We explain the method/s and the algorithms with the step by step formulations that is easy to implement by those of ordinary skilled in the art and by employing computer programming languages and computer hardware systems that can be optimized or customized by build or design of hardware to perform the algorithm efficiently and produce useful outputs and functionalities for various desired applications.

### II-I Participation Matrix Building for a Composition

Assuming we have an input composition of state components, e.g. an input text, the “Participation Matrix” (PM) is a matrix indicating the participation of one or more state components of particular order in one or more partitions of the composition. In other words in terms of our definitions, PM indicate the participation of one or more lower order SCs into one or more SCs of higher or the same order. PM/s are the most important structure of that carries the raw information from which many other important functions, information, features, and desirable parameters/metrics can be extracted. Without intending any limitation on the value of PM entries, in one exemplary embodiments of the current disclosure the PM is a binary matrix having entries of one or zero and is built for a composition or a set of compositions as the following:

1. break the composition to desired numbers of partitions. For example, for a text document, break the documents into chapters, pages, paragraphs, lines, and/or sentences, words, letters, characters etc. and assign an order number (e.g. 0,1,2,3 . . . etc) to one or more sets of similar partitions, i.e. the ordered state components,

2. select a desired N number of SCs of order k and a desired M number of SCs of order l (these SCs are usually the partitions of the composition from the step 1) according to certain preselected criteria, and;

3. construct a N×M matrix in which the ith raw (Rᵢ) is a vector (e.g. a binary vector), with dimension M, indicating the presence of the i^{th} SC of order k, (often extracted from the composition under investigation), in the SCs of order 1, (often extracted from the composition under investigation or sometimes from another referenced composition), by having a nonzero value, and not present by having the value of zero.

We call this matrix the “Participation Matrix” of the order kl (PM^{kl}) which can be represented as:

$${SC}_{1}^{l} … {SC}_{M}^{l} \\ {PM}^{kl} = \begin{matrix}{SC}_{1}^{k} \\ ⋮ \\ {SC}_{N}^{k}\end{matrix} ( \begin{matrix}{pm}_{11}^{kl} & … & {pm}_{1 M}^{kl} \\ ⋮ & ⋱ & ⋮ \\ {pm}_{N 1}^{kl} & … & {pm}_{NM}^{kl}\end{matrix} ) \qquad ( 1 )$$

where SCₚ^{k} is the p^{th} SC of the kth order (p=1 . . . N), SC_{q}^{l} is the q^{th} SC of the lth order (q=1 . . . M), and, according to one exemplary embodiment of this invention, PM_{pq}^{kl}≠0 if SCₚ^{k} have participated, i.e. is a member, in the SC_{q}^{l} and 0 otherwise. A desired criteria, in the step 2 above, can be, for instance, to only select the content words, certain values which is corresponded to a state components, or select certain partitions having certain length or, in another instance, selecting all and every word, values, or character strings and/or all the partitions.
The participating matrix of order lk, i.e. PM^{lk}, can also be defined which is simply the transpose of PM^{kl} whose elements are given by:

PM_{pq}^{lk}=PM_{qp}^{kl} (2).

Accordingly without limiting the scope of invention, the description is given by exemplary embodiments using the general participation matrix of the order kl, i.e the PM^{kl} in which k≤l.

Furthermore PM carries much other useful information. For example using binary PMs, one can obtain a participation matrix in which the entries are the number of time that a particular SC (e.g. a word) is being repeated in another partitions of particular interest (e.g. in a document) one can readily do so by, for instance, the following:

PM_R¹⁵=PM¹²×PM²⁵ (3)

wherein the PM_R¹⁵ stands for participation matrix of SCs of order 1 (e.g. words) into SCs of order 5 (e.g. the documents) in which the nonzero entries shows the number of time that a word has been appeared in that document (for simplicity possible repetition of a word in an SC of order 2, e.g sentences, is not accounted for here). Another applicable example is using PM data to obtain the “frequency of occurrences” of state components in a given composition by:

FOₗ^{k|l}=Σⱼpmᵢⱼ^{kl} (4)

wherein the FOₗ^{k|l} is the frequency of occurrence of SCs of order k, i.e. SCₗ^{k}, in the SCs of order l, i.e. the SC^{l}. The latter two examples are given to demonstrate on how one can conveniently use the PM and the disclosed method/s to obtain many other desired data or information.

More importantly, from PM^{kl} one can arrive at the “Co-Occurrence Matrix” COM^{k|l} for SCs of the same order as follow:

COM^{k|l}=PM^{kl}*(PM^{kl})^{T} (5),

where the “T” and “*” show the matrix transposition and multiplication operation respectively. The COM is a N×N square matrix. This is the co-occurrences of the state components of order k in the partitions (state components of order l) within the composition and is (as will be stated in next sections) one indication of the association of SCs of order k evaluated from their pattern of participations in the SCs of order l of the composition. The co-occurrence number is shown by comᵢⱼ^{k|l} which is an element/entry of the “Co-Occurrence Matrix (COM)” and (in the case of binary PMs) essentially showing that how many times SCᵢ^{k} and SCⱼ^{k} have participated jointly into the selected SCs of the order l of the composition. Furthermore, COM can also be made binary, if desired, in which case only shows the existence or non-existence of a co-occurrence between any two SC^{k}.

The importance of the “co-occurrence matrix” as defined in this disclosure is that it carries or contain the information of relationship and associations of the SCs of the composition which is further utilized in some embodiments of the present invention. Moreover, the frequency of occurrences and the co-occurrences is defined in view of event/s of interest. In other words the observation of participation of state components of certain order in state comments of higher order (the events). For example for investigation and knowledge extraction from textual body of data the co-occurrences of SCs of order one (e.g. words) is their participation, for instance, in composing sentences, i.e. the event of interest, here, is observation of a sentence.

It should be noticed that the co-occurrences of state components can also be obtained by looking at, for instance, co-occurrences of a pair of state components within certain (i.e. predefined) proximities in the composition (e.g. counting the number of times that a pair of state components have co-occurred within certain or predefined distances from each other in the composition. Similarly there are other ways to count the frequency of occurrences of a state components (i.e. the FOᵢ^{k|l}). However the preferred embodiment is an efficient way of calculating these quantities or objects and should not be construed as the only way for implementing the teachings of the present invention. The repeated co-occurrences of a pair of state components within certain proximities is an indication of some sort of association (e.g. a logical relationship) between the pair or else it would have made no sense to appear together in one or more partitions of the composition(i.e. in state components of higher order).

Those skilled in the art can store the information of the PMs, and also other mathematical/data objects of the present invention, in equivalent forms without using the notion of a matrix. For example each raw of the PM can be stored in a dictionary, or the PM be stored in a list or lists in list, or a hash table, or a SQL database, or NoSQL database, or binary files, or compressed data files, or any other convenient objects of any computer programming languages such as Python, C, Perl, Java, R, GO, etc. Such practical implementation strategies can be devised by various people in different ways. Moreover, in said one exemplary embodiment the PM entries (especially for showing the participation of lowest orders SCs of the composition into each other, e.g. a PM¹²) are binary for ease of manipulation and computational efficiency.

However, in some applications it might be desired to have non-binary entries so that to account for partial or multiple participation of lower order state components into state components of higher orders, or to show or to preserve the information about the location of occurrence/participation of a lower order SC into a higher order SCs, or to account for a number of occurrences of a lower SC in a higher SC etc., or any other desirable way of mapping/converting or conserving some or all of the information of a composition into one or more participation matrices. In light of the present disclosure such cases can also be readily dealt with, by those skilled in the art, by slight mathematical modifications of the disclosed methods herein without departing from the sprit and scope of the present invention.

Having constructed one or more of the participation matrix/es, denoted generally with PM^{kl}, we now launch to explain the methods of defining and evaluating the “value significances” of the state components of the compositions for various measures of significance. One of the advantages and benefits of transforming the information of a composition into participation matrices is that once we attribute something to the SCs of particular order then we can evaluate the merit of SCs of another order in regards to that attribute using the PMs. For instance, if we find words of particular importance in a textual composition then we can readily find the most important sentences of the composition wherein the most important sentences contain the most important words in regards to that particular significance/importance measure or aspect. Moreover, as will be shown, the calculations become straightforward, language independent and computationally very efficient making the method practical, accurate to the extent of information content of the composition, and scalable in investigating large volumes of data or large bodies of knowledge.

According to another embodiment of the present invention, autonomous mobile systems are systems comprising an array/set of sensory hardware generating a number of sets/vectors/strings of data corresponding to environmental data and/or any other desired sensory data as well as any other forms of data such as commands, conversations, textual data, signals, etc. and/or other desired data by accessing to knowledge repositories and/or through communication facilities which forms one or more sets of state components of predefined orders.

The movement of the autonomous objects then is modeled as series of events in time or transitioning of system state position into next position in the predefined state space of the system using the lower order state components of the system. By lower order state components or components of the state space we usually mean any type of data (sensory, controlling, commanding, visual, audio, encrypted strings, strings of characters, numerical values) and/or a content playing a rule in navigation of an autonomous system. Each of such events can be characterized, denoted, and/or being represented by a plurality of set of data of various nature. Moreover a set comprising combinations of one or more of such instances of lower order components (i.e. vectors of vectors) forms a set of higher order state components.

In here we notice that in any real system, autonomous or not, there could usually be fund one or more state components of certain order (themselves could be composed of state components of lower order) that play significant roles in navigating the system or the evolution of its trajectory in the so-called physical space-time domain. In other words usually certain state components of particular order and/or some state components of lower order play a dominant role in transitioning the system from one state to next state as time evolves and system moves from one position to another position in the defined state space.

These set of certain components of the state space make the autonomous system being stable and behave in a rational and predictable manner rather than seeming to act stochastically.

Therefor identifying this set of components of the state space becoming crucial to make the autonomous system capable of navigating through its state space in a rational and sane manner.

From this perspective, gathering and/recording all such data over time from an existing combined (i.g combined as combination of human operator with machines or carriers, computer etc.) autonomous system over a number of predefined time intervals (e.g. 1 micro seconds) we are able, in fact, to build a body of knowledge/data from which we can learn/deduce and derive many instrumental knowledge and the data that once are shared/accessed/replicated by another system (e.g. a man-made machine or so called artificial) then that system become able to behave in an intelligent and rational manner having or becoming capable of acquiring the skills that an intelligent being such as human is capable of acquiring to perform the desired task such deriving a car or cleaning a house, performing a surgery, uttering and conversing, or composing an essay.

Such machines, potentially can perform much better than human considering that the processing speed, memory and storage, and granularity of the data acquisition that the artificial machines have at their disposal is growing very fast while the costs are declining. Granularity of data, for instance, is in reference to quality and resolution, and spectral width of modem camera lenses, or sensitivity of sensors compared to human sense (e.g. 5 fundamental human sense) and the like.

Here it should be mentioned that in spite of the value of having access to granular data, it should, however, be noted that having high resolution data points (e.g. small quantization step data acquisition) usually will increase the complexity of the current methods (e.g. Bayesian inferences methods, deep learning, logistic regression, etc.) of autonomous decision making systems dramatically and such systems will not necessary perform better by having access to granular data. In fact in many occasions such autonomous system can became unpredictable and incapable of making rational decisions or, in terms of our definitions, incapable of making a sound state transition.

However, one of the objectives of the current disclosure is to make or build or devise such autonomous systems that while can use the benefits of data granularity but still become able to stay rational and behave in a stable and predictable manner as will be pointed throughout the detailed description of the current disclosure.

The next equally important issue is finding the relationship of value significant components of the states so that when the system encounter a new situation (i.e. receives new information or data) it can make the most appropriate decision to transit to a new state and therefore move forward towards its mission/destination or goals. Furthermore knowing the relationships between these high value (value significant) state components are crucial to estimate or compose the most rational and sane new state so as to navigate the system through its space of states reliably.

Accordingly we introduce the concept of association strength of components of state space and several types of associations are introduced according to various value significance measures.

From the association and value significances of the components of the sate space we can calculate the associations between the state vectors (i.e. the points in state space or the corresponding Hilbert space) themselves so that one can quickly and efficiently calculate the best/optimal next state components (according to some measures of association and significance value and the contextual data surrounding the current state of the system) to make or build smart and rational autonomous systems such as self-driving cars, humanoid and/or autonomous robots, and state-full software artifacts and agents etc.

The investigation/navigation method's and the algorithm/s are now explained in the following sections and subsections with the step by step formulations that are easy to implement by those of ordinary skilled in the art and by employing computer programming languages and computer hardware systems that can be optimized or customized by build or hardware design to perform the algorithm/s efficiently and produce useful outputs for various applications such as some of those mentioned in the disclosure.

### II-II Value Significance Measures

This section begins to concentrate on value significance evaluation of a predefined order SCs by several exemplary embodiments of the preferred methods to evaluate the value of an SC of the predetermined order, within a same order set of SCs of the composition, for the desired measure of significance.

Using these mathematical objects various measures of value significances of SCs in a body of knowledge or a composition (called “value significance measure”) can be calculated for evaluating the value significances of SCs of different orders of the compositions or different partitions of a composition. Furthermore, these various measures (usually have intrinsic significances) are grouped in different types and number to distinguish the variety and functionalities of these measures.

The first type of a “value significance measure” is defined as a function of “Frequency of Occurrences” of SCᵢ^{k} is called here FOᵢ^{k|l} and can be given by:

vsm_1ᵢ^{k|l}=f₁(FOᵢ^{k|l}), i=1,2, . . . N (6)

wherein FOₗ^{k|l} is obtained by counting the occurrences of SCs of the particular order, e.g. counting the appearances of particular word in the text or counting its total occurrences in the partitions, or more conveniently be obtained from the COM^{k|l} (the elements on the main diagonal of the COM^{k|l}) or by using Eq. 4, or any other way of counting the occurrences of SCᵢ^{k} in the desired partitions of the composition.

Moreover the f₁ in Eq. 6 is a predefined function such that f₁(x) might be a liner function (e.g. ax+b), a power/polynomial of x function (e.g. x³ or x+x^{0.53}+x⁵), a logarithmic function (e.g. 1/log2(x)), or 1/x function, etc.

Accordingly, a vsm_1_1ᵢ^{k|l}, (stands for number one of type one “value significance measure”) for instance, can be defined as:

vsm_1_1ᵢ^{k|l}=c.FOᵢ^{k|l} (7)

wherein c is a constant or a pre-assigned vector. The vsm_1_1ᵢ^{k|l} of Eq. 7 gives a high value to the state components of order k, SC^{k} , that have most frequently occurred in state components of order l, SC^{l}, In another situation or some applications if, for a desired aspect, less frequent SCs are of more significance one may use the following vsm_1_2ᵢ^{k|l}(number 2 of type 1 vsm)

$$vsm\_ 1 \_ {2}_{i}^{k \vert l} = \frac{c}{( {FO}_{i}^{k \vert l} )} , i = 1 , 2 , … N \qquad ( 8 )$$

Furthermore, another type of vsm_xᵢ^{k|l} is defined as a function of the “Independent Occurrence Probability” (IOP) in the partitions such as:

vsm_2ᵢ^{k|l}=f₂(iopᵢ^{k|l}), i=1 . . . N (9)

wherein the independent occurrence probability (iopᵢ^{k|l}) may conveniently, assuming a single occurrence of an OS^{k} in a partition OS^{l}, be given by:

$$( {iop}_{i}^{k \vert l} ) = \frac{{FO}_{i}^{k \vert l}}{M} , i = 1 … N \qquad ( 10 \text{-} 1 )$$

or one may consider the following:

$$( {iop}_{i}^{k \vert l} ) = \frac{{FO}_{i}^{k \vert l}}{{\sum }_{i} {FO}_{i}^{k \vert l}} , \qquad ( 10 \text{-} 2 )$$

be a more appropriate measure of “independent probability of occurrence wherein summation is over frequency of occurrences of all SC^{k} in the composition, and f₂ in Eq. 9 is a predefined function. For instance a vsm_2_1ᵢ^{k|l} (i.e. the number 1 type 2 vsm) can be defined as:

vsm_2_1ᵢ^{k|l}=−log₂(iopᵢ^{k|l}), i=1 . . . N (11)

This measure gives a high value to those SCs of order k of the composition (e.g. the words when k=1) conveying the most amount of information as a result of their occurrence in the composition. Extreme values of this measure can point to either novelty or noise.

Still, another type of vsm_xᵢ^{k|l} is defined as a function of the “co-occurrence of an SC^{k} with others as:

vsm_3ᵢ^{k|l}=f₃(comᵢⱼ^{k|l}), i=1 . . . N (12)

wherein the comᵢⱼ^{k|l} is the co-occurrences of SCᵢ^{k} and SCⱼ^{k} and f₃ is a predetermined function. For instance a vsm_3ₗ^{k|l} can be defined as:

vsm_3_1ᵢ^{k|l}=f₃(comᵢⱼ^{k|l})=Σⱼ comᵢⱼ^{k|l}, i=1 . . . N (13).

This measure gives a high value to those frequent SCs of order k that have co-occurred with many other SCs of order k in the partitions of order l.

This measure (Eq. 13) once combined with other measures can yet provide other measures. For instance when it is being divided by the vsm_1_1ᵢ^{k|l} of Eq. 7, (e.g. being divided by FOᵢ^{k|l}), the resultant measure can indicates the diversity of occurrence of that SC. Therefore, this particular combined measure usually gives a high value to the generic words (since generic words can occur with many other words). Once the generic words excluded from the list of SCs of the order k then this measures can quickly identifies the main subject matter of a composition so that it can be used to label a composition or for classification, categorization, clustering, etc.

Accordingly, more vsm_xᵢ^{k|l} can be defined using the one or more of the other vsmᵢ^{k|l} or the variables. For instance one can define a vsm_xᵢ^{k|l} of type 4 (x=4) as function of vsm_1_2ᵢ^{k|l} given by Eq. 8 and comᵢ^{k|l} as the following:

vsm_4_1ⱼ^{k|l}=f₄(vsm_1_2ᵢ^{k|l}, comᵢⱼ^{k|l})=Σᵢ(compᵢⱼ^{k|l}, vsm_1_2ᵢ^{k|l})=(1/FOᵢ^{k|l})^{T}×COM, i,j=1 . . . N (14)

wherein “T” stands for matrix or vector transposition operation and wherein we substitute the vsm_1_2ᵢ^{k|l} from Eq. 8 into Eq. 12 or 14. This measure also points to the diversity of the participations of the respective SC especially when COM is made digital.

For mathematical accuracy it is noticed that in our notation the index “i” refers to the row number and the index “j” refers to the column number therefore the matrices with only the subscript of “i” usually are the column vectors and the matrices with only the subscript of “j” usually are row vectors.

In a similar fashion there could be defined, synthesized, and be calculated various vsm_xᵢ^{k|l} (x=1,2,3, . . . ) vectors for SCᵢ^{k} that are indicatives of one or more significances aspect/s of an SCᵢ^{k} in the composition or the BOK. These groups of vsm_xᵢ^{k|l} generally refer to the intrinsic value significance of an SC in the BOK.

These “value significance measures” (vsm_xᵢ^{k}) are more indicative of intrinsic importance or significances of lower order constituent part that can be use to separate one or more of the these SCs for variety of applications such as labeling, categorization, clustering, building maps, conceptual maps, state component maps, or finding other significant parts or partitions of the composition or the BOK. For instance the vsm_xᵢ^{k|l} can readily be employed to score a set of document or to select the most import parts or partitions of a composition by providing the tools and objects to weigh the significances of parts or partitions of a BOK.

Accordingly, from the vsm_xᵢ^{k} vectors one can readily proceed to calculate the vsm_x of other SC of different order (i.e. an order l) utilizing the participation matrices PM^{kl} by a multiplication operation by:.

vsm_xⱼ^{l|kl}=(vsm_xᵢ^{k})^{T}×pmᵢⱼ^{kl} j=1,2, . . . M and i=1,2, . . . N (15)

wherein vsm_xⱼ^{l|kl} is the type x value significance of SCs of order l obtained from the data of the PM^{kl}. An instance meaning of SC of order l for a textual composition or a BOK is a sentence (e.g. l=2), a paragraph (e.g. l=3) or a document (l=5). The vsm_xⱼ^{l|kl} thereafter can be utilized for scoring, ranking, filtering, and/or be used by other functions and applications based on their assigned value significances.

Generally, many other “value significant measures” can be constructed or synthesized as functions of other “value significance measures” to obtain a desired new value significance measure.

Therefore, from the disclosure here, it becomes apparent as how various filtering functions can be synthesized utilizing the participation matrix information of different orders and other derivative mathematical objects. The method is thereby easily implemented and is process efficient.

An immediate application of the theory and the associated methods, systems, and applications are instrumental in processing of natural languages compositions and building intelligent systems capable of moving, behaving, and interacting with humans in an intelligent manner.

### II-III The Association Strength

This section look into another important attributes of the state components of a composition that is instrumental and desirable in investigating the composition of state components.

According to the theoretical discoveries, methods, systems, and applications of the present invention, the concept and evaluation methods of “association strengths” between the state components of a composition or a BOK play an important role in investigating, analyzing and modification of compositions of state components.

Accordingly, the “association strength measures” are introduced and disclosed here. The “association strength measures” play important role/s in many of the proposed applications and also in calculating and evaluating the different types of “value significance evaluation” of SCs of the compositions. The values of an “association strength measure” can be shown as entries of a matrix called herein the “Association Strength Matrix (ASM^{k|l})”.

The entries of ASM^{k|l} is defined in such a way to show the concept and rational of association strength according to one exemplary general embodiment of the present invention as the following:

asm_{i→j}^{k|}=f(comᵢⱼ^{k|l}, vsm_xᵢ^{k}, vsm_yⱼ^{k}) . . . i,j=1 . . . N, x,y=1,2, (16),

where asm_{i→j}^{k|}is the “association strength” of SCᵢ^{k} to SCⱼ^{k} of the composition and f is a predetermined or a predefined function, comᵢⱼ^{k|l} are the individual entries of the COM^{k|l} showing the co-occurrence of the SCᵢ^{k} and SCⱼ^{k} in the partitions or SC^{l}, and the vsm_xᵢ^{k} and vsm_yⱼ^{k} are the values of one of the “value significance measures” of type x and type y of the SCᵢ^{k} and SCⱼ^{k} respectively, wherein the occurrence of SC^{k} is happening in the partitions that are SCs of order l. In many cases the vsm_xᵢ^{k} and/or the vsm_yᵢ^{k} are from the same type of “value significance measure” and usually are calculated from the participation data of the SC^{k} in the SCs of order l, i.e. the PMs, but generally they can be of different types and possibly calculated from PMs of different bodies of data.

Accordingly having selected the desired form of the function f and introducing the exemplary quantities from Eq. 6, and/or 9 and/or Eq. 12 into Eq. 16 the value of the corresponding “association strength measure” can be computed.

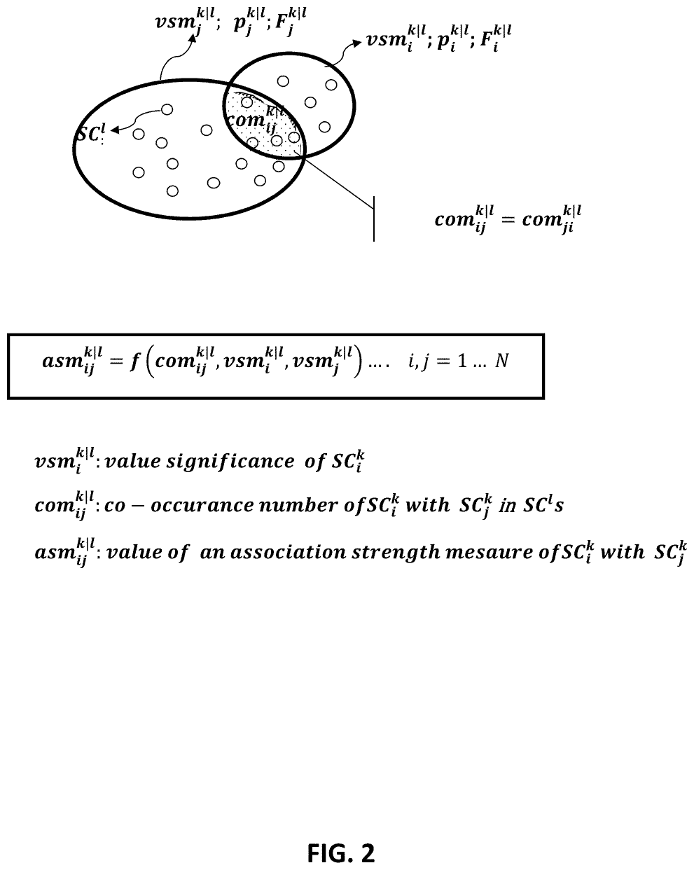

Referring to FIG. 2 here, it shows one definition for association of two or more SCs of a composition to each other and shows how to evaluate the strength of the association between each two SCs of composition. In FIG. 2 the “association strength” of each two SCs has been defined as a function of their co-occurrence in the composition or the partitions of the composition, and the value significances of each one of them.

FIG. 2, moreover shows the concept and rational of this definition for association strength according to this disclosure. The larger and thicker elliptical shapes are indicative of the value significances, e.g. probability of occurrences, of SCᵢ^{k} and SCⱼ^{k} in the composition that were driven from the data of PM^{kl} and wherein the small circles inside the area is representing the SC^{l} s of the composition. The overlap area shows the common state components of order l, SC^{l}, between the SCᵢ^{k} and SCⱼ^{k} in which they have co-occurred, i.e. those partitions of the composition that includes both SCᵢ^{k} and SCⱼ^{k}. The co-occurrence number is shown by comᵢⱼ^{k|l}, which is an element of the “Co-Occurrence Matrix (COM)” introduced before (Eq. 5).

The various asm_{i→j}^{k|l} can be grouped into types and number in order to distinguish them from other measures in a similar fashion in labeling and naming the VSMs in the previous subsection. Consequently few exemplary types of “association strength measures”, asm_{i→j}^{k|l}, are given below:

asm_1_1_{i→j}^{k|l}=comᵢⱼ^{k|}. . . i,j=1 . . N (17)

asm_2_1_{i→j}^{k|l}=comᵢⱼ^{k|l}/vsm_xᵢ^{k|l} . . . i,j=1 . . . N, x, y=1,2, (18-1)

asm_2_2_{i→j}^{k|l}=comᵢⱼ^{k|l}/vsm_xⱼ^{k|l} . . . i,j=1 . . . N, x, y=1,2, (18-2)

$$\begin{matrix}asm\_ 3 \_ {1}_{i \to j}^{k \vert l} = \frac{{vsm\_y}_{l}^{k \vert l}}{{vsm\_x}_{l}^{k \vert l}} \cdot {com}_{ij}^{k \vert l} … i , j = 1 … N , x , y = 1 , 2 , … & ( 19 \text{-} 1 ) \\ asm\_ 3 \_ {2}_{i \to j}^{k \vert l} = \frac{{vsm\_y}_{l}^{k \vert l}}{{vsm\_x}_{l}^{k \vert l}} \cdot {com}_{ij}^{k \vert l} … i , j = 1 … N , x , y = 1 , 2 , … & ( 19 \text{-} 2 )\end{matrix}$$

It is important to notice that the association strength defined by Eq. 16, is not usually symmetric and generally asm_{j→i}^{k|l}≠asm_{i→j}^{k|l}. Therefore, one important aspect of the Eq. 16 to be pointed out here is that associations of SCs of the compositions are not necessarily symmetric and in fact an asymmetric “association strength measure” is more rational and better reflects the actual relationship between the SCs of the composition.

To further illustrate on the actuality of the “association strength measures” consider that vsm_xᵢ^{k|l}=iopᵢ^{k|l} and vsm_xᵢ^{k|l}=iopᵢ^{k|l} wherein the iopᵢ^{k|l} and iopⱼ^{k|l} are the “independent occurrence probability” of SCᵢ^{k} and SCⱼ^{k} in the partitions respectively, wherein the occurrence is happening in the partitions that are SCs of order l.

Consequently, for instance, from the associations strength of Eq. 19-1, we define another exemplary “association strength measure”, labeled as asm_3_1_1_{i→j}^{k|l}, (it reads as number 1 of type 3_1 “association strength measure”, to make it distinguishable from other measures) as:

$$asm\_ 3 \_ 1 \_ {1}_{i \to j}^{k \vert l} = c \frac{{com}_{ij}^{k \vert l}}{( {iop}_{i}^{k \vert l} / {iop}_{j}^{k \vert l} )} = \frac{{com}_{ij}^{k \vert l} \cdot {iop}_{j}^{k \vert l}}{{iop}_{j}^{k \vert l}} , i , j = 1 … N \qquad ( 20 \text{-} 1 )$$

and similarly using Eq. 19-2 we arrive at:

$$asm\_ 3 \_ 2 \_ {1}_{i \to j}^{k \vert l} = c \frac{{com}_{ij}^{k \vert l}}{( {iop}_{j}^{k \vert l} / {iop}_{i}^{k \vert l} )} = \frac{{com}_{ij}^{k \vert l} \cdot {iop}_{i}^{k \vert l}}{{iop}_{j}^{k \vert l}} , i , j = 1 … N \qquad ( 20 \text{-} 2 )$$

where c is a predetermined constant, or a pre-assigned value vector, or a predefined function of other variables in Eqs. 20-1 and 20-2, comᵢⱼ^{k|l} are the individual entries of the COM^{k|l} showing the co-occurrence of the OSᵢ^{k} and SCⱼ^{k} in the partitions of order l, and the iopᵢ^{k|l} and iopᵢ^{k|l} are the “independent occurrence probability” of SCᵢ^{k} and SCⱼ^{k} in the partitions respectively, wherein the occurrence is happening in the partitions that are SCs of order l. In a particular case, it can be seen that in Eq. 20-1, the un-normalized “association strength measure” of each SC with itself is proportional to its frequency of occurrence (or self-occurrence). Generally iopᵢ^{k|l} and iopⱼ^{k|l} are functions of frequency of occurrences of state components of order k, which depend on the definition of such frequency of occurrences for each particular aspect (or event) of interest.

II-III-I The Association Strength, Conditional Probability of Occurrences, and Informational Value of State Components of a Body of Knowledge

It was mentioned that the association strength defined by Eq. 16 or more particularly by Eq. 20-1 or 20-2, are not symmetric and generally asmⱼᵢ^{k|l}≠asmᵢⱼ^{k|l}. One important aspect of the Eq. 20 which is pointed out is that associations of SCs of the compositions that have co-occurred in the partitions are not necessarily symmetric and in fact it is argued that asymmetric association strength is more rational and better reflects the actual relationships of SCs of the composition.

To illustrate further in this matter, Eq. 20-1 basically says that if a less popular SC co-occurred with a highly popular SC then the association of less poplar SC to the highly popular SC is much stronger than the association of a highly popular SC having the same co-occurrences with the less popular SC. That make sense, since the popular SCs obviously have many associations and are less strongly bounded to anyone of them so by observing a highly popular SC one cannot gain much upfront information about the occurrence of less popular SCs. However observing occurrence of a less popular SC having strong association to a popular SC can tip the information about the occurrence of the popular SC in the same partition, e.g. a sentence, of the composition.

A very important, useful, and quick use of association strength measures, e.g. Eq. 20-1, is to find the real associates of a word, e.g. a concept or an entity, from their pattern of usage in the partitions of textual compositions. Knowing the associates of words, e.g. finding out the associated entities to a particular entity of interest, has many applications in the knowledge discovery and information retrieval. In particular, one application is to quickly get a glance at the context of that concept or entity or the whole composition under investigation.

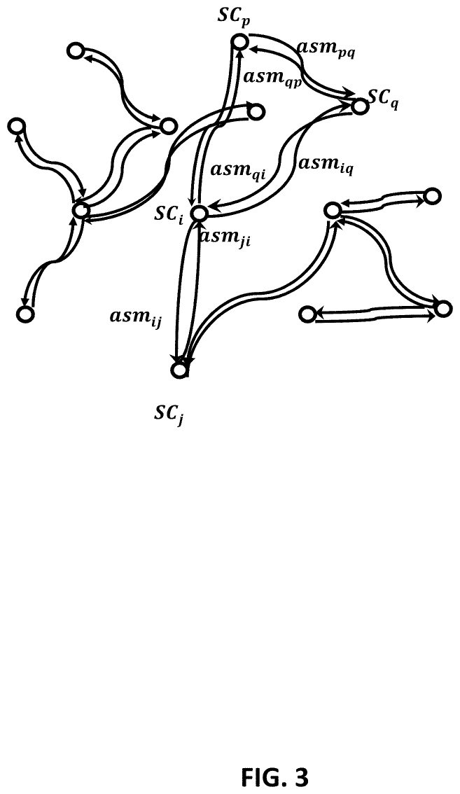

In accordance to another aspect of the invention, one can recall from graph theories that each matrix can be regarded as an adjacency matrix of a graph or a network. Consequently, FIG. 3 shows a graph or a network of SCs of the composition whose adjacency matrix is the Association Strength Matrix (ASM). As seen the graph corresponding to the ASM can be shown as a directed and asymmetric graph or network of SCs. Therefore having the ASM one can represent the information of the ASM graphically. On the other hand by having a graph one can transform the information of the graph into an ASM type matrix and use the method and algorithm of this application to evaluate various value significance measures for the nodes of the graph or network. Various other graphs can be depicted and generated for each of the different matrixes introduced herein. FIG. 3 further demonstrate that how any composition of state components can be transformed (using the disclosed methods and algorithms) to a graph or network similar to the one shown in FIG. 3 showing the strength of the bounding between the nodes of the graph.

Using the association strength concept one can also quickly find out about the context of the compositions or visualize the context by making the corresponding graphs of associations as shown in FIG. 3. Furthermore, the association strengths become instrumental for identifying the real associates of any SC within the composition. Once the composition is large or consist of very many documents one can identify the real associations of any state component of the corresponding universe. Such a real association is useful when one wants to research about a subject so that she/he can be guided through the associations to gain more prospects and knowledge about a subject matter very efficiently. Therefore a user or a client can be efficiently guided in their research trajectory to gain substantial knowledge as fast as possible. For instance a search engine or a knowledge discovery system can provide its clients with the most relevant information once it has identified the real associations of the client's query, thereby increasing the relevancy of search results very considerably.

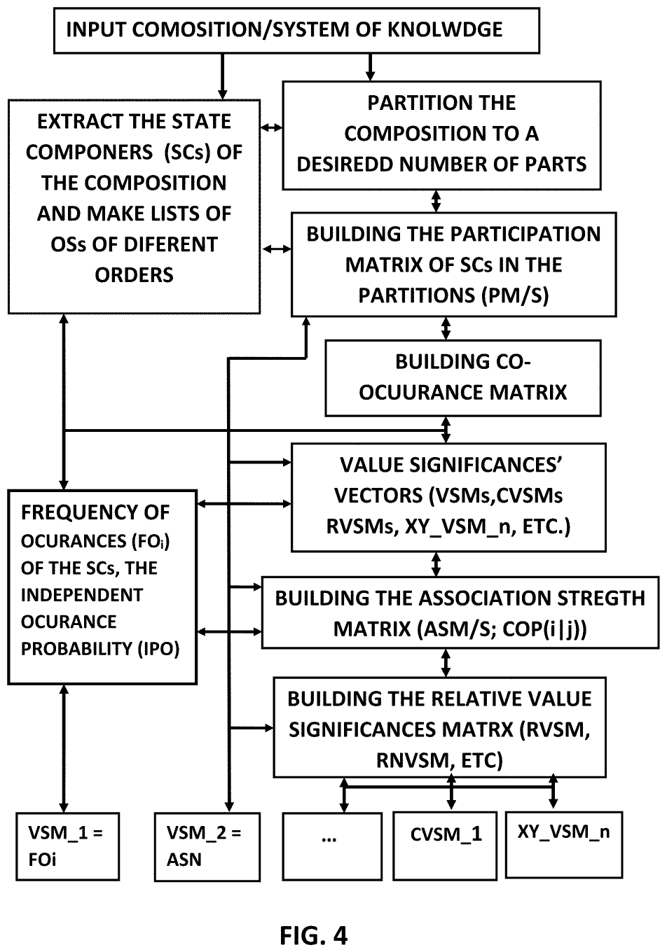

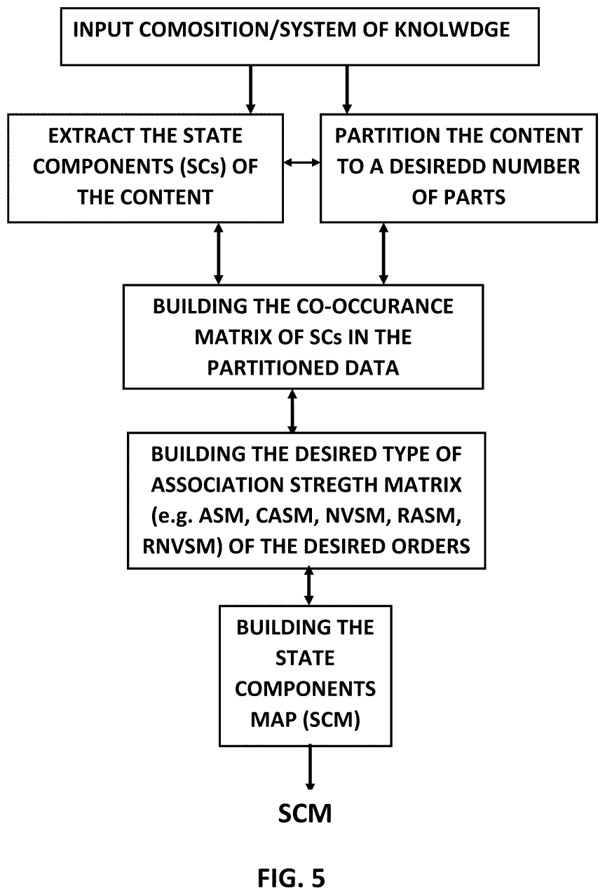

As another example, a service provider providing knowledge discovery assistance to its clients can look into the subjects having high associations strength with the subject matter of the client's interest, to give guidance as what other concepts, entities, objects etc. should she/he look into to have deeper understanding of a subject of interest or to collect further compositions and documents to extend the body of knowledge related to one or more subject matters of her/his/it's interest. FIGS. 4, 5 shows a block diagram of one process flow to obtain such data objects to be used for the aforementioned applications such as building state component maps (SCMs)

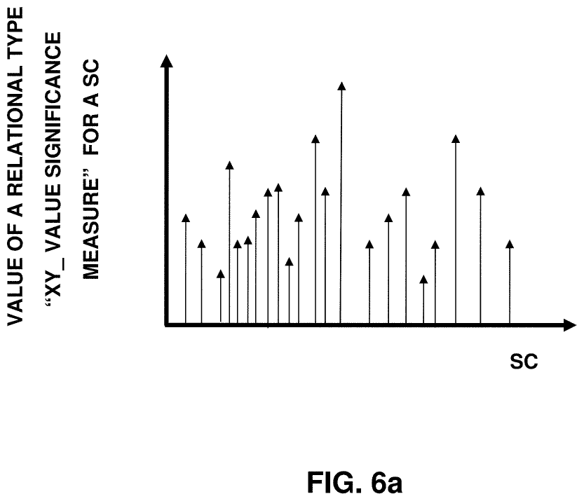

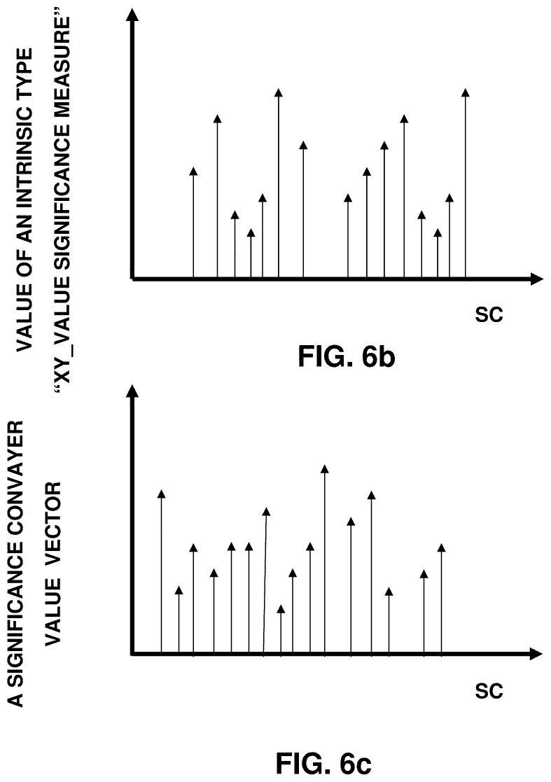

FIG. 6a, 6b, 6c shows spectral representation of association strengths of state components. As seen the association strength of an SC with other SCs can be represented with a row or column vector and further it can be depicted or regarded as a spectral signature corresponded to each SC. Each SC of the body of knowledge therefore will have a spectrum of association value with other SCs of the body of data and depends on the choice of type of the “association strength measure” can have a different depiction.

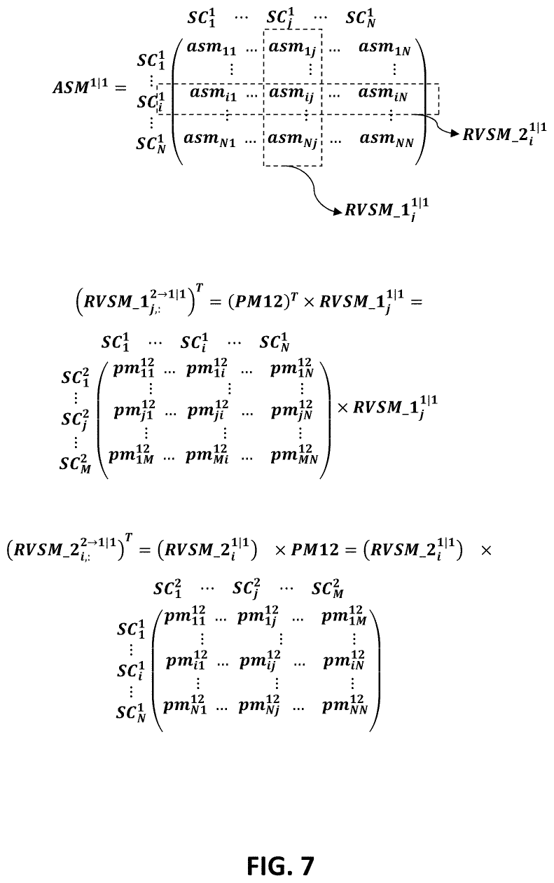

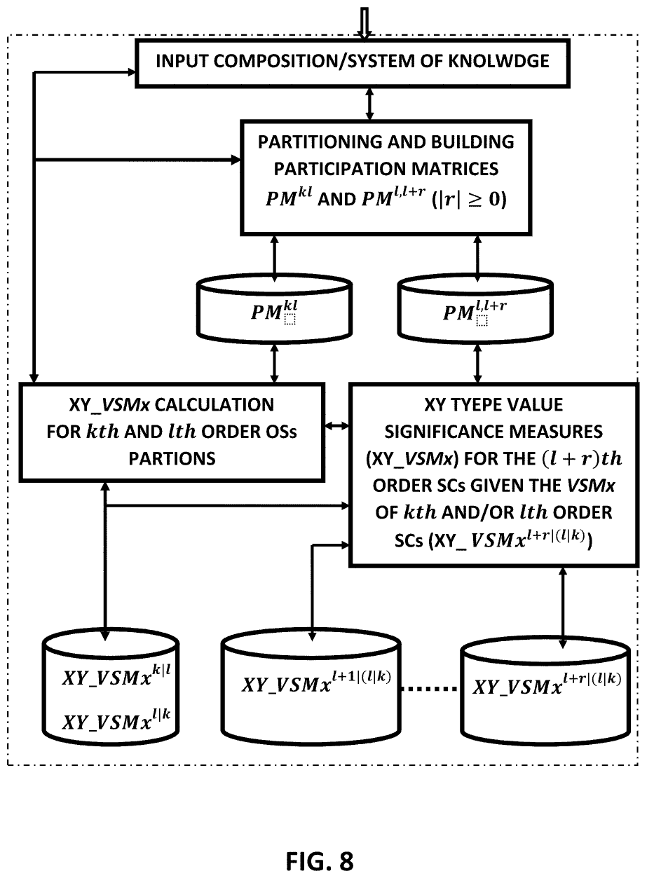

Furthermore the asm vector can also be regarded as relative value significance of a SC in relation to another SC as shown in FIG. 7. FIGS. 8, 9 and 10 further shows further applications of such data objects (e.g. VSMs, ASMs, and other data objects of this disclosure) in investigation of bodies of data or bodies of knowledge.

According to another aspect of the invention, we also put a value of significance on each SC based on the amount of information that they contribute to the composition and also by the amount of information that composition is giving about the SCs.

To evaluate the information contribution of each SC we use the information about the association strength as being related to the probability of co-occurrence of each two SCs in the partitions of the composition. The probability of occurrence SCᵢ^{k} after knowing the occurrence of SCⱼ^{k} in a partition, e.g. SC^{l}, is considered to be proportional to the association strength of SCⱼ^{k} to SCᵢ^{k}, i.e. the asm_{j→i}^{k|l}. Therefore we define yet another function named “Conditional Occurrence Probability (COP^{k|l})” here as being proportional to asm_{j→i}^{k|l}. Hence to have entries of COP^{k|l} as the following:

cop^{k|l}(i|j))=p^{k|l}(OSᵢ^{k}|OSⱼ^{k})∝asm_{j→i}^{k|l}. (20-3)

Considering that Σⱼiopⱼ^{k|l}.cop^{k|l}(i|j)=iopᵢ^{k|l} (total conditional probabilities of occurrences of OSᵢ^{k} in a partition is equal to independent occurrence probability of SCᵢ^{k} in that partition) we arrive at:

$${cop}^{k \vert l} ( i \vert j ) = \frac{{iop}_{i}^{k \vert l} \cdot {asm}_{jl}^{k \vert l}}{{Σ}_{q} {iop}_{q}^{k \vert l} \cdot {asm}_{qi}^{k \vert l}} \qquad ( 20 \text{-} 4 )$$

In the matrix form let's call the corresponding matrix, with entries of cop^{k|l}(i|j), as COPM^{k|l}(SCᵢ^{k}|SCⱼ^{k}). The matrix COPM^{k|l} can be made to a row stochastic (assuming the i showing the index of rows) but sparse (having many zero entries) and in terms of graph theories jargon it could be corresponded to an incomplete graph or a network. However if for mathematical and/or computational reasons it becomes necessary, it can be made to become a matrix that corresponds to a complete graph (every node in the graph is connected directly to all other nodes) by subtracting an small amount from the non-zero elements and distribute it into the zero elements so that processing of the matrix for further purposes can be performed without mathematical difficulties (no division by zero etc.).
In particular, replacing the asm from Eq. 20-1 into Eq. 20-4 we will arrive at:

$${cop}^{k \vert l} ( i \vert j ) = \frac{{iop}_{i}^{k \vert l}}{{iop}_{j}^{k \vert l}} \frac{{com}_{ij}^{k \vert l}}{{Σ}_{q} {com}_{iq}^{k \vert l}} , \qquad ( 20 \text{-} 5 )$$

The relationship (Eq. 20-5) is not only very elegant but also is very effective in evaluating and estimating the real informational values of state components of the universe corresponding to the body of knowledge under investigation. In fact the terms

$$\frac{{com}_{ij}^{k \vert l}}{{Σ}_{q} {com}_{iq}^{k \vert l}}$$

are the entries of row normalized version of co-occurrence matrix COM (norm 1 normalized over row). Further the row normalized (or column normalized) version of matrix COM is not symmetric anymore. Eq. 20-5 is a good and sound estimation of the conditional occurrence probability. Further we discovered that for most practical purposes, and based on own experiments especially in investigation of large corpuses, phrase detection, speech recognition, and image investigation we observe that

$$\frac{{p}_{i}^{k \vert l}}{{Σ}_{q} {com}_{iq}^{k \vert l}} \approx \frac{{p}_{j}^{k \vert l}}{{Σ}_{q} {com}_{jq}^{k \vert l}}$$

for most of SCᵢ^{k} or SCⱼ^{k} of the body of knowledge, so that Eq. 20-5 is not in violation of Bayes Theorem. Eq 20-5 can also be calculated using frequency of occurrences:

$${cop}^{k \vert l} ( i \vert j ) = \frac{{F}_{i}^{k \vert l}}{{F}_{i}^{k \vert l}} \frac{{com}_{ij}^{k \vert l}}{{Σ}_{q} {com}_{iq}^{k \vert l}} \qquad 20 \text{-} 5 \text{-} 1$$

Again Eq. 20-5-1 is not, statistically, in violation of Bayes theorem as we can see that

$$E ( \frac{{F}_{i}^{k \vert l}}{{Σ}_{q} {com}_{iq}^{k \vert l}} ) = E ( \frac{{F}_{j}^{k \vert l}}{{Σ}_{q} {com}_{jq}^{k \vert l}} ) = \frac{1}{\overline{n}} \qquad 20 \text{-} 5 \text{-} 2$$

Wherein, E is the expected value, and n̅ is the average length of state components of order l,_SC^{l}, of the body of knowledge.

And similarly replacing the asm from Eq. 20-2 into Eq. 20-4:

$${cop}^{k \vert l} ( i \vert j ) = \frac{{iop}_{i}^{k \vert l} {iop}_{j}^{k \vert l} {com}_{ij}^{k \vert l}}{{{Σ}_{q} ( {iop}_{q}^{k \vert l} )}^{2} {com}_{iq}^{k \vert l}} , \qquad ( 20 \text{-} 6 )$$

Eqs. 20-4, 20-5 and/or 20-6 can readily be used for effective knowledge retrieval or question answering, state navigation, content generation, classification, and many other useful applications. However all these applications have similar nature and can be modeled into a state navigator machines/systems.

Having assembled a body of knowledge, and following the methods and formulation given in the present invention, one can calculate the asm_{i→j}^{k|l} and cop^{k|l} (i|j) either in real time or premade.

Each row (or column) of these association strength matrices or COP matrix can be viewed as an spectrum of association for each state component from which one can be used to extract the knowledge about the relevancy and types of the relevancies of the state components of the same or the higher order. In practice, an input to the system, either as one or more components of the state of the system, or a query in the form of, for instance, a natural language question, we can treat the input as a list of one or more state components of order k, i.e. the SCⱼ^{k}, of the body of knowledge. One application of ASM and COP therefore could be in looking for highly relevant and the most informative (i.e., highly associated SCs, or highest cop^{k|l} (i|j) partition of the body of knowledge. This can be done through use of one or more participation matrices of different order and one or more ASM/COP and give back an answer which is most informative and relevant to the query or the state of system with confidence. Or using eq20-4, or 20-5, or 20-6 to compose the most informative response and relevant to the query/input/state to the system.

Those skilled in the art can rewrite the Eqs.17 to 20-6 or simplify it even further without departing from the spirit and the scope of the present invention which in one aspect is to evaluate the conditional probability of occurrences of state components by investigating its corresponding body of knowledge or data. These conditional probabilities therefore can be used to evaluate the information content of the partitions of the body of knowledge and consequently estimate the total information content of a BOK. Also the conditional probability can be readily used to estimate the probability of components of the next state of the system of knowledge (e.g. an autonomous moving robots) given its current state.

Equally important, from the conditional probability of occurrences of state components of order k, one can proceed to calculate and assign values to partitions of the compositions, e.g. the SC of order l.

For instance for a textual body of knowledge if SCᵢ¹ can be defined to be the words of a language, then the information content of an individual sentence of the given body of knowledge can be calculated using the Eq. 20-5, and the Conditional mutual information of random variable as the followings:

I(SC₀¹,SC₁¹, . . . SCₙ¹)=ΣᵢⁿI(SCᵢ¹|SC₀¹, . . . , SCᵢ₋₁¹) (20-7)

wherein further we use:

I(OSᵢ¹)=−log(iopᵢ^{1|l}) (20-7-1)

I(SCᵢ¹|SCⱼ¹)=−log(cop^{1|l}(i|j))

and chain rules can be applied to calculate I(SCᵢ¹|SC₀¹, . . . ,SCᵢ₋₁¹) using the conditional probability of occurrences given, for instances, by Eq. 20-5 or 20-6.

The informational content of the partitions of the body of data can be very insightful and instrumental for extracting the usable knowledge within a body of data or select the stats of the system which can give the highest insight about the working behavior of a system such as a self-driving car or an autonomous robot or a decision support system artifact.

Yet equally important, from Eq. 20-4 and/or Eq. 20-5/6 one can calculate the conditional entropy OS^{k} as the following:

$$H ( {SC}^{k} \vert {SC}^{k} ) = - E ( log ( {COPM}^{k \vert l} ( {SC}^{k} \vert {SC}^{k} ) ) ) = {\sum }_{j} iop ( {SC}_{j}^{k} ) {\sum }_{i} {cop}^{k \vert l} ( {SC}_{i}^{k} \vert {SC}_{j}^{k} ) log ( {cop}^{k \vert l} ( {SC}_{i}^{k} \vert {SC}_{j}^{k} ) ) \qquad ( 20 \text{-} 8 \text{-} 1 )$$

wherein E stands for Expectation value. And in its matrix form can be re-written as:

H(SC^{k}|SC^{k})=−E(log(COPM^{k|l}(SC^{k}|SC^{k})))=(COPM.logCOPM).sum() (20-8-2)

Wherein COPM is COPM^{k|l}(SC^{k}|SC^{k}), “.” Stands for element-wise matrix multiplication, and sum( )is sum of resultant matrix over both indices.

For instance, consider a textual body of knowledge composed of many documents, pages, paragraphs, and sentences and words and characters. Following the teachings of the present invention one can make one or more participation matrix from the textual body of knowledge, say we built PM12 and evaluated the cop^{k|l}(SCᵢ^{k}|SCⱼ^{k}), assuming k=1 and l=2, that is the PM¹² indicating participation of words into sentences. Then the average information content of a sentence, (e.g. an average SCᵢ₂²) can be calculated, using computer programs instructions executed by one or more data processing or calculating devices, as the followings:

$$I ( {SC}^{2} ) = \overline{n } H ( {SC}^{1} ) - \frac{\overline{n} ( \overline{n} - 1 )}{2} H ( {SC}^{- 1} \vert {SC}^{1} ) \qquad ( 20 \text{-} 9 )$$

Wherein H (OS¹) is the entropy of independent occurrences of an SC^{k}, calculated from iopᵢ^{1|2} (i.e. Σᵢⁿiopᵢ^{1|2}log(iopᵢ^{1|2}) and n̅ is the average sentence length (average number of words in a sentence) and which both can be obtained easily from the PM¹² (e.g. assuming PM¹² is binary, then sum of all its entries of divided by number of SC² can give n̅, and sum over columns divided by sum of all enters of can give a column vector whose ith elements is the iopᵢ^{1|2}). In deriving Eq. 20-9, chain rules for entropy (i.e. H(SC₀¹,SC₁¹, . . . SCₙ¹)=ΣᵢⁿH(SCᵢ¹|SC₀¹, . . . SCᵢ₋₁¹)) is used.

It is noticed that the Eq. 20-9 gives the average information (or entropy) of a sentence of the textual body from which, therefore, the higher bound of information content of the body of knowledge or data can be estimated.

In the same manner information of an individual sentence (i.e. I(SCᵢ₂²) can be calculated more precisely from COPM and the information of its constituent SC¹. Generally, by using Eqs 17 to 20-9 and building the corresponding data objects, the information content of any state component of any particular order of the body of knowledge can be estimated or calculated.

Furthermore, it is also observed that the conditional occurrence probabilities can have dependencies on the aspect of association of interest, i.e. the type of association strength measures. Using Eq. 4 and the ASM of interest (further types of association strength measures are also given in supplementary section of this disclosure) different COPs with their own interpretations and usage can be obtained, calculated and revealed.

To recap, in this section, we derived the conditional probability of occurrences of state components of certain order, knowing the occurrence of an state component of the same order in an SC of higher order, from the concept and definitions and one type of association measures (e.g. from Eq. 20-1) we arrived at Eq. (20-4) and eq.(20-5)). We also notice that this conditional probability of occurrence itself is one measure of association strength between SCs of the composition. Accordingly another type of asm is introduced as the following:

asm_3_3_{i→j}^{k|l}=cop^{k|l}(SCᵢ^{k}|SCⱼ^{k}) (20-10)

asm_3_4_{i→j}^{k|l}=cop^{k|l}(SCⱼ^{k}|SCᵢ^{k}) (20-11)

This asm_3_3_{i→j}^{k|l} and/or asm_3_4_{i→j}^{k|l} can be readily used for estimating the components of next or future state of the system given the components of the current state. It will determine the context of the current and future and last state automatically and is very instrumental in generating rational, meaningful, and sane new states. It should be remembered that new state could be a composed sentence or a next navigation control signals for an autonomous moving vehicle or robot.

### II-III-II Causal Association Strengths, Mutual Co-Occurrence/Similarities Matrices/Operators and Their Usage in Knowledgeable Machines

The sequence of partitions of a body of knowledge/data can be used to extract some more important relationships between SCs of a system of knowledge. In reality things happens one after another and time/sequence play an important role in shaping a system of knowledge. That is directly the results of observation of events which form our understanding of the world. Even a textual essay such as script of a talk, a journalistic article, a novel, a movie script, and/or a trajectory of moving objects (big or small) follow a path in transitioning from one state to another. The sequence of partitions of a body of data therefore can convey some significant information about the actual inner working of our universe. To account for this measure of significance we introduce, at least, a number of more data objects as the followings:

SPM^{kl}(i,j,τ)=PM^{kl}[i,j+τ] (21)

DPM^{kl}(i,j,τ)=SPM^{kl}(i,j,τ)−PM^{kl}[i,j] (22)

IPM^{k}(i,j,τ)=PM^{kl}[i,j]+SPM^{kl}(i,j,τ) (23)

wherein SPM^{kl}, DPM^{kl} and IPM^{kl} stand for “ Shifted Participation Matrix”, “Differential Participation Matrix” and “Interleaved Participation Matrix” respectively, and τ is an integer which basically shifts the columns of the PM^{kl} to the right or left(i.e. to the past or future depend on the sign of τ.). In practice the shift could be circular if desired.
In this preferred embodiment the columns of the PM^{kl} are corresponded to the state components of order l of the system, and the rows are corresponded to the state components of order k which, for example, can refer to quantized values or predefined numerical values of the sensory device arrays and all other such desirable state components such as the textual descriptions (either coded/encrypted or expressed in natural language words, phases, sentences, etc) of the scene from a visual detection and recognition units (e.g. camera's and/or Lidar/s and/or Radars, and/or GPS data, and/or external sources of information or knowledge etc.).
Moreover in one preferred exemplary embodiment, without intending to impose a limitation on entries of a PM, the entries of the PM^{kl} are binary in which the value of 1 shows the presence of that particular component of the state (e.g. the actual value of acceleration signal or the actual value of the temperature inside the engine, or the actual values of steering torque, or the actual value of the speed either normalized or absolute values) or else the entry value is zero. Therefore the DPM entries is only nonzero when the components of the state (i+τ) has changed relative to state components of sate(i) and it is zero otherwise.
In this way the new PM, i.e. the DPM shows the component that has participated in changing the state and entries will be either +1 or −1, or will be zero if the state components remained the same.
Further for the sack of brevity of the ongoing formulations let's define few operators that act on data objects. We define “CRoss Occurrence Matrix Operator”, CROMO, and “CRoss Similarity Matrix Operator”, CRSMO, operations that act upon two matrices as the followings:

CROMO(M₁,M₂)=M₁*M₂^{T} (24)

CRSMO(M₁,M₂)=M₁^{T}*M₂ (25)

wherein M₁, and M₂ are matrices with the dimensions that operator of Eq. 24 and/or Eq. 25 are doable in the context of matrix algebra. It can be seen that, for instance, the co-occurrence matrix of Eq. 5 can be shown as COM^{kl}=CROMO (PM^{kl},PM^{kl}) and similarly SM^{kl}=CRSMO (PM^{kl}, PM^{kl}).
From these Participation Matrices, we proceed to calculate yet other data objects that we call “Causal Co-Occurrence Matrix/es” which are generally functions of the shift τ, and refer to these types of “Causal Cross Occurrences Matrices” as CCROM_^{k|l}(τ).
Accordingly following the teachings of this disclosure we can proceed to define and compute various “association strength measures” of components from different snapshots of data. For instances, finding association or relationships of the components that change together, or remained the same, from one state to another state. We call these group of associations strengths measures as “Causal Association Strength Measures” or CASM . In one embodiment of the current disclosure CASMs (which are generally defined by Eq. 16, are instantiated by Eq. 19-1 and more specifically similarly to the ASM deified in Eq. 20-2) are given by:

$$\begin{matrix}casm\_ {1}_{i \to j}^{k \vert l} ( q ) = c \frac{ccrom\_ {1}_{ij}^{k \vert l} ( q ) \cdot {icp}_{j}^{k \vert l}}{{icp}_{i}^{k \vert l}} , i , j = 1. . N & ( 26 ) \\ casm\_ {2}_{i \to j}^{k \vert l} ( p , q ) = c \frac{ccrom\_ {2}_{ij}^{k \vert l} ( p , q ) \cdot {icp}_{j}^{k \vert l}}{{icp}_{i}^{k \vert l}} , i , j = 1. . N & ( 27 ) \\ cas\_ {3}_{i \to j}^{k \vert l} ( p , q ) = c \frac{ccrom\_ {3}_{ij}^{k \vert l} ( p , q ) \cdot {icp}_{j}^{k \vert l}}{{icp}_{i}^{k \vert l}} , i , j = 1. . N & ( 28 ) \\ casm\_ {4}_{i \to j}^{k \vert l} ( q ) = c \frac{ccrom\_ {4}_{ij}^{k \vert l} ( q ) \cdot {icp}_{j}^{k \vert l}}{{icp}_{i}^{k \vert l}} , i , j = 1. . N & ( 29 ) \\ casm\_ {5}_{i \to j}^{k \vert l} ( q ) = c \frac{ccrom\_ {5}_{ij}^{k \vert l} ( q ) \cdot {icp}_{j}^{k \vert l}}{{icp}_{i}^{k \vert l}} , i , j = 1. . N & ( 30 )\end{matrix}$$

wherein casm_1_{i→j}^{k|l}(q), casm₂ᵢ_{_{i→j}}^{k|l}(p,q), casm_3_{i→j}^{k|l}(q), casm_4_{i→j}^{k|l}(q), and casm_5_{i→j}^{k|l}(q) are the individual entries of “Causal Association Strength Matrix” of type 1 to type 5, respectively which in their matrix form are denoted by:

### CASM_1^{kk}(q),

### CASM_2^{kk}(p,q),

### CASM_3^{kk}(p,q)

### CASM_4^{kk}(q)

### CASM_5^{kk}(q),

and ccom_1_{i→j}^{k|l}(q), ccrom₂^{k|l}(p,q), ccrom_3^{k|l}(p,q), ccrom_4^{k|l}(q), and ccrom 5^{k|l}(q) are the individual entries of “Causal CRoss Occurrence Matrix” of type 1 to type 5, respectively, that in their matrix form are given by:

CCROM_1^{k|l}(q)=CROMO (PM^{kl}, DPM^{kl}(q)) (31)

CCROM_2^{k|l}(p,q)=CROMO(DPM^{kl}(p), DPM^{kl}(q)) (32)

CCROM_3^{k|l}(p,q)=CROMO(abs(DPM^{kl}(p)),abs(DPM^{kl}(q))) (33)

CCROM_4^{k|l}(q)=CROMO(IPM^{kl}(q),DM^{kl}(q) (34)

CCROM_5^{k|l}(q)=CROMO(IPM^{kl}(q), IPM^{kl}(q) (35),

And icpᵢ^{k|l} or icpⱼ^{k|l} stand for “independent change probability” of SCᵢ^{k} and SCⱼ^{k} respectively and can be calculated from main diagonals of the CCROMs (preferably when the operator CROM arguments, the PMs, are binary matrices) divided by the number of higher order state components in PM, (i e. the M) and, in one exemplary instance, might be given by:

$${icp}_{i}^{k \vert l} = \frac{ccrom\_ {2}_{ii}^{k \vert l} ( p , q )}{M} , \qquad ( 36 )$$

and wherein abs in Eq. 33 stands for absolute value of entries of the matrices, DPM^{kl}(q) and IPM^{kl}(q) are the “Differential PM” and “Interleaved PM” which were introduced by Eq. 22, and Eq. 23, whereas we also used the operator of CROMO introduced by Eq. 24. Those skilled in the art can define and calculate icpᵢ^{k|l} in other sensible manners depends on the objectives, definitions of the events of interests, and situations, without departing from the sprit and scope of this disclosure.
Moreover, using other types of “association strength measures” introduced in Eqs.16 through 19-2, we can further instantiate further types of Causal Association Strength Measures.
Similarly using the relations Eqs. 16 through Eq. 20-3 and 20-4 we can also introduce the one or more “Causal Conditional Probability of Occurrences” in a similar fashion which in light of the above equations and description is straightforward except the careful usage of the indexes i and j.
The interpretation of various CASMs are now given here. The CASM_1 is instrumental in identifying the anticipated changes in state components (e.g. SC^{k}) given the current state components. This measure therefor can be used to anticipate the likely changes in the components of the SC^{l}, i.e. another state component of order l, given the current state component of order l. More importantly it can identifies the bonds or strengths between the existence of a certain state component and estimate, predict, or anticipate what will be the next state components. The term ‘Causal’ therefore is appropriate because one can identifies that presence of which components will be followed by changes of other certain state components or changes in some state components have been preceded (or loosely speaking resulted from or caused) by presence of some other state components (i.e. the causal associates). Apparently again this type of associations are also asymmetric.
In this way one can further identify “causal value significance measure” for lower order state components. Therefore from CASM_1 one can define a “Causal value significance measure” of type one, CVSM_1, for state components of order k as the following:

cvsm_1ᵢ^{k}=Σⱼcasm_1_{i→j}^{k|l} (37).

The higher the cvsm_1^{k} for a state components of order k the more important and significant this state component is in the transformations of the higher state components (e.g. SCᵢ^{l} and l>k) and as the result for the whole navigation. Acquiring knowledge of such components become extremely important in investigation and, explainability, and interpretability of the systems of knowledge be it a medical body of data or body of data collected from a vehicle while been driven for many number of hours. Similar to Eq. 37 other “causal value significance measures” (e.g. cvsm_2^{k}) and, as further disclosed in the supplementary section of this disclosure, other types of “value significance measures” (VSMs) can be defined and calculated and processed from all types of “association strength measures”
The “Causal Association Strength Measure” of type 2, CASM_2^{kk} (p, q), is instrumental in identifying the state components (specially the lowest order state components) that change with each other which might be due to a common cause or multiple factors. It is noticed that factors here, as can be appreciated, are in fact the state components that their changes affects significant changes in state components of higher order. For instance, appearance of certain state components of order 1 (one) in a i^{th} state components of order 2 (two) will coincides with changes in some of the state components of order 1 in the (i+q)^{th} state component of order 2. Once the state component of order 2 sees that certain state components of order 1, which was absent in the previous state, suddenly appears then the whole state components of order 2 will change coincidently with that change or the appearance of this factor. As an example, in vehicle driving, appearance of a state component of order one corresponding to existence of a pedestrian in the visual unit will coincides with many changes in appearance or disappearance of other state components of order 1 in the next few state comments of order 2 (e.g. the vehicle acceleration is changed to deceleration or beak or cause the change in steering control signal etc.). The term ‘Causal’ therefore is appropriate because one can identifies that changes in which components will be followed by changes of other certain state components or changes in some state components have been preceded (or loosely speaking resulted from or caused) by changes in some other state components (i.e. the causal associates). Apparently again this type of associations are also asymmetric.
To illustrate this further let's assume our first order state component are the discretized or quantized numerical values of the parameters of interest (e.g. the voltage of acceleration control signal, the steering control signal, the GPS info, speedometer data, odometer data, textual data, or some encrypted strings, all output data of sensory device and the all the desired info from visual recognition unite such as the recognition of red light signals, the distance from an intersection, presence of pedestrian, 4G, 5G communication signals and symbols, etc.) and the state components of order 2 are vectors with binary values showing the presence or absence of that particular state components of order one in that instance of time. Consequently the PM¹² is, therefore, a matrix whose columns are corresponded to state components of order 2 and each row correspond to one of state components of order 1.
Then DPM will be a matrix with entries of −1, 0, or 1. An entry of 1 in i^{th} index/row of each column j of DPM¹²(q) shows the appearance of i^{th} state components of order one, 1, in q columns after j^{th} column of PM¹², ie. q steps in future, a −1 entry in the i^{th} location/index of j^{th} column of DPM¹²(q) shows the disappearance of i^{th} state components of order 1 in q column after j^{th} columns of PM¹², and an entry of 0 in the i^{th} location of j^{th} columns of DPM¹²(q) shows no change in the presence or absence of i^{th} state component of order 1 in q column after j^{th} columns of PM¹².
Many interesting information and interpretation will be observed. For instance the resultant Causal COM from DPM can have entries with negative values, positive and zero values wherein each indicates different meaning. A highly negative causal co-occurrences, that is calculated from DPM, between two state components of order 1 is an indication of mutual exclusiveness (whenever one component appears the other will disappear) whereas a highly positive causal co-occurrences shows highly dependent relationship between the two components, whereas a zero causal co-occurrence between two state components does not provide much information without further investigation (it could be that they never change with each other or consequent to other or they do change independently, i.e. statistically independent from each other, which needs more closer look).
In one preferred embodiment the icp in the relations
Consequently the resulting “Causal Association Strength” show even further distinguished relationships between the state components that can be used for navigating the machine or system in its state space or for predictions and/or estimation of optimal state-action decision making
The CASM_3^{kk} (p, q), is instrumental in identifying the causal association of changing state components in a way to anticipate changes of state components with each other regardless of the type of their association whether they are changing in mutually exclusive manner(in which observing a change in certain state components will almost ensure the disappearance of other certain components) or highly dependent manner (in which changes in certain state components will almost ensure changes in other certain state components). Therefor high value entries of CASM_3 ^{kk}(p, q) indicate knowledge worthy relations between the corresponding state components. That is, a high casm_3_{i,j}^{kk}(p, q) individual entry of CASM_3^{kk}(p, q) indicates that there are some interesting noteworthy relationships between SCᵢ^{k} and SCⱼ^{k} regardless of their type of relationship. Therefore this measure will quickly extract the knowledge about SC^{k} of the system of knowledge which play a significant role in the behavior of the corresponding system (the system that has produced such data).
The CASM_4^{kk}(p, q), is instrumental in identifying the causal association of changing lower order state components in a way to anticipate changes in SC^{k} given the context of both higher state components of SCₚ^{l} and SC_{q}^{l} which is mostly similar in nature to CASM_1^{kk}(p, q). The measure not only give upfront knowledge and information about changing low state components in view of two or more higher state components but also can indicate the presence or the context of new state that the system will enter into. Again this measure alone or in conjunction with other measure/s can ensure certain level of sanity of navigation by confirming or anticipating the general context of the future state (e.g. state SC_{q}^{l}).
Similarly the CASM_5^{kk}(p, q) carry the knowledge and information about the contextually, i.e. the smooth-ness or proximity, or anticipation of future higher order states.
It is noticed that in practice p and q are either the same or consequent to each other or having other desirable distance from each other in the sequence of recorded higher order state components.
As another example of interpretation and uses of various Causal ASM, consider a textual body of knowledge, a BOK, then the association strength of low order state components calculated using “Interleaved Participation Matrix”, IPM, (i.e. CASM_5 ^{k|l}(q)) can be interpreted as a measure of how appearance of a low state component (e.g. words or phrases) in a higher consecutive state components (e.g. next sentences) can steer, shift, or navigate the context of the subject matter of the text as it being composed. We can call this an “induction property” for SCs, and shows that how certain words can influence or cause the following sentences being composed semantically. In this case this measure of association is instrumental in, for instance, building a conversational system which can interact with another client (e.g. a human user or a conversant agent) to ensure the continuity and sanity of the conversation and preserving the context of conversation while also producing informative and knowledge worthy utterance.
These measure are instrumental in interpretability, explainability and predictability of the systems and applications that use the methods, systems and concepts of the current disclosure.
Accordingly using the one or more of measures of association and value significance of state components of various orders and building the corresponding data objects (as thought and disclosed in this patent application) one become able to build generally intelligent and knowledgeable systems capable of navigating through the spaces with high degree of confidence, sanity, rationality, interpretability and explainability.
In passing, it should be noted that the term “Causal” here is used to indicate a probability of Causal relationships between state comments as opposed to a concrete factual causal relationships, as in reality there cannot be found one to one causal relationship between any two state complements. In fact in reality a cause and effect event cannot be conceived in a universe with only two lower order state components and there should be at least one more component in order to see an event taking place. Therefore the knowledge of at least one more state component is needed to infer a causal relationship between any two state components. This is especially more true in worthwhile non-trivial challenges of real life such as medical, engineering, economics, and generally well-being of societies.

### II-III-III State Navigation

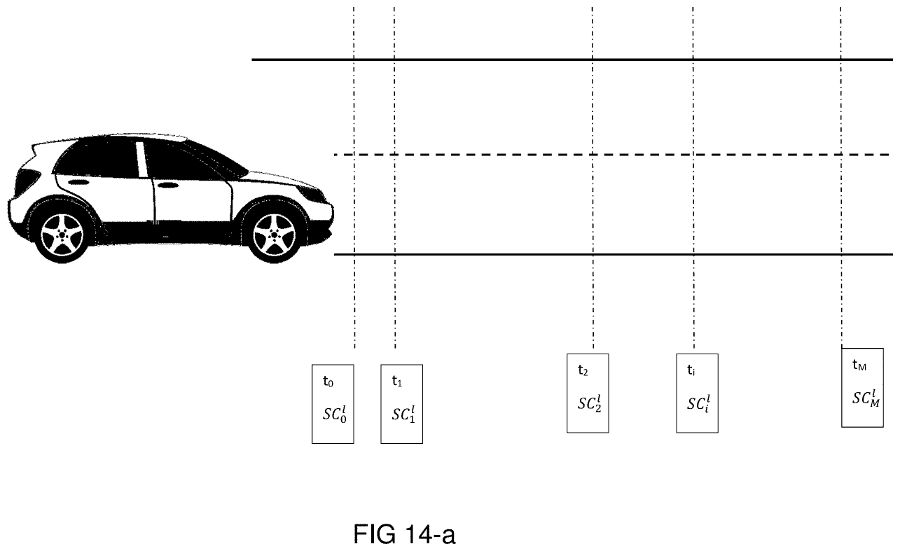

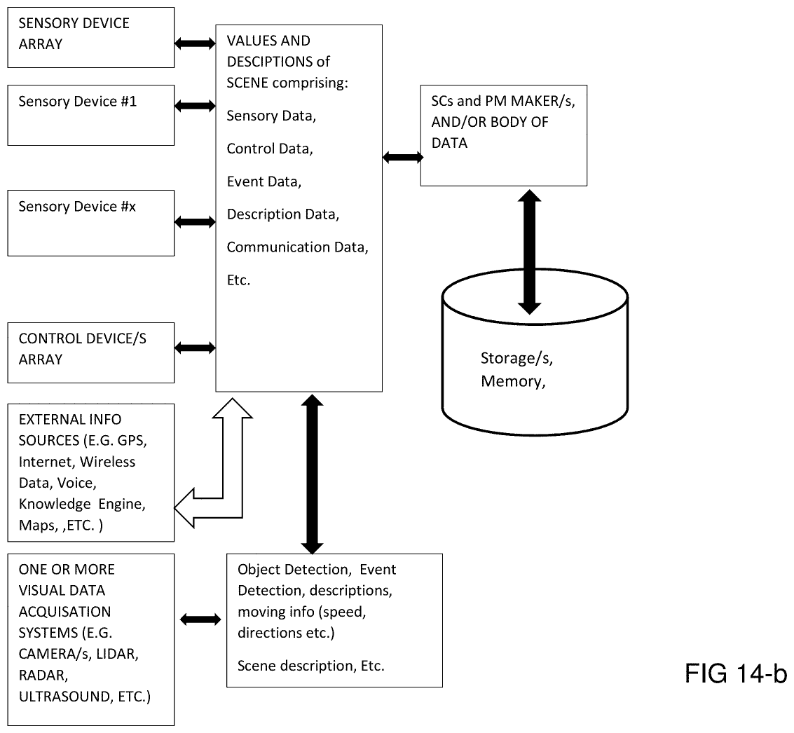

In this section we explain in details how to gather the data, build the compositions of states, and exercise the teachings of this disclosure in one exemplary but important application case of the current disclosure.
To build an autonomous intelligent being (possibly with limbs and physically enabled to perform works as defined by a physicist) one need to ensure that the decisions being made by such machine/system is first of all sane and secondly is useful and purposeful toward being valuable to a society of human beings. Accordingly such a system should navigate through the space continuously (space in its sense of both its physical space and mental state or knowledge and skill space).
In order to navigate the system through its physical or state space reliably and safely, the navigation and transitioning should be sane, rational, dependable, and more importantly the decision (to transit from one state to another particular state) that are being made by the system should be explainable and the results of navigation system should be interpretable as well.
Then the issue to address is what is sane? We define sane as something which is not against the inner workings of the physical/mathematical world. To be sane means do not do something which is too distant from the norm unless there are evidences forcing one/system to do that.
The sanity and rationality can be extracted from the investigation of body of the data, as explained along this specifications, collected from the state transitions of the system in real world and from the behavior of an intelligent sane being in navigating such systems.
An exemplary way of building such system of knowledge, corresponding to the state space or universe of an autonomous mobile system, according to this disclosure, is by collecting all possible and desired types of data (such as sensory data, environmental data, visual or equivalent data, system control data, commanding data, communication data, conversing data, user interface data, etc.) from some real situation by, for example, recoding all such data during a 100 hours of driving a car in various situations. For instance such data is recorded while driving and interacting with a vehicle in city traffic, highway traffic, urban traffic, downtown traffic, drop of, pick up, with and without human inputs both verbally or physically and the like.
Accordingly methods are disclosed to arrange these data in exemplary embodiments to gain the knowledge necessary and useful in building autosomes mobile systems.
In one preferred exemplary embodiment, according to this disclosure, we assemble such data for each instance of time and concatenate them to make very long string/content with marker separating the time intervals at the time of recording data. Usually the time interval could be regular and periodic so that for instance we record all incidence and values of such data at 1 micro second time intervals. Let's say the dimension of the desired state components (e.g. the number of the lowest order state components) at any instance is 1 million (considering different ranges of sensors, natural language vocabulary, etc.) then at each instance of 1 micro second we have a string of data carrying the information about presence or absence of such components in that instance of time. For instance, as illustrated in FIG. 14-a, each event (i.e. a state component of higher order, 1) is accompanied with one or more sets of state components, say state components of order k, such as:

1. A numerical (e.g. integer 8 or float 64 bit) array of data corresponding to, for instance, environmental sensory data (such as temperature, light, atmospheric pressure, any desired and conceivable types of data and any particular sensory data);

2. One or more array of data or data files corresponding to one or more visual scene of an event. These data, for example, can be gathered from Cameras, Lidars, Radars etc.

3. One or more set of state components, corresponding to the description of the visual scene of the even. For example a one or more list of encrypted or natural language textual data (e.g. an English language paragraph text) which describe the visual scene of the event.

4. One or more array of data corresponding to values of controlling signals at an event.

5. One or more array of data corresponding to communicating devices such as 5G/6G wireless data, external data, municipalities data and the like that can be accessed during gathering the data.

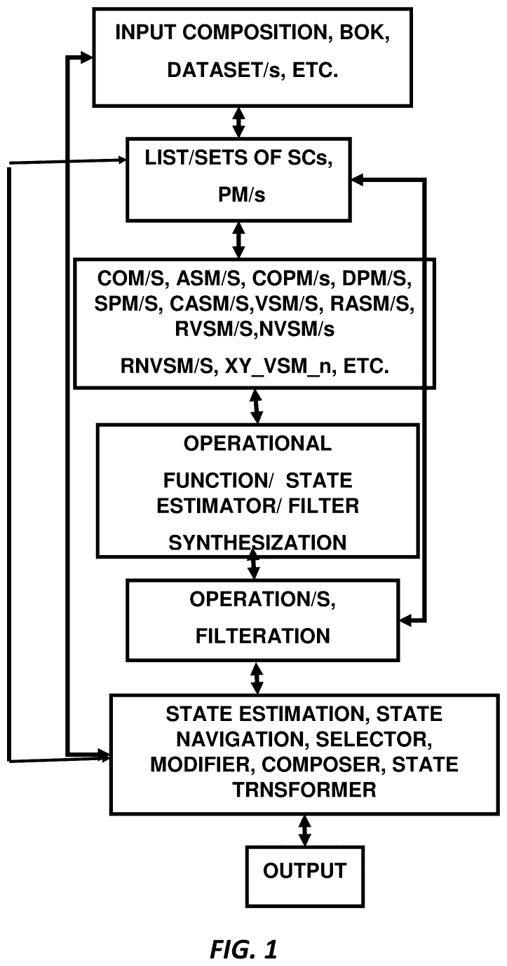

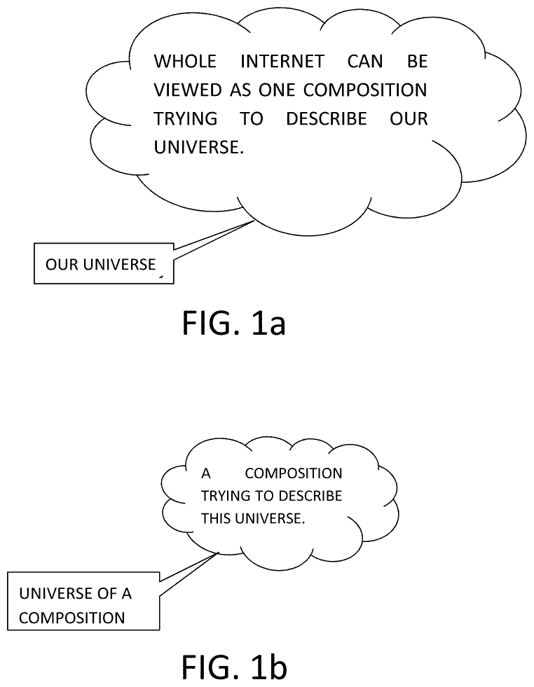

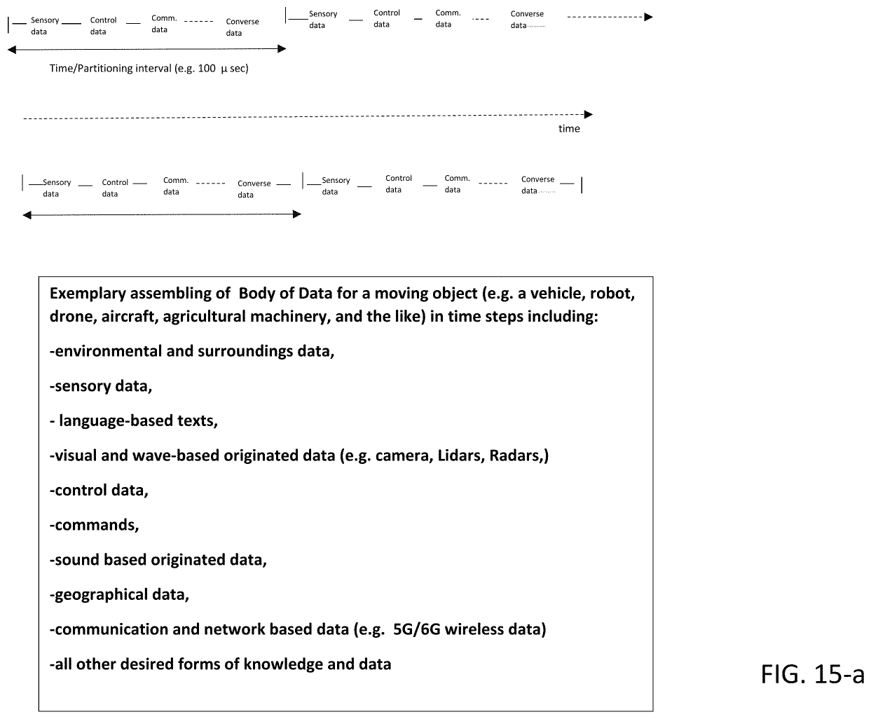

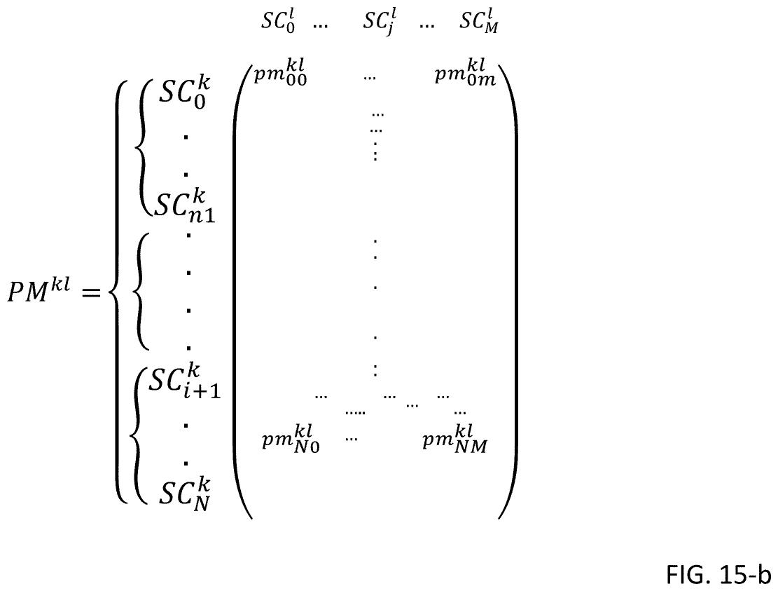

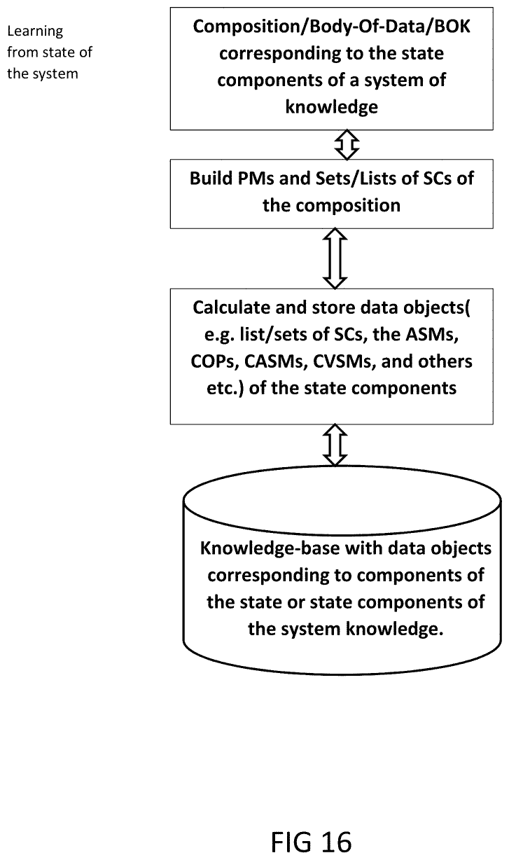

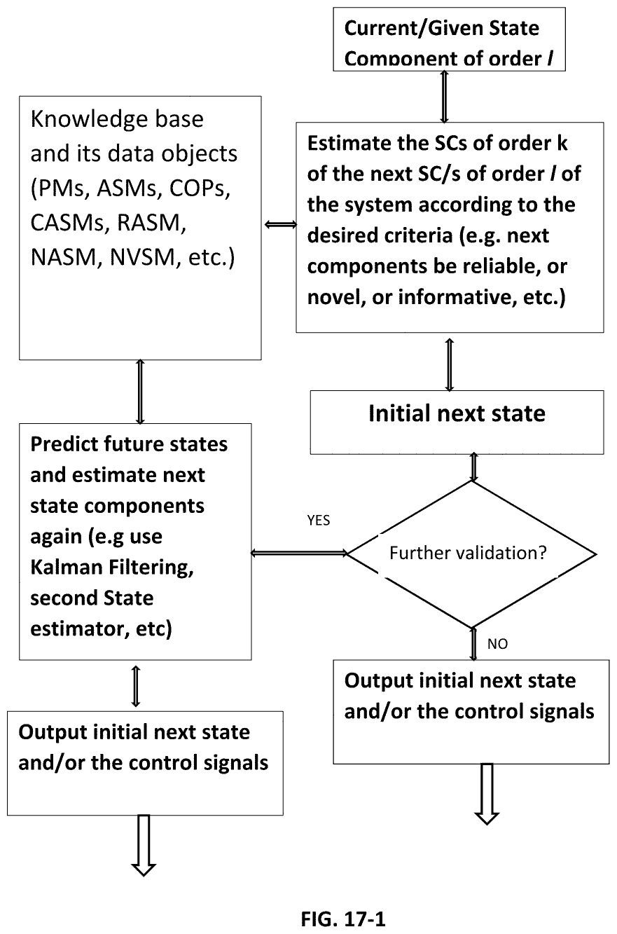

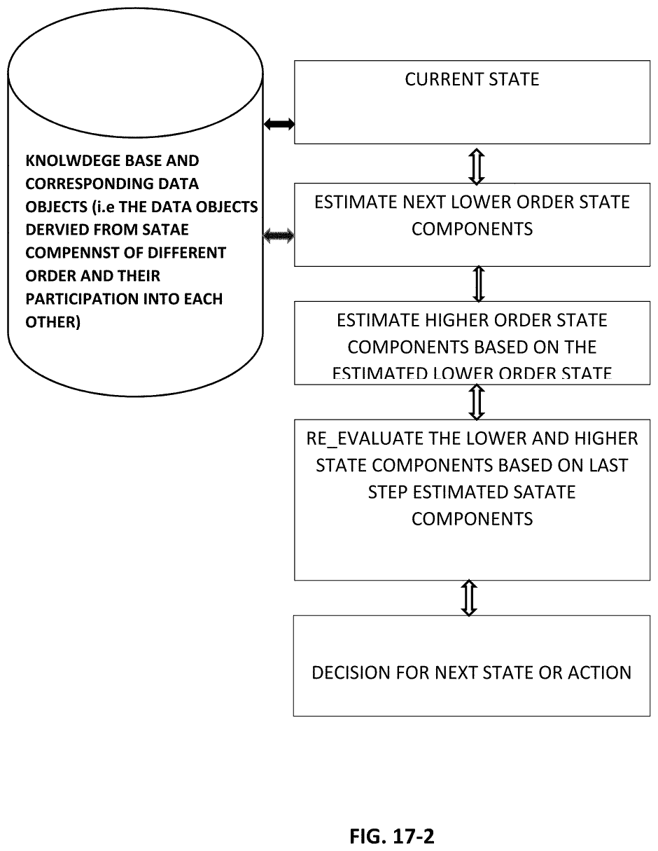

After assembling the body of data then following the methods of partitioning the data and assigning order to different sets of partitions or defining the state components of various orders, one can proceed to build, as illustrated in FIGS. 14-b, 15-a and 15-b, one or more data structures corresponding to the participation of one or more of the group/set of data arrays in another set of data. As stated before, in the present invention we call such data structure participation matrix or matrices since the corresponding array/s of data can be conveniently summarized and be represented by numerical matrixes with rows and columns.
More usefully or particularly a matrix showing the data values for each event. For instance each value of a sensory signal corresponding to a sensor can be represented by a row in the matrix, and each event is represented by a column (see FIG. 15-b).
Having constructed one or more desired participation matrices, as depicted in FIG. 16, these data objects are used for navigating through states or for transitioning from one state to another state in such a way that the transition is consistent with a such transition that is expected from a an intelligent/cognition-able/conscious being such as a trained human being or any other similar being.
Accordingly, using one or more participation matrices and using or computing one or more of “association strength measures” and conditional probability of occurrences, one can, therefore, project the participation value of lower state components of future (or past) state components of higher orders.
To enable our system to navigate through the space we (after building the dataset or the composition or the system of knowledge, and breaking the compositing into one or more state components of different order and build corresponding participations matrices) build other data objects according to the exemplary embodiments of this disclosure, and arriving at various associations strength matrices, and various conditional probabilities which enables us to design the navigation system.
Now assume we are at the j^{th} state component of order l (i.e. SCⱼ^{l}) and we want to move through the physically space (e.g. in the case of mobile/movable system, such as vehicles, robots, drones, plane, space craft, etc.) or its corresponding state space. To move around the space using the disclosed methods and the resulting data objects and information that one can acquire from the investigation of the composition, by exercising the methods of current disclosure, one can devise one or more rational scenarios, algorithms and methods enable a system to navigate through its space (supervised, semi supervised, or autonomously)
For instance, in one embodiment one can use the causal type association introduced in last section to evaluate the state components of order k of the SC^{l} at the (j+q)^{th} or to evaluate or estimate some of constituent SC^{k} of the SC_{j+q}^{l} (q≥1).
Then having some of the SC^{k} of the SC_{j+q}^{l} one can further use the desired or most appropriate combinations of various types of association strengths and conditional probability of occurrences to estimate the most rational other SC^{k} of SC_{j+q}^{l} and make a decision as how transit/move the system from SCⱼ^{l} into SC_{j+q}^{l} or navigate through its space.
Furthermore as depicted in FIGS. 17-1 and 17-2, the system can further make sure to have made a right decision by evaluating or estimating the higher order state components (.e.g. SCⱼ^{l+1}) to gain upfront information about the possible future events and states or to anticipate/project the future context so that if the future path is not desired for any rational, then change its decision by assigning the right values to the state components of order k, SC^{k}, of SC_{j+q}^{l} if necessary . Furthermore once a projected SC^{k} components of next SC_{j+q}^{l} is estimated other methods such as Kalman filtering can also be used to further solidify the decisions about the components of next state of the system. Once the presence/absence(i.e. the participation) of certain lower state components in the next higher state components are estimated or projected then the system can proceed to navigate or transition into its next state (e.g. decide to accelerate, decelerate, steer left gradually, steer right gradually, or keep driving steadily, etc.)
In another exemplary embodiment, from the current state vector (i.e. the SC^{l}) we can compute the next state thorough cop(i|j) and specially causal cop(i|j) (the cop that uses causal association, casm) in order to have the knowledge that explains why the next state components of the system should be present in the next higher state component.
Then having estimated the most likely or suitable components of the next state the system can proceed to transit to the next state and keep continuing its trajectory through space-time, or its universe of body of knowledge.
Because the associations of the components and knowledge about their relationships (causal or contextual) is learnt from data of real world, therefore it can be strongly argued that the estimation of the components of the next state and the decision in transitioning to the next estimated state is a sane, rational and right choice. When system encounters the situation that does not have a record of, the system can make the best optimal decision rooting in physical laws and realities of our universe.
For instance, to test the effectiveness of the state transitioning of the system, according the to the teachings of the current disclosure, we can simulate the propagation of an electromagnetic wave/signal (e.g. a laser light or a microwave signal) in a predefined propagation environments in which some of its properties (e.g. the permittivity) varies along the propagation direction of the wave and gather the data, for instance, about the amplitude distribution or shape of the wave function along the perpendicular axis to the propagating axis. In the first run the simulation is done by solving Maxwell's equations for such environment and the data gathered accordingly along different steps of the propagation of the wave. Now in the second run we do not use Maxwell equation to simulate the wave proportion but rather we use the dataset gathered from the first run and calculate the data objects of interests (e.g. VSMs, and ASMs, CASMs, and COPs) and from one or more initial state data (e.g. the initial wave distribution at some point along the propagation axis and other data corresponding to the propagating environment properties at that points,) we were able to project the next wave distribution states very accurately and efficiently as the propagating environment properties varied along the propagation axis. This test confirms that from the data of the first run simulation our space navigation system become knowledgeable about the behaviors of wave propagation in the environments so that without consulting with governing equations (i.e. the Maxwell wave propagation equations) it become able to accurately predict, project and navigate the wave through the propagation environment.
The state transitioning can also be calculated or estimated for a block of state components or any other higher state order state components, therefore higher state components can provide a context within which the prediction or estimation of the participation of lower order state components can be checked and re-evaluated again.
For example as a real life self-deriving vehicle(or any other kind and type of robots) consider or assume that that state components with assigned order of 1 are the actual discretized and quantized values of all types of sensory data, control data, actuators, and natural language vocabulary that described the scene (outputted from visual investigation units) and other desired and conceivable forms of participating sate components etc., and state components that assigned with order 2 is comprises of values corresponding to the values of the state components of order 1 (i.e. the presence or absence state components of order 1 which in a participation matrix forms a sparse columns of the corresponding PM¹²) that are recoded and stored in time steps of 1 ms (or any other desired time steps), i.e. their corresponding representative of state order 2 are the columns of the Participation Matrix 1 into 2 or PM¹² of the collected states over time. Consequently let's consider every chunk of 10 (or 100 or any other desired length) state components of order 2 as members of a set of state components that are assigned with order 3 and so on.
Now when the vehicle (or robot) start from an initial state (an SC²) and want to estimate and direct the next state or next movement/command/control etc. of the vehicle then using the teaching of the this disclosure we can have estimated the most probable appropriate values for state components of order 1 and from there we can estimate the one or more next state components of order 2 and from there we can estimate and have a good prediction or projection for the state components of order 3 or 4 (state components of order 3 or 4 provide a good future context to the estimator/investigator/decision making system) once we know the most likely state components of higher order we can use that information to refine our initial estimate again in order to increase the chance of making a more rational and sane decision.
For instance, if given the state components of order 1 of the current state component of order 2, predicate or will instruct/command/control the system to accelerate rapidly but there is one state components of order 1 which is present in the current state components of order 2 which does not affect the state components order 1 of the next immediate state components 2 but the system have acquired the knowledge from the Body of data/knowledge that usually the presence of that particular component will have a significant effect (and potentially undesired) in the future states.
Therefore estimating the components of higher order state components from current lower order state components can provide a probable scenario in the further along navigation and therefore can tip the decision maker/investigator to correct its path in the state space, even though such state have not been observed or has not explicitly been observed before or at least not in the vicinity of current higher states.
Further it should be noticed that in practice for any one or more state components of order k there is usually a large number of state components of order l (l>k) that show strong association (consensus, novel, more informative, most probable etc.) and can be projected as the next higher order states. Therefore after each initial prediction more targeted and relevant knowledge is identified that can be used to refine the decision if desired.
As can be seen if the estimation of next action is used in stimulatory environments (with decision from a human decision maker or driver) then the body of knowledge can be enriched significantly. Such a stimulatory system can also be used to create novel scenarios and record the state components for this improbable scenarios in order to ensure that the real system have the knowledge to deal with as many possible scenarios as possible.
Similarly such systems can be used also for training a human operator such as in navigating an airplane or other mission critical machineries when human decision making for any reasons (e.g. legal requirements) is preferred.
Moreover it can be seen that in stimulatory environments it is easy to adapt the system (by introducing special conveyer or rewards for certain desirable states) to learn specific skills similar to reinforcing learning.
In a broader sense the resulting autonomous space or state navigation could also be used for training in any profession (Law, Medical, technical jobs, etc.) or similarly educational purposes such as in variety of schools and universities.
All these are possible because the system of present invention can extract the knowledge from the body of data/knowledge in order to have enough knowledge of the world (e.g. in an unsupervised manner) to deal with real world events and change their state rationally (not stochastically) in a predictable manner as the time evolves while having known the trace or the reasons for making such decisions to transition from an origin state to the destined state.
Furthermore, as pointed out before, those skilled in the art can store, process or represent the information of the data objects of the present application (e.g. list of state components of various order, participation matrix or matrices, association strength matrix or matrices, and various types of associational, relational, novel, and causal matrices, various value significance measures, co-occurrence matrix/matrices, and other data objects introduced herein) or other data objects as introduced and disclosed in this disclosure (e.g. association value spectrums/vectors, value significance measures, state component map, state component index, and the like and/or the functions and their values, association values, counts, co-occurrences of state components, vectors or matrix, list or otherwise, and the like etc.) of the present invention in/with different or equivalent data structures, data arrays or forms without any particular restriction.
For example the PMs, ASMs, SCMs or co-occurrences of the state components, COMs, etc. can be represented by a matrix, sparse matrix, table, database rows, NoSQL databases, JSON, dictionaries and the like which can be stored in various forms of data structures. For instance each part, section, or any subset of the objects of the current disclosure such as a PM, ASM, SCM, CASM, RNVSM, NVSM, and the like or the state component lists and index, or knowledge database/s can be represented and/or stored in one or more data structures such as one or more dictionaries, one or more cell arrays, one or more row/columns of an SQL database, or by any implementation of NoSQL database/s of different technologies or methods etc., one or more filing systems, one or more lists or lists in lists, hash tables, tuples, string format, zip format, CSV files, sequences, sets, counters, JSON, or any combined form of one or more data structure, or any other convenient objects of any computer programming languages such as Python, C, Perl, Java., JavaScript etc. Such practical implementation strategies can be devised by various people in different ways.
The detailed description, herein, therefore describes exemplary way(s) of implementing the methods and the system of the present invention, employing the disclosed concepts. They should not be interpreted as the only way of formulating the disclosed concepts, algorithms, and the introducing mathematical or computer implementable objects, measures, parameters, and variables into the corresponding physical apparatuses and systems comprising data/information processing devices and/or units, storage device and/or computer readable storage media, data input/output devices and/or units, and/or data communication/network devices and/or units, etc.
The processing units or data processing devices (e.g. CPUs) must be able to handle various collections of data. Therefore the computing or data processing units to implement the system have compound processing speed equivalent of one thousand million or larger than one thousand million instructions per second and a collective memory, or storage devices (e.g. RAM), that is able to store large enough chunks of data to enable the system to carry out the task and decrease the processing time significantly compared to a single generic personal computer available at the time of the present disclosure.”
The data/information processing or the computing system that is used to implement the method/s, system/s, and teachings of the present invention comprises storage devices with more than 1 (one) Giga Byte of RAM capacity and one or more processing device or units (i.e. data processing or computing devices, e.g. the silicon based microprocessor, quantum computers etc.) that can operate with clock or instruction speeds of higher than 1 (one) Giga Hertz or with compound processing speeds of equivalent of one thousand million or larger than one thousand million instructions per second (e.g. an Intel Pentium 3, Dual core, i3, i7/i9 series, and Xeon series processors or equivalents or similar from other vendors, or equivalent processing power from other processing devices such as quantum computers utilizing quantum computing devices and units) are used to perform and execute the method once they have been programmed by computer readable instruction/codes/languages or signals and instructed by the executable instructions. Additionally, for instance according to another embodiment of the invention, the computing or executing system includes or has processing device/s such as graphical processing units for visual computations that are for instance, capable of rendering, synthesizing, and demonstrating the content (e.g. audio or video or text) or graphs/maps of the present invention on a display (e.g. LED displays and TV, projectors, LCD, touch screen mobile and tablets displays, laser projectors, gesture detecting monitors/displays, 3D hologram, and the like from various vendors, such as Apple, Samsung, Sony, or the like etc.) with good quality (e.g. using a NVidia graphical processing units).
Also the methods, teachings and the application programs of the presents invention can be implement by shared resources such as virtualized machines and servers (e.g. VMware virtual machines, Amazon Elastic Beanstalk, e.g. Amazon EC2 and storages, e.g. Amazon S3, and the like etc. Alternatively specialized processing and storage units (e.g. Application Specific Integrated Circuits ASICs, field programmable gate arrays (FPGAs) and the like) can be made and used in the computing system to enhance the performance, speed and security of the computing system of performing the methods and application of the present invention.
Moreover several of such computing systems can be run under a cluster, network, cloud, mesh or grid configuration connected to each other by communication ports and data transfers apparatuses such as switches, routers, data servers, load balancers, gateways, modems, internet ports, databases servers, graphical processing units, storage area networks (SANs) and the like etc. The data communication network to implement the system and method of the present invention carries, transmit, receive, or transport data at the rate of 10 million bits or larger than 10 million bits per second;”
Furthermore the terms “storage device, “storage”, “memory”, and “computer-readable storage medium/media” refers to all types of no-transitory computer readable media such as magnetic cassettes, flash memories cards, digital video discs, random access memories (RAMSs), Bernoulli cartridges, optical memories, read only memories (ROMs), Solid state discs, Sild State derives (SSD/s) and the like, with the sole exception being a transitory propagating signal.”

The detailed description, herein, therefore uses a straightforward mathematical notions and formulas to describe exemplary ways of implementing the methods and should not be interpreted as the only way of formulating the concepts, algorithms, and the introduced measures and applications. Therefore the preferred or exemplary mathematical formulation here should not be regarded as a limitation or constitute restrictions for the scope and sprit of the invention which is to investigate the bodies of knowledge and compositions with systematic detailed accuracy and computational efficiency and thereby providing effective tools, products and application in knowledge discovery, scoring/ranking, decision making, navigation, conversing, man/Machine collaboration and interaction, filtering or modification of partitions of a body of knowledge, string processing, information processing, signal processing and the like.

### II-III-V Visual Detection and Object Recognition

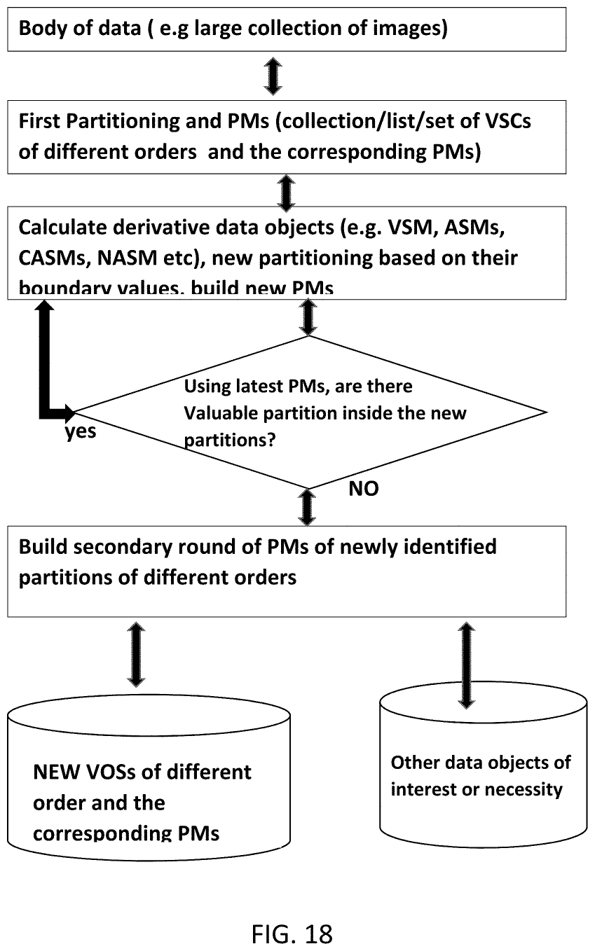

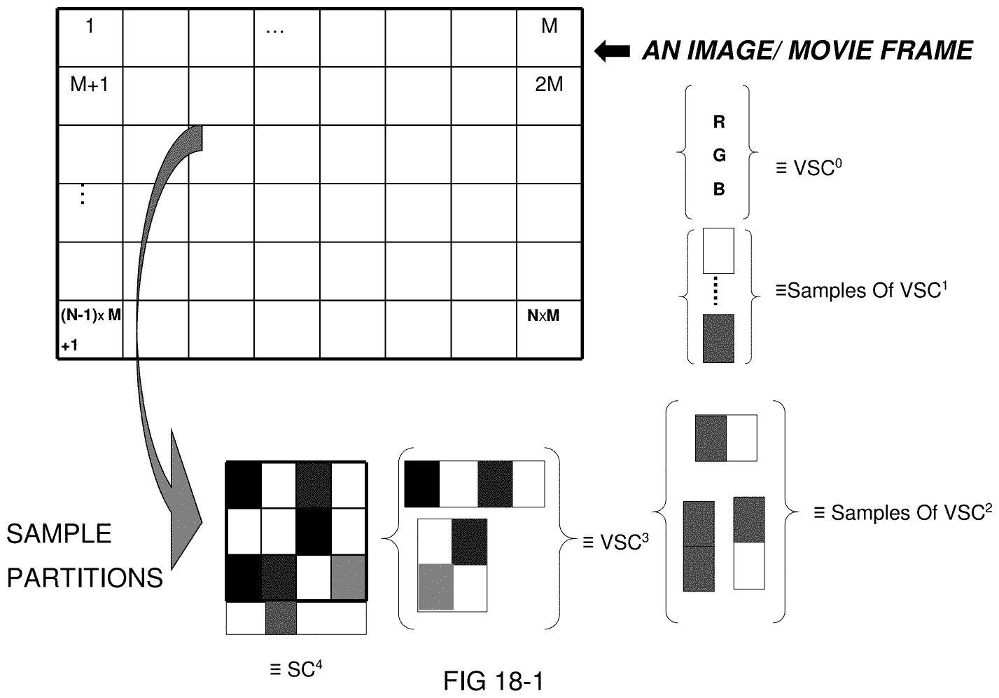

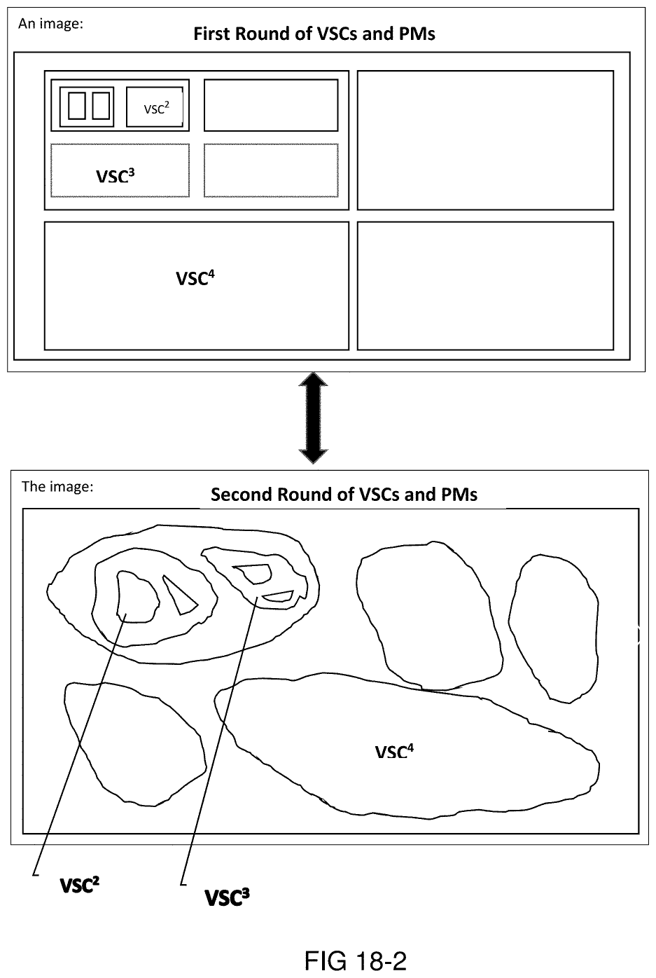

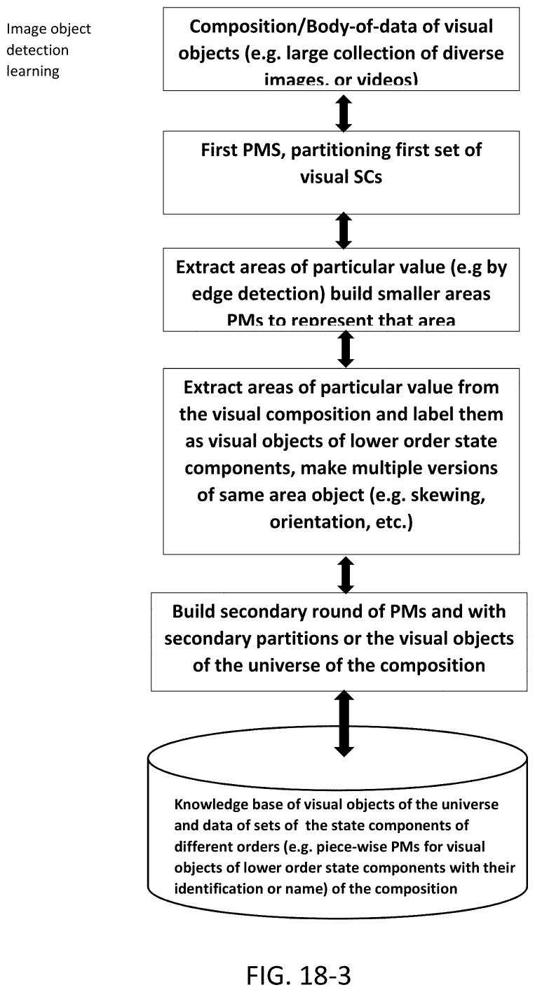

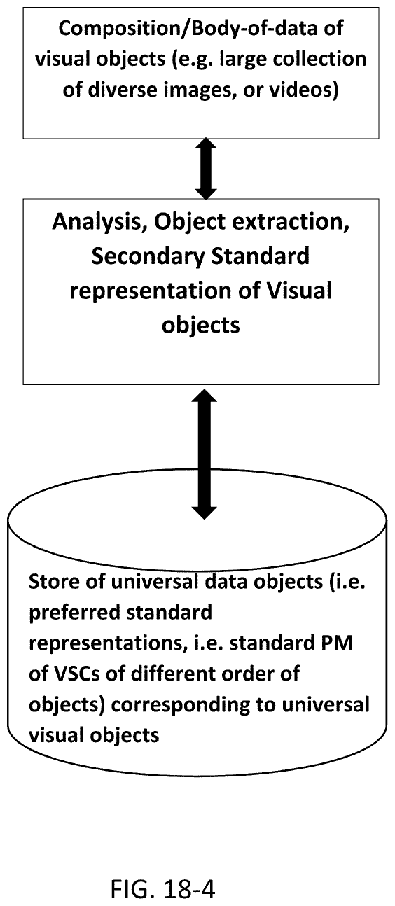

Similar to other type of bodies of knowledge or data and the investigation methods presented here, there are shown in FIGS. 18 to 18-4, one or more unit/s that can use a premade body of data (a collections of very many images or video frames or make a body of knowledge in real time) to make sense and learn about the real world environments and the knowledge contained in the visual scenes to learn about valuable state components of the universe and their relationships by the same methods that were described in above sections. For example by using novelty detection (using various novelty significance measures and novelty associations presented in the supplementary section of this disclosure) the visual investigator can recognize the boundaries or edges of objects/areas in a visual scene, separate the objects, and make a new PM from the detected edges for further and more detailed investigation of such detected visual objects by using the methods of current disclosure with assigning value significance to “Visual State Components” (VSCs) and from computed associations of state components, and decide about the objects of high values in the scene and their relationships with each other.
Accordingly, one of the goals of initial investigation of visual objects is to build a universal or standard representation of visual objects. In one embodiment according to present invention the standard representation of visual objects are corresponding data objects (e.g. one or more PMs) that can be shown and stored or transport by standard participation matrices. Standard PMs for instance are the ones that have a predefined number of VSCs of certain order. For instance an standard PM can be the participation matrix PM¹² in which the row are corresponded to standard pixels, e.g. 2²⁴ true color SVGA or 2⁸ or VGA etc., or a predefined subset of standard pixels. Similarly higher order Visual SCs can also be standardized and used for representing all visual objects with PMs of standard size for at least one of the dimensions of the PM.

In this section another instantiation, application and system of image processing is presented. The system of image processing is basically the system of FIG. 16, wherein, as shown in FIGS. 18, 18-1, 18-2, 18-3, and 18-4, exemplary illustrations are given as how to apply the methods of this disclosure to process image data and gain the knowledge about such bodies of knowledge, i.e. in this instance a collection of images.

After processing of the image/s, the system of image processing can detect, recognize, and classify related or similar images, through calculating various Association and Significance values of State components of visual nature and order.

As seen in FIG. 18-1, one can initially partitions an image or a movie frame down to its individual RGB components of its pixels as State components of order zero, then regards a pixel as composition of RGBs or more conveniently as VSCs of order 1, then, for example, every two adjacent pixels (horizontally and/or vertically as desired) as VSCs of 2, and every 2 of VSCs of order 2 as SCs of order 3 and so on. In this particular illustrations, for example, a SCs of order k is in fact composed of 2^{2(k-2)} (for k>2) pixels. Obviously one may elect to partition the image in another fashion and user different order for any certain number of pixels.

In this way we become able to transform the information of a picture into existence of such ordered state components into each other through constructing data objects or one or more data structures corresponding to the participation matric/es of various order as described and defined along this disclosure.

In one embodiment of the present invention in building “Visual State Components”, VSCs, of an image all the desired combinations of VSCs of different orders can be identified and kept for analyzing the image. For instance for a given VSCs of order l, the VSCs of order k within that VSC can be all the combinations of VSCs of order k. As an example, if we assign an order of 3 to every 3 pixels strip (i.e. aligned horizontally like an strip) then we can have two VSC of two pixels (e.g VSC assigned with order 2) and similarly if we assign an order of 3 to every 4 pixels strip then we would have 3 VSC of two pixels and so on. Therefor one can extract the VSCs of an image in multiple combinations (e.g by sliding the VSCs in one or both directions in the image) of VSCs that can make up or reconstruct the image. For higher order VSCs of square or rectangular shape the possible combinations of pixels and the resulting possible lower order VSCs increases and consequently the resulting PMs become much larger and so the demand for storage and the processing power also increases. Generally as shown in FIG. 18-1 lower order VSCs (e.g. VSCs of order 1 to 3) can be standardized and all other possible higher order VSCs can be expressed by its lower order constituents VSCs. However in practice higher order VSCs of the image are the partitions of the image and limited variations of partitioning are considered rather than all possible variations whereas each partition then can be expressed by its constituents lower order standardized VSCs.

Further the lists of VSCs of particular order defined for visual objects can be a set (all identical SCs represented with one of such) or be listed as they appear in the picture.

Setting the ordered state components of the picture will make the PMs less data intensive resulting faster processing and shortening the image processing task thereof. Furthermore sometimes said setting can also enhance the functionality of the process and lessen the clutters. For instance, if the desired function of the process is to categorize the visual objects, setting the VSCs may help to reduce unnecessary noise beside the data processing effect.

For some other applications however, it might be desirable to keep all the VSCs of any order as they appeared in the picture. In this case index of that SCs in a PM also bears the geometrical information of that SCs (partitions of the picture) in the picture.

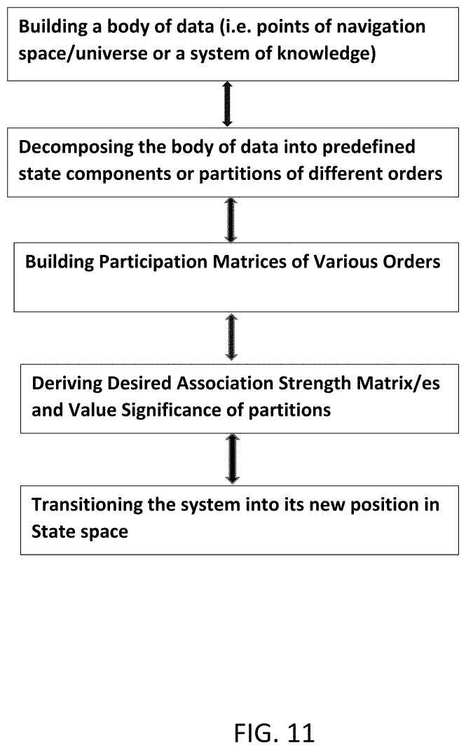

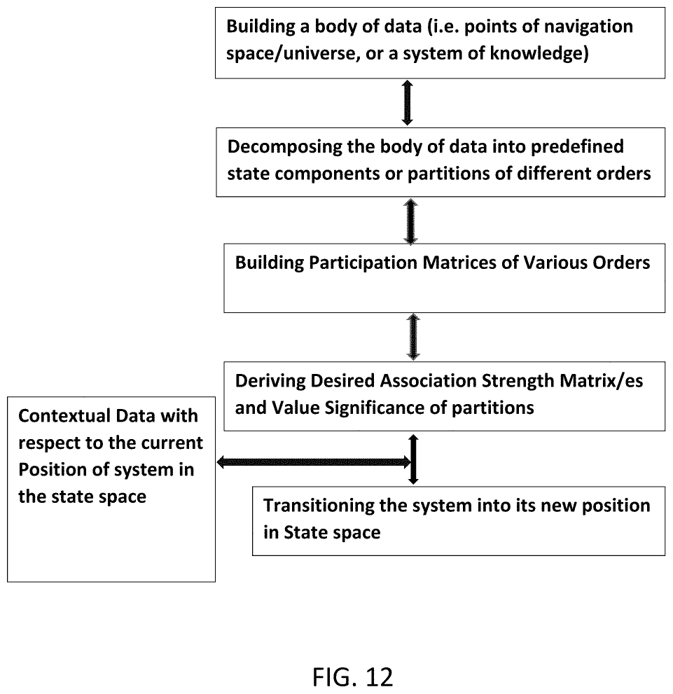

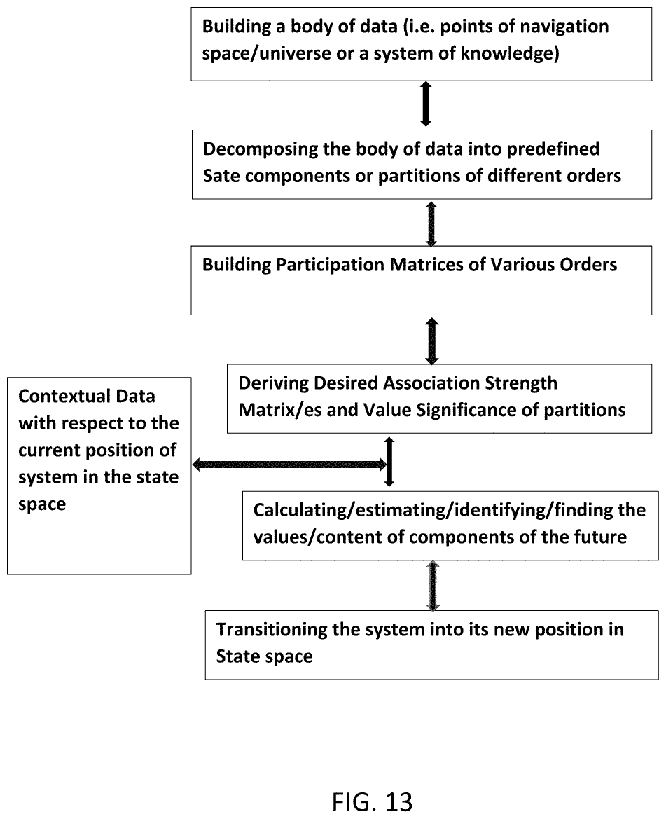

It should be noticed that the indices of the corresponding matrix are in fact an indication of geometrical shape of the objects in the scene as the indices i and j can be interpreted as the coordinates of the VSCs of an image in a two dimensional plan. Therefore when a visual SC of order k is signified as important (according to one or more significance aspects, e.g. novelty) then several of such identified objects show similar behavior and significance values and therefore can be grouped together and from the coordinates (ie. the indices of significant SCs) and he boundaries of the such significant objects in the scene can be recognized and detected as shown in FIG. 18-1-18-4.

For instance the index of the state components (the index of the column or the rows, that each SC will be represented by, in the participation matrix) bears a very important information about a picture and can be used geometrically to characterize a picture. For instance the ratio of the j index of significant VSCs of order 3 of the picture can be used as further information to characterize the picture. New data objects and Matrix/es can be constructed to convey the information of some of the selected VSCs of certain order of the image frame/picture respect to each other. Furthermore, such geometrical information and/or their ratio can be normalized so that they can be used for comparing to other processing needs (identifying a picture in a standard way from a group of other pictures).

Again, the data objects of the present invention (e.g. varicose PMs, ASMs, VSMs, and COPs, vectors or matrices) can be adequately described as being a representation of points in a Hilbert space and linear transformations of the data objects does not have drastic effect on the quality and continuity of the investigation results. Most other transformation (such as rotating an image, i.e. rotating the data of its corresponding participation matrix, or other mathematical operations on the data objects) also would not cause a discontinuity type of effect on the behavior of the result of desired data, e.g the result of a novelty detection or finding significant partitions/segments or edge detection etc, of an image. In other words the disclosed image processing method is much more robust and process efficient than the image processing with neural networks, or deep learning, convolutions neural nets, and classical image processing methods.

Nevertheless as is the case with the textual compositions, the result of investigation of visual compositions, e.g. the presented image processing, can be used to build more efficient and compact neural networks than building a heuristically large neural network. Moreover the data objects that are generated after investigations of a body knowledge, composed of a number of images, can be used to initialize the neural networks for further training. Since the data of the investigation results (e.g. ASMs, VSMs, COPs, RASMs and other data objects of this disclosure) like) are obtained from existing and real images (or in general exhibiting state components rather than randomly possibly existing State components) a deep learning network built and initialized (by using the data of the presented investigation method of compositions of state components) is more likely to converge, and converge faster.

The process is efficient in doing intelligent actions and decision making based on a received or input image/picture. Another advantage of using the present invention as a method of image processing in application ranging from computer vision, navigation, categorization, content generation, gaming and many more, is that the method/s is less sensitive to the orientation and angle and almost invariant since many data objects are built during the investigation that are assigned to segments of deferent sizes of the image. Accordingly by using one or more of these data objects or a combination of different ASM/VSM measures and the information that are extracted from the images during the investigation process, one can assign a distinguishable signature to an input images.

Once the image is partitioned into segments of predefined sizes or pluralities of state components of different orders calculating then obtaining data objects of interests become similar to the described in detailed methods for the textual compositions (see Eq. 64).

Accordingly the system of image processing based on the teaching of this disclosure become able to provide all functionalities of FIG. 1, 10 or 16. An exemplary application therefore would be in computer vision for clustering or classification of images characterization of images, and then acting upon such characterization and recognition.

As shown in FIG. 18, the visual investigator first identifies the areas of the image that have some significances (e.g. VSSs that poses high novelty value significance or any other measure of significances) and collect these areas as secondary higher order VSCs. For instance the boundaries of an objects such as a cat in an image is identified as a secondary VSC and so one. Referring to FIG. 18-2 here, then one or more secondary PMs are build. Then the investigator further investigate (using various VSMs and ASMs, and other derivative data objects corresponding to the image) these secondary high ordered visual objects and try to find more valuable areas in that secondary VSCs, and yet recognize more objects in that VSC and repeat the process until no significant areas is discovered. Then these sub areas are represented by standard PMs and is labeled either with human input or automatically labeled. Automatic labeling can be done with assigning a unique string of character to each of the final detected visual objects. In this way a standard representation of a visual object is obtained and indexed. Accordingly the visual investigator can acquire the knowledge about very many objects of real world and index and calcifies them in standard forms of data objects (e.g. sets of standard VSCs of different order and their respective participation matrices of various order). The method is illustrated and described in Figs in 18-3 and 18-4.

In particular, for robot visions, autonomous robots, intelligent expert (e.g. medical assistant robots), autonomous or semi-autonomous transportation robots (e.g. self-driving car, truck, drone, self-flying objects, etc.).

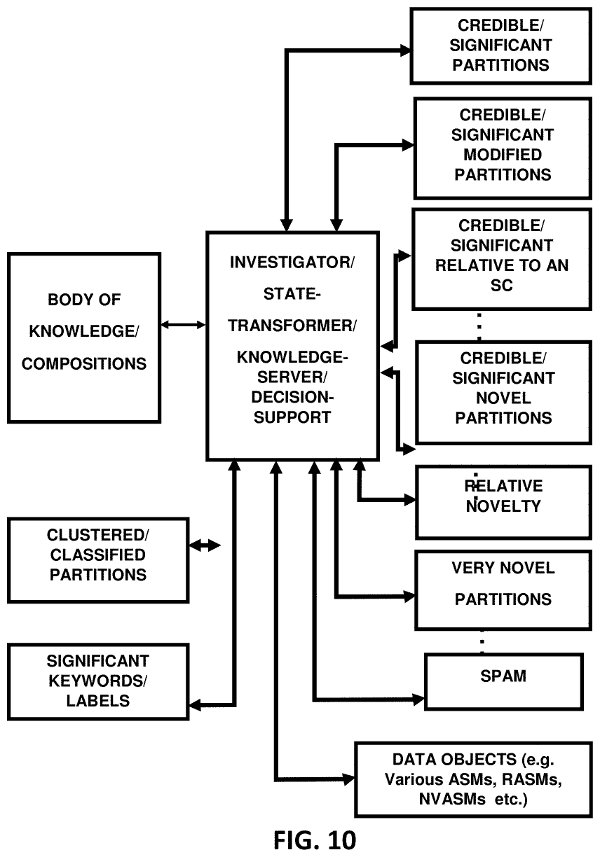

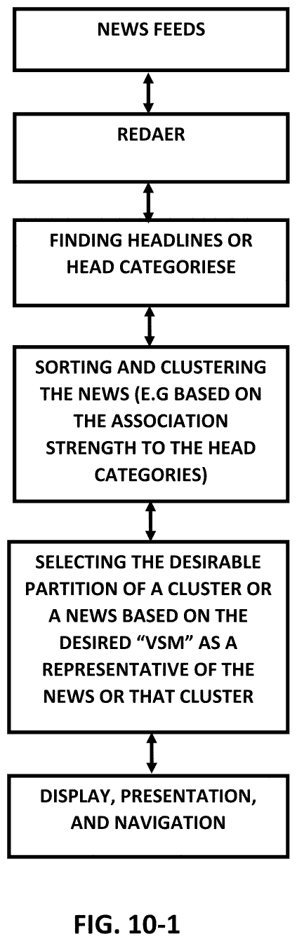

Once an image is characterized and its relation to a cluster, category or class become known, a system or machine that comprises the image processing/investigation of the present disclosure, can issue further instructions or signals to be used by other systems or parts (e.g. another machine, software, robot, intelligent being etc). Such systems/machines can therefore achieve a cognition and understanding of their surroundings and environment. Further, using the present disclosure's method of investigation of compositions, such systems and machines are capable of conversing and exchanging data and knowledge not only with other machines but also with human by conversing with human clients through human consumable languages or content such as voice or machine generated multimedia content.
For instance using the Novel relational associations measure (Eq. 1 to 37 and 38 onwards) the investigator system of FIG. 10 become able to distinguish movements and their speed (as shown in FIG. 18-1, visual SCs can be traced by their indices in the partitioned images and therefore partitions of the consequent images of a live camera (i.e. movie frames) can be traced and their identities and motions can be calculated by using their indices in the partitioned image.
One particular use of the methods and algorithm of this disclosure is to rank the images based on relational value significances using association strengths values of State components of different order (see supplementary section of this disclosure).
An interesting system is for image recognition when ranking an input image as how that could be related to an state components. For example how an image is close or contain certain object or living thing etc. or, for instance, whether there is a tree in the image. In such system for this application the system of FIG. 10 comprising data processing or graphical processing units have the details of a tree picture along with partition as number of sets of state components of predefined order as been illustrated in FIG. 18-1.

Then among a body of compositions of images we can identify whether an input images contain certain state component (considering that one can regard a whole image of tree/tress as SC of order 4, 5, or higher) then its constituent partitions such single pixels as SC order 1, 2 pixel partitions as set of SCs of order 2, 4 pixel partitions as set of SCs of order 3, 16 pixels partitions as set of SCs of order 4 and so on.

One can find the associations of the partitions of the picture and using some or all the Eqs. 1-64 to build data structures, programing a GPU, program an FPGA, design a system on chip, design and build an application specific computing devices such as ASIC using silicon or III-V materials, a data processing apparatus comprising one or more computing or data processing devices, and to evaluate or score or rank the relevancy of an input image/picture to a target or desired image/picture, category, concept, function, signal, or instructing a machine or order a machine to perform a desired task or operations. For example how closely an input image or picture is related to certain entity/ies, like a cat, a tree, a house, a car, a passenger, a movable objects (as the target State component), or when there are very number of images then use the method for classification and categorization of images.

Furthermore, the image/pictures can be preprocessed by known digital signal processing to do for example, rotate the input picture once or more with certain angle, change the orientation, resize the image/picture to a predefined pixel size, or a desired height and width, or predefined dimension (e.g. every picture transformed or re scaled, or resizes to 320*320 pixels or to a 1000 by 1000 pixels, or one Mega pixels etc.) Further the range of possible combinations (R, G, B), with or without the pixel depth data, can be changed or reduced. For example the image/picture can be transformed to gray scale only, or range of pixel color be reduced to a desired number of colors, e,g. from 256×256×256 number of colors be reduced to 16×16×16 number of colors or the like.

Moreover, as mentioned before, another useful data objects which can be used as part of standard visual objects representation is various ratios of the i^{th} to j^{th} indices of the significant VSCs of each image which carry the knowledge of geometrical shape of a visual objects. For instance we can build a “Visual Geometrical Matrix” (VGM) corresponding to a visual objects , in one simple exemplary form, as follow:

$${VGM ( p , q )}^{k \vert l} = f ( \frac{{x}_{p}}{{x}_{q}} , \frac{{y}_{p}}{{y}_{q}} ) \qquad ( 38 ) ( II \text{-} III \text{-} V \text{-} 1 )$$

wherein the pairs (xₚ, yₚ) and (x_{q}, y_{q}) are the coordinates of the significant points (i.e. point/area of p and point/area of q) or area p and q of the image, respectively, which themselves are functions of the indices of their respective VSC.
In this way for each point or area of the extracted and standardized picture/image with some significance we can build an standard characteristic matrix which can be part of the standard representation of visual objects. The standard characteristic matrix or the VGM as we called it is generally sparse and only have nonzero values for really important and significant point/areas or VSCs of the image (significant according to one or more significance measure as described before.) It is also evident that the Eq. 38 II-III-V-1 is just one way of defining the standard characteristic matrix or the VGM.
In another exemplary embodiment, using the novel type of association or novel relational association, a computer vision system is built using the one or more of the investigation methods of this disclosure or using the data objects of the investigator to interpret and track the novelty to their corresponding state components (e.g. a cat is moving near a tree) in order to build a computer vision system to be used in systems requiring vision cognitions (e.g. using in humanoid Robots and/or self-deriving car/robots or drowns security systems etc.)
In practice, the data volume of a picture frame or an image file is way larger than the data of an average text file. Accordingly the processing time of an image frame especially if it is a high definition image, is considerably higher. Also consider that usually the image in some scenarios or embodiments is processed with a large number of other pictures of the same category or a diverse group or number of images. Therefore, in one exemplary method, application, and system of image processing with teachings of this disclosure we use graphic processing units, each having one or more processing cores, coupled with enough random access computer readable memories (e.g. RAMs) to accelerate the computing speed.
One or more graphic processing units are programed to receive an image frame, for instance from a video port, process the image, encoded image data to partition the image and extract the constituent state components of different orders, build the participation matrix/es, build one or more “association strength matrix” (ASM) between state components of the said image. The ASM could be calculated for state components of the same order or different order, each order corresponds to partition or a segments of various size of the image (as described before). Further building data structures corresponding to value significance of the portions of at least one order. Further calculate other data objects of various type such as RASM, RNASM, VSMs, NVSMs, and any other desired data objects expressed by Eq. 1-65 to investigate the image or group of images as outlined in FIG. 10 for example. And further execute the instructions by the processing units to do at least one of the exemplary applications disclosed in this disclosure (such as clustering a large number of images into one or more categories, novelty detection, summarization, recognition, tagging, transforming to text, reconstruction of an image with certain desired features, construction of other images, new image creation etc.) or further process the image to do other desirable functions based on the data of the investigation results. The processing units further, or when coupled with other processing devices, can control other machines, artificial limbs, robots or decide on further actions and/or executing other functions and processing.

### II-III-IV Other Desirable Association Strength Measures

In another instance it may be more desirable to have defined the association strength measure as:

$$asm\_ 2 \_ {3}_{i \to j}^{k \vert l} = c \frac{{com}_{ij}^{k \vert l}}{{iop}_{i}^{k \vert l}} , i , j = 1. . N \qquad ( 39 \text{-} 1 )$$

This asm_2_3_{i→j}^{k|l}, measure indicates that association of an OSᵢ^{k} to another one, say OSⱼ^{k}, is stronger when the co-occurrences of them is high and the probability of occurrence of OSᵢ^{k} is low. In other words if an SC is occurring less frequently and whenever it has occurred it has appeared more often with one particular SC then the association bond of the less frequently occurring SC is strongest with the particular SC that has co-occurred with, the most. In the other way for a given co-occurrence number for a particular SC, say OSⱼ^{k}, it's highest associated bond is from the SC with less independent occurrence probability.

This particular association strength measure can reveal a strong relationship from a less significant SC to the one who has co-occurred the most and is a useful measure to hunt for some types of novelty.

Yet in another instance an application/s is found for the following association strength definition:

asm_4_1_{i→j}^{k|l}=c.comᵢⱼ^{k|l}.iopⱼ^{k|l} i,j=1 . . . N (39-2).

The asm_4_1_{i→j}^{k|l}, attributes the strongest association bond from a first SC, say OSᵢ^{k}, to a second SC, say OSⱼ^{k}, when the product of their co-occurrences and the independent probability of occurrence of the second SC is the highest. This association strength measure usually is useful for discovering the real association of two important or significant SCs of the composition.

And yet further, the following measure can be defined to hunt for mutual associations bonds such as word phrases as the following:

$$asm\_ 2 \_ {4}_{ij}^{k \vert l} = c \frac{{( {com}_{ij}^{k \vert l} )}^{2}}{{Fo}_{i}^{k \vert l} \cdot {Fo}_{j}^{k \vert l}} , i , j = 1. . N . \qquad ( 40 \text{-} 1 )$$

This measure of association strength (i.e. Eq. 40-1) is symmetric and gives a high value to those pairs of SCs that frequently co-occur with each other such as word phrases. This becomes equal to 1 (assuming c=1 in Eq. 40-1) when two words have always co-occurred with each other.

Another symmetric association strength measure is defined as:

$$asm\_ 2 \_ {5}_{ij}^{k \vert l} = c \frac{( {com}_{ij}^{k \vert l} ) [ {( {Fo}_{i}^{k \vert l} )}^{2} + {( {FO}_{j}^{k \vert l} )}^{2} ]}{{Fo}_{i}^{k \vert l} \cdot {Fo}_{j}^{k \vert l}} , i , j = 1. . N . \qquad ( 40 \text{-} 2 )$$

This measure of association strength (i.e. Eq. 40-2) is also symmetric and gives a high value to those associations that are can give high value information about each other,

These are few exemplary but useful types of association strength measures which are found to be instrumental in analyzing and investigation of a composition of state components. However by Eq. 16 it can be seen that there could be defined, synthesized and calculate numerous other association strength measures. Furthermore considering that comᵢⱼ^{k|l} is also one type of “association strength measure” therefore Eq. 16 can be further generalized as:

asm_x2_{i→}^{k|l}=F(asm_x1_{i→j}^{k|l}, vsm_xᵢ^{k}, vsm_yⱼ^{k}) . . . i,j=1 . . . N,x,y=1,2, . . . , x1, x2=1,2, (41),

wherein F is a predefined function and x1 and x2 refer to different types of association strength measures and xᵢ and yⱼ refer to one of the “value significance measures” of the different types of “value significance measures”. To illustrate this, one can see that the asm_3_1_{i→j}^{k|l}, (from Eq. 19-1) can be expressed versus the asm_2_1_{i→j}^{k|l}, (Eq. 18-1) and the vsm_1ⱼ^{k|l} (Eq. 7) as:

asm_3_1_{i→j}^{k|l}=c.asm_2_2_{i→j}^{k|l}.vsm_1ⱼ^{k|l} (42)

wherein c is a constant and “.” indicates an element-wise multiplication of two vectors and wherein Eqs. 7, 10, 18-1, 19-1, were combined to derive the Eq. 42.

These illustrating examples are given to demonstrate that with the concept of “value significance” and “association strengths” there will be various ways to synthesize, perform, calculate and obtain the desired association strength for the particular application by those skilled in the art.

### II-IV—Supplementary Subjects, Exemplary Implementations, and Systems and Services

### II-IV-I—Cross Association Strength Measures

Also importantly from the one or more of the “association strength measures” one can go on and define a measure for evaluating the hidden association strength of SC of order k even further by:

ASM_x3^{k|l}=(ASM_x1^{k|l})^{T}×ASM_x2^{k|l} (43)

wherein ASM_x3^{k|l} stands for type x3 “association strength measure” which is basically a N×N matrix. The Eq. 43 takes into account the transformative or hidden association of SCs of order k (e.g. words of a textual composition or BOK) from one asm measure and combines with the information of another or the same asm measure to gives another measure of association that is not very obvious or apparent from the start. This type of measure therefore takes into account the indirect or secondary associations into account and can reveal or being used to suggest new or hidden relationships between the SCs of the compositions and therefore can be very instrumental in knowledge discovery and research.
Eq. 43 can, in fact, be interpreted as “cross-association strength” between state components in general with the same or different association strength measure in mind.
When we use the same type of association strength measure, in yet another exemplary and effective way we introduce another measure of association calling it “cross-association strength measure” or CROSS_ASM for short which is defined as:

CROSS_ASM=(ASM×ASM^{T}) (44)

Wherein, in here, ASM, is one of the desired types of the association matrix and “T” stands for matrix transposition operation and “×” indicates matrix multiplications. Eq. 44 is one particular case for the general concept of “cross-association strength measures” which is described, defined, represented, and calculated by Eq. 43. It is understood that CROSS_ASM (or any other objects of mathematical and data objects this disclosure) can further be processed or go through other mathematical operations when desired.
It is worth mentioning again, that all the data objects of present disclosure and the corresponding matrixes vectors etc. can be made to become normalized. That is for instance, any desired matrix of this disclosure can be, and very frequently is desirable, to become column normalized, or row normalized (i.e. the norm or the length of each column or row of the desired matrix is unity). Further the multiplications and/or products of the matrices, sometime are element-wise and sometimes are inner products and sometimes are normalized inner products of the vectors of the corresponding Hilbert space.
A very important, useful, and quick use of exemplary “association strength measures” of Eq. 17-26 and “cross association strength measures” of Eq. 44 is to find the real associates of a word, e.g. a concept or an entity, from their pattern of usage in the partitions of textual compositions. Knowing the associates of words, e.g. finding out the associated entities to a particular entity of interest, finds many applications in the knowledge discovery and information retrieval. In particular, one application is to quickly get a glance at the context of that concept or entity or the whole composition under investigation. The choice and the evaluation method of the association strength measure is important for the desired application. Furthermore, these measures can be directly used as a database of semantically associated words or SCs in meaning or semantic. For instance if the composition under investigation is the entire (or even a good part of) content of Wikipedia, then universal association of each entity (e.g. a word, concept, noun, etc.) can be calculated and stored for many other applications such as in artificial intelligence, information retrieval, knowledge discovery and numerous others.

As mentioned before, from the “association strength measures” one can also obtain and derive various other “value significance measures” which poses more of intrinsic type of significances. For instance the asm_{i→j}^{k|l}, (e.g. Eq. 20-26) was used to define and calculate few exemplary “value significance measures”, i.e. vsmᵢ^{k|l}, in order to evaluate the intrinsic importance, credibility, and importance of SCs of different orders.

In practice, for given a SC, e.g. SCⱼ^{k}, we want to find out the strongest “associated with” SC (assume it found out to be the OSᵢ^{k}). To do that we can use Eq. 20-1. Also one can use the Eq. 20-2 to find out which SC the given SC, say OSᵢ^{k}, is highly “associated to” (assume it was found out to be the OSⱼ^{k}).

To find out the semantically or functionally related SCs one can use Eqs. 43 and 44 which is an important tool for knowledge discovery. For instance this measure can be used to hunt for the subject matters that can in fact be highly related, but one cannot find their relations in the literature explicitly. The “association strength measure” of Eq. 26, thereby can point to interesting and important topics of further investigation or research either by human researcher or an intelligent machine.

In the next subsection the rational and definition of yet other types of instrumental measures and way of calculating them are given

### II-IV-II Relational Association Measures

As mentioned above the association strength values are important for many applications. One or more of such applications is to cluster or to find hidden relationships between the partitions of the compositions. The asm_{i→j} of the lower order SCs can show the association strength of the higher order SCs of the composition thereby to use them for clustering, categorization, scoring, ranking and in general filtering and manipulating the higher order SCs.

Accordingly, in this section we further disclose and explain the concept of “Relational Association Strength measure” (RASM). In the general terms, from lower order “association strength matrix” we can proceed to calculate association strength of higher order SCs to a lower order SC that we call it “Relational Association Strength measure” (RASM) here.

One exemplary instance of such “Relational Association Strength measure” can be given by:

RASM_1^{l→k|kl}=rasm_1ᵢ_{ₗ}ⱼ_{ₖ}^{l→k|kl}=(PM^{kl})^{T}×ASM^{k|l} iₗ=1,2, . . . M and jₖ=1,2, . . . N (45)

wherein rasm_1ᵢ_{ₗ}ⱼ_{ₖ}^{l→l|kl} or the RASM_1^{l→k|kl} is the “first type relational association strength measure” of SCs of order l to SCs of order k, which is a M×N matrix and shows the degree that an SC of order l (e.g. the iₗth sentence of the composition) is associated or is related to a particular SC of order k (e.g. to the jₖth word of the composition) .

It is noted that ASM^{k|l} is generally a square asymmetric matrix, whose transpose is not equal to itself, and therefore there could be envisioned another, also important, type of “relational association strength measure”. Accordingly, in the same manner the “second type relational association strength measure” can be defined and calculated as:

RASM_2^{l→k|kl}=rasm_2ᵢ_{ₗ}ⱼ_{ₖ}^{l→k|kl}=(PM^{kl})^{T}×ASM^{k|l}^{^{T}} iₗ=1,2, . . . M and jₖ=1,2, . . . N (46).

wherein rasm_2ᵢ_{ₗ}ⱼ_{ₖ}^{l→l|kl} or the RASM_2^{l→k|kl} is the “second type relational association strength measure” of SCs of order l to SCs of order k, which is also a M×N matrix and is similar to RASM_1^{l→k|kl} except relational emphasis is from different aspect. For instance if the ASM used in Eq. 28 is from the Eq. 20, then for a given SC of order k (e.g. a particular keyword) the RASM_1^{l→k|kl} shows a high relatedness for those partitions (e.g. sentences or paragraphs etc.) that contain the words that are highly bonded to the target SC. Whereas at the same condition using the RASM_2^{l→k|kl} then those sentences that contain the words that the target SC is highly associated with show a strong relatedness to the target SC.

Therefore using the above relational rasm one can conveniently find the most related partitions of a composition to one or more target SC for the desired goal of the investigation (e.g quick retrieval of documents, sentences, or paragraphs with high semantic relevancy).

On the other way, the RASM_2^{l→k|kl} or RASM_1^{l→k|kl} can be used also to find out the association strength or relatedness of particular SC of order k (e.g. the jₖth word of the composition) to a particular SC of order l (e.g. the iₗth sentence of the composition) by having the following relationship:

RASM_x^{k→l|kl}=(RASM_x^{l→k|kl})^{T} (47).

The reason that the present invention call RASM_x^{l→k|kl} “Relational Association Strength Measure” of type x, is to remind the fact that these types of association strength are not only between a higher order SC (e.g. a sentence, paragraph, or a document, or a segment/partitions of a picture) with a lower order SC (e.g. a word or a keyword, phrase, a pixel, or section of a picture etc) but it is, in an indirect way, also between a higher order SC and the associations of a lower order SC. The name for the other way around relationship (i.e. RASM_x^{k→l|kl}) is also appropriate in which not only a lower order SC is associated with a higher order SC but also is related to other constituent lower order SCs of the higher order SC.

Many more useful mathematical objects and relations are obtained, in a similar fashion as thought in the present invention, from which variety of operations can be envisioned. For instance we can proceed to calculate the association strength between the SCs of order l (e.g. an association strength measure between sentences of a textual composition) by the following:

RASM_x^{l→l|kl}=rasm_xᵢ_{ₗ}ⱼ_{ₗ}^{l→l|kl}=RASM_x^{l→k|kl}×RASM_x^{k→l|kl}, iₗ,jₗ=1,2, . . . M (48)

wherein rasm_xⱼ_{ₖ}^{l→l|kl} is indicative of one type of “relational association strength measure” between ith SC of order l and jth SC of order l. This matrix is particularly useful to find or select the higher order SCs of the composition or the partitions (e.g. sentences or paragraphs, or documents), that are highly associated with each other. In some applications, though, it would be desirable, for instance, to find out the partitions that have the least amount of associations with any other partitions etc.

In general one or more of these “related associations measures” can be used (either normalized or not) to define and/or synthesize new RASMs.

By the same manner using “Participation Matrix/es” and other objects, other desired features can be quantified in a composition or a BOK and consequently make it possible to select, clustered, or filter out the desired part or parts of the composition to look into, investigate, modified, re-composed, etc.

Eqs. 45-48 make it easy to find the partitions of the compositions that have the highest relatedness or highest relative association with a keyword or the other way around etc. Therefore a computer implemented method utilizing these formulations can essentially filters out the most related parts or partitions of a composition in relation to a target keyword.

One immediate application, of course, is for scoring the relatedness of group of documents to a subject matter or a keyword. Another immediate application of the computer implemented method, utilizing the concept of RASM_x^{l→k|kl} and the formulation, for instance, is to cluster and separate partitions of a BOK or a large corpus/s, etc into sets of partitions that are related to a particular subject matter. The relatedness is measured by one or more of the above measures and partitions that exhibited an association strength value greater (or sometimes smaller) than a predetermined threshold to a particular SC, can be grouped or clustered together. Further these data can be readily used to build a neural network type system (for learning, reasoning etc.) whose edge/connection weights can be obtained from the data of association strengths of the state components (e.g. the node of a neural net). In this way the training of a neural net can be done much faster or simply by reading a body of knowledge to attain the necessary data for building a learnt (e.g. adjusted weight by training through observing output/input as done currently without the teachings of the this disclosure) neural net. The association strength data structures, usually in the form a matrix, therefore are instrumental to build such cognitive networks for variety of tasks in general and for building neural nets in particular. The training iteration and the resource needed to train a neural net is significantly reduced using the information of the association strengths (and various other data objects or data structures introduced in this disclosure) of the state components obtained by investigating a body of knowledge as taught through this disclosure.

In light of the foregoing explanation, the algorithm and method of clustering become straightforward. For instance, a number of partitions of the composition or the BOK that have exhibited a predetermined threshold of relative association strength or predetermined criteria of satisfying enough association strength to a target subject or to each other can be categorized or being clustered as group together.
As a practical example, these method's, were successfully and effectively used for clustering and categorizing a large of number of news feeds as shown in FIG. 10-1.

Nevertheless in the short note here, the FIG. 10-1 shows the procedure in which using the concept of “value significance” a number of head category are selected from those SCs exhibiting the highest value significances, and consequently using the “related association strength measure” concept it was possible to separate the very many different news feeds into different categories automatically with satisfactory accuracy.

In the next section, in accordance with another aspect of this disclosure the relative or “relational value significance measures” (RVSM) are further introduced to evaluated the relative significances of various SCs in relation to a target SC in the context of the given BOK.

### II-IV-III Relational Value Significance Measures

Considering the case wherein one is looking for an important partition of the BOK related to a target SC (e.g. OSⱼ^{k}) which could be a word or a phrase, subject matter, keyword etc. Consequently one needs a value significance measure/s that is measured in relation or relative to one or more target SC. One can call this conceptual measure as “relational value significance measure” or RVSM.

In here the RVSM can simply be the association strengths of OSᵢ^{k}, i=1,2, . . . N to a target OSⱼ_{ₖ}^{k}, i.e. asm_{i→j}_{ₖ}^{k|l} or the jₖth column of the ASM^{k|l} matrix, which when is used as a VSM vector that can give a weighted importance of partitions of the composition or the BOK (i.e. an OSᵢ_{ₗ}^{l}) in relation to the target OSⱼ_{ₖ}^{k} when operates (multiply) on the participation matrix PM^{kl}, as the following:

rvsm_1_xᵢ_{ₗ}ⱼ_{ₖ}^{l→k|kl}=(pmᵢ_{ₖ}ᵢ_{ₗ}^{kl})^{T}×asm_yᵢ_{ₖ}_{→j}_{ₖ}^{k|l} . . . iₖ,jₖ=1,2, . . . N and iₗ=1,2, . . . M and x,y=1,2, (49)

wherein rvsm_1_xᵢ_{ₗ}ⱼ_{ₖ}^{l→k|kl} stands for type 1 of number x “relational value significance measure” of SCs of order l, OSᵢ_{ₗ}^{l}, to a given OSⱼ_{ₖ}^{k} which is a row vector and is obtained by processing the participation data of OS^{k} in OS^{l} or in other words it has been driven from the data of PM^{kl} and y is indicative the type of the “association strength measure”.

For the sake of simplicity usually the x and y are the same type. Accordingly, as can be seen in this embodiment the first type “relational value significance measure”, rvsm_1ᵢ_{ₗ}ⱼ_{ₖ}^{l→k|kl}, in fact the same as rasm_1ᵢ_{ₗ}ⱼ_{ₖ}^{l→k|kl} the “first type relational Association strength measure” introduced in Eq. 45.

Eq. 49, once executed, will assign values to OS^{l} in which it amplifies the importance or significance values of the partitions (e.g. sentences) of the composition that contains the SCs (e.g. words) that have the highest association strength to the target OSⱼ^{k} (i.e. a target keyword) thereby to provide an instrument, i.e. a filtering function, for scoring and consequently selecting one or more highly related partitions to an OSⱼ^{k}.

In fact the Eq. 49 can also be written in a matrix form wherein the rvsmᵢ_{ₗ}ⱼ_{ₖ}^{l→k|kl} is a M by N matrix indicating the relative importance of the partitions to each of OSⱼ^{k}. In other words rvsmᵢ_{ₗ}ⱼ_{ₖ}^{l→k|kl} is a kind of “relational value significance measure” and can be used as, say, “first type relational value significance measure” (e.g. can be shown by RVSM_1 notation).

The RVSM_1 therefore, following the Eqs. 27 and 31, can be given in the matrix form as:

RVSM_1_x^{l→k|kl}=RASM_1^{l→k|kl}=rvsm_1ᵢ_{ₗ}ⱼ_{ₖ}^{l→k|kl}=(PM^{kl})^{T}×ASM^{k|l}, iₗ=1,2, . . . M and jₖ=1,2, . . . N (50)

wherein the “T” shows the transposition matrix operation and RASM_1^{l→k|kl} is the “Relational Association Strength Matrix” and the RVSM_1 is the “first type relational value significance measure”. It is noticed that ASM^{k|l} is a N×N matrix and RASM_1^{l→k|kl} is a M×N matrix indicating the relatedness/association of OSᵢ^{l} (e.g. a sentence and i=1. . . M) to a OSⱼ^{k} (e.g. a word and j=1 . . . N).

In a similar fashion there could be defined a second type relative value significance measure (e.g. can be shown by RVSM_2 notation).

as:

RASM_2^{l→k|kl}=rvsm_2ᵢ_{ₗ}ᵢ_{ₖ}^{l→k|kl}=(PM^{kl})^{T}×(ASM^{k|l})^{T} iₗ=1,2, . . . M and iₖ=1,2, . . . N (52)

Or equivalently (see Eq. 28) given by:

RVSM_2^{l→k|kl}=RASM_2^{l→k|kl} (52)

wherein the RVSM_2^{l→k|kl} or the RASM_2^{l→k|kl} indicates the relatedness/association strength of OSᵢ^{l} (e.g. a sentence and i=1 . . . M) or its “relational value significance” to a OSⱼ^{k} (e.g. a word and j=1 . . . N).

Remembering the ASM^{k|l} in general is asymmetric and have different interpretation in which the rows of ASM^{k|l} indicates the value of association to other and column indicates the value of being association with by others. Therefore the RVSM_1^{l→k|kl} is indicative of a degree that an SC of order l, OSᵢ^{l}, (e.g. sentences) containing the SCs of order k, OS^{k} (e.g. the words) that are used to explain or express or provide information regarding the target OSⱼ^{k} (i.e. containing the words that are highly associated with the target SC). Whereas the RVSM_2^{l→k|kl} is indicative of a degree that an OSᵢ^{l} (e.g sentences) containing the OS^{k} (e.g. the words) for which the target OSᵢ^{k} is used or participated to explain or express or provide information about them (i.e. containing the words that the target SC is highly associated with).

Yet a third type of “relational value significance measure” can be defined as:

RVSM_3ᵢ_{ₗ}ⱼ_{ₖ}^{l→k|kl}=vsmⱼ_{ₖ}^{k|l}.RASM_1^{l→k|kl}=vsmⱼ_{ₖ}^{k|l}.((PM^{kl})^{T}×ASM^{k|l}) iₗ=1,2, . . . M and jₖ=1,2, . . . N (53)

wherein “.” indicates an element-wise multiplication and the vsmⱼ_{ₖ}^{k|l} could be the value of the one of the “value significance measures”.

And yet “forth type relational value significance measure” can be defined and calculated as:

RVSM_4ᵢ_{ₗ}ⱼ_{ₖ}^{l→k|kl}=vsmⱼ_{ₖ}^{k|l}.RASM_2^{l→k|kl}=vsmⱼ_{ₖ}^{k|l}.((PM^{kl})^{T}×ASM^{k|l}), iₗ=1,2, . . . M and jₖ=1,2, . . . N (54)

Therefore there could also be defined various “relational value significance measures” by incorporating the “intrinsic value significances” and the “relational association strength”.

Accordingly, in general the RVSM_xᵢ_{ₗ}ⱼ_{ₖ}^{l→k|kl} can be rewritten as:

RVSM_xᵢ_{ₗ}ⱼ_{ₖ}^{l→k|kl}=fₓ(vsmⱼ_{ₖ}^{k|l}, RASM_1^{l→k|kl}, RASM_2^{l→k|kl}) (55)

wherein RVSM_xᵢ_{ₗ}ⱼ_{ₖ}^{l→k|kl} is the “type x relational value significance measure” and the fₓ is a predetermined function.

These measures, RVSM_3ᵢ_{ₗ}ⱼ_{ₖ}^{l→k|kl} and/or RVSM_4ᵢ_{ₗ}ⱼ_{ₖ}^{l→k|kl} put an intrinsically high value on the significance of the partitions that are highly related to the high value significance OS^{k} of the composition by taking the intrinsic value of the target SCs into account. Therefore these measures can be instrumental to, for example, representing a body of knowledge with the highest relational value significance or to summarize a composition. To do so one can simply select one or more partition of the BOK that scored the highest for these measures in order to present it as summary of a composition.

Furthermore, from RVSM_xᵢ_{ₗ}ⱼ_{ₖ}^{l→k|kl} one can proceed to calculate the “relational value significance measures” between the SCs of higher order l as:

RSVM_x^{l→l|kl}rvsm_xᵢ_{ₗ}ⱼ_{ₗ}^{l→l|kl}=RSVM_x^{l→k|kl}×(RSVM_x^{l→k|kl})^{T}, iₗ,jₗ=1,2, . . . M (56)

wherein RVSM_x^{l→l|kl} is the relative value significance measure between SCs of order l so that it can directly measure the relatedness of partitions of the BOK such as sentences, paragraphs, or documents to each other. Again this measure therefore can readily be used to find the highly related partitions of the BOK either for retrieval purposes, rankings, document comparisons, question answering, conversation, or clustering and the like.

The concept behind the “relational value significance measures” is for processing and investigating compositions of state component as it become important in these investigations to have tools, measures, and filtering functions and methods of building such filtering functions to spot a partition relevant to another part or partition or to a given composition or query.

For instance in the information retrieval it becomes increasingly important to have retrieved the most relevant pieces of information and therefore the retrieved documents or the parts thereof should be the most relevant document and partition to a target SC which could be a keyword or set of keywords or even a composition itself. For instance it would be very useful and desirable to find the most relevant document or piece of knowledge to an input query in the form of a natural language question, or even a paragraphs or a whole text document. In this particular application one or more of the various kind and types of the, so far introduced, “value significance measures” can readily be applied using the method of this discloser to retrieve and present the most relevant part (e.g. a word, a sentence, a paragraph, a chapter, a document) to the sought after subject matter or in response to a query.

Many other desirable outcome and functionality can be built in light of the teachings and the disclosed method of systematic and computer-implementable methods of investigations not only for textual compositions but also for other types of compositions. In fact the disclosed method has been used and applied on image and video compositions as well as genetic code compositions which confirmed the method/s is indeed very effective in investigating compositions of state component to obtain a desirable outcome or information or knowledge or the result.
In another aspect of the present invention, in the next section, are the concept and definitions of “novelty value significance measures” (NVSM), as indication of various situations of novelty of SCs in the composition or the BOK.

### II-IV-IV—Novelty Value Significance Measures

According to another aspect of investigation methods of compositions yet other value significance measures are introduced and explored herein. According to this aspect of investigation, in some instances it would become desirable to have found the words or the partitions of a composition expressing novel information about one or more subject matter/s. In these instances if one can have an instrument or a function to measure a novelty value of a subject matter (e.g. an SC of the composition) itself or a novelty measure for the partitions then it would become practical to spot the novel information and/or the partitions of the composition carrying novel information in the context of that compositions or a set of compositions or generally a body of knowledge (BOK) as we defined before.

However the degree or value of novelty should be somehow measured in order to identify the part or partitions of the novelty and evaluate their value in terms of the significance of their novelty. In this disclosure these measures are called “novelty value significance measures” (NVSM) which can be categorized in different types and we, herein, define and show the methods of evaluating them for state components of a composition or a BOK.

In view of that, the first step is to define what constitute a novelty in the context of a BOK and identify different aspects that there is into a novelty investigation.

There could be envisioned several situations in which a novelty can occur that is of value in the investigation process. The detection and evaluation of novelty values can be important to either a knowledge consumer or to be used in other applications, processes, and or other computer implemented client programs.

Accordingly, in the present invention we explain few exemplary instances of novelty, having significance value, to be investigated in more details to demonstrate another investigation method of compositions according to novelty significance aspect/s.

### II-IV-V Relational Novelty

Novelty is an attribute that is related to newness, surprising factors, entropy, not being well known, not seen before, and unpredictability. However this attributes depends very much on the context and in relations to other state components of the compositions. For instance something which is new in one domain or context might be an obvious thing in another domain. Or something that is new now, it might become vey well known fact after sometimes. For instance, in news aggregation novelty of the news is very much related to the time of the news being broken and how many other news agencies have published the same news story. Therefore the novelty should be measured in relation to the context, time, and other partitions of the compositions. However, we look for novelty or novelties in the given composition for investigation and since we can treat time and/or a time stamp as an SC, our method of investigation, therefore, would also work for time-related compositions such as news, as well.

Generally, therefore, a valuable novelty occurrence is relational (i.e. more than one SC is participated where the novelty occurs) which should be investigated in the context of a composition. For instance in the context of a body of knowledge (BOK) there could be found many known or anticipated facts in regards to the subject matter/s of the BOK but there could be some partitions, e.g. statements, that are less known and can be considered as novel.

In this subsection therefore, to identify relative or relational novelty in regards to a topic or one or more SCs, several important novelty occurrence situations are envisioned and exemplified in the followings.

One of the situations is a novel relationship between two or more SCs in which case there could yet be envisioned at least two notable and important situations.

In one situation of novel relationship between two or more SCs, for example, a type of “relational novelty value significance measure” can be assigned to spot a novel or less known relationship between two important SCs. In this case the relational novel value should be high because the two significant SCs are less seen with each other in a part or partitions of a composition or a BOK. Therefore the desired “relational novel significance measure” should be proportional to the value significances of each of the SCs and be inversely proportional to their “association strength bond”.

Accordingly, one exemplary and simple measure of “relational novel value significance” between two of the SC of order k, say OSᵢ^{k} and OSⱼ^{k}, can be given by:

$$rnvsm\_ {1}_{i \to j}^{k \vert l} ( {OS}_{i}^{k} , {OS}_{j}^{k} ) ∝ {vsm}_{i}^{k \vert l} , {vsm}_{j}^{k \vert l} , \frac{1}{{com}_{ij}^{k \vert l}} \qquad ( 57 )$$

wherein the rnvsm__{i→j}^{k|l}, stands for type one “relational novelty value significance measure” of OSᵢ^{k} to the OSⱼ^{k}. This measure can be used to hunt for those partitions that contain two or more significant SCs expressing less known relationship. Therefore this measure will give a high value to the pair of the SCs, that are intrinsically significant, and more likely the expressed relationship to be credible and significant yet their relationship with each other is of novelty in the context of the BOK.

Another situation of novel relationship between two or more SCs, is a type of novelty between two SCs in which the novelty reveals less known information about one important SC of the interest (e.g. a target keyword, a high value significance subject of a BOK, etc.), regardless the significance of the other SCs. In this instance, the intrinsic value of the target SC, e.g. an intrinsic vsm, should be a significance factor for measuring and putting a value on the novelty. Also in terms of how to spot a novelty in relation to a significant target SC then the less known associations can be a guide to find the novel part or partitions or statement of a relationship between a significant SC with other SCs of the composition.

Therefore, another type of “relational novelty value significance measure” can be defined as:

$$rnvsm\_ {2}_{i \to j}^{k \vert l} ( {OS}_{i}^{k} , {OS}_{j}^{k} ) ∝ {vsm}_{j}^{k \vert l} \cdot \frac{1}{{com}_{ij}^{k \vert l}} \qquad ( 58 )$$

wherein the rnvsm_2_{i→k}^{k|l} stand for the second type “relational novelty value significance measure” OSᵢ^{k} to the OSⱼ^{k}. This measure put a high relational novelty value on the pairs that at least one of them, e.g. the target SC, have a high intrinsic value (i.e the vsm of the OSⱼ^{k}) while the other ones are the ones that had the lowest co-occurrences with the target SC. This measure can be used to spot the partitions that are novel and significant but perhaps the expressed relationship, between the two SCs, by the partition, is less credible.

Moreover there could be considered further notable situations, when two or more of SCs of the composition have participated in a partition, to convey a novel knowledge or information.

Accordingly, for example, another type of relational novelty can occur between a less significant SC and a high significance target SC. In this case this type of novelty value should be proportional to the value significance of the second SC, e.g. a target SC, and be inversely proportional to the value significance of the less significant SC and also be inversely proportional to their co-occurrences so that:

$$rnvsm\_ {3}_{i \to j}^{k \vert l} ( {OS}_{i}^{k} , {OS}_{j}^{k} ) ∝ {vsm}_{j}^{k \vert l} , 1 \text{/} {vsm}_{i}^{k \vert l} , \frac{1}{{com}_{ij}^{k \vert l}} \qquad ( 59 )$$

wherein the rnvsm_3_{i→j}^{k|l} stand for the third type of “relational novelty value significance measure” OSᵢ^{k} to the OSⱼ^{k}. This measure can be used to spot highly novel but perhaps even less credible partitions of the BOK than what is found by the rnvsm_2_{i→j}^{k|l}.

And yet another type of novelty can occur between two less significant SCs. In this case the significance and relational novelty value should be inversely proportional to the significances, i.e. VSMs, of each of the SCs and also proportional to their co-occurrences so that:

rnvsm_4_{i→j}^{k|l}(OSᵢ^{k},OSⱼ^{k})∝1/vsmⱼ^{k|l},1/vsmᵢ^{k|l},comᵢⱼ^{k|l} (60)

wherein the rnvsm_4_{i→j}^{k|l} stands for the forth type of “relational novelty value significance measure” OSᵢ^{k} to the OSⱼ^{k}. This measure can be used to spot a highly novel relationship between two less known SCs but with some credibility. This measure can be used to spot the rare partitions that might be irrelevant to the context of the BOK but is important to be looked at.

And yet there could be another notable situation and measure of relational novelty as:

$$rnvsm\_ {5}_{i \to j}^{k \vert l} ( {OS}_{i}^{k} , {OS}_{j}^{k} ) ∝ 1 \text{/} {vsm}_{j}^{k \vert l} , 1 \text{/} {vsm}_{i}^{k \vert l} , \frac{1}{{com}_{ij}^{k \vert l}} \qquad ( 61 )$$

wherein the rnvsm_5_{i→j}^{k|l} stands for the fifth type of “relational novelty value significance measure” OSᵢ^{k} to the OSⱼ^{k}. This measure can be used to spot a highly novel relationship between two less known SCs but with even less credibility than rnvsm_4_{i→j}^{k|l}. This measure can be used to spot the noise like partitions that might be irrelevant to the context of the BOK but might be essential to be looked at such as crime investigation or financial analysis, fraud detections and the like. This measure also can be used to filter out the irrelevant or noisy part of the composition, or be used in data compression, image compression and the like.

In another notable instance a measure of relational novelty value can be defined based on their association strengths to each other as:

rnvsm_6_{i→j}^{k|l}(OSᵢ^{k},OSⱼ^{k})∝asm_{i→j}^{k|l}/asm_{j→i}^{k|l} (62)

wherein the rnvsm_6_{i→j}^{k|l} stands for the sixth type of “relational novelty value significance measure” OSᵢ^{k} to the OSⱼ^{k}. This measure of novelty amplifies the asymmetry of the association strength value between the two SCs and therefore serves as a measure of anomaly and novelty, both too large and too small a value for this measure can point to a novelty situation. However, to have a symmetric rnvsm using asm one might consider the following measure:

$$rnvsm\_ {7}_{i \to j}^{k \vert l} ( {OS}_{i}^{k} , {OS}_{j}^{k} ) ∝ ( \frac{{asm}_{i \to j}^{k \vert l}}{{asm}_{j \to i}^{k \vert l}} + \frac{{asm}_{j \to i}^{k \vert l}}{{asm}_{i \to j}^{k \vert l}} ) \qquad ( 63 )$$

wherein the rnvsm_7_{i→j}^{k|l} stands for the seventh type of “relational novelty value significance measure” OSᵢ^{k} to the OSⱼ^{k}. This measure is particularly good to spot any symmetric kind of novelty or anomaly between OSᵢ^{k} to the OSᵢ^{k}. When the value of this measure is large then there is a novelty situation to look at between OSᵢ^{k} to the OSⱼ^{k}.

It can be noted that the some of the exemplary rnvsm_x_{i→j}^{k|l}, (x=1,2,3 . . . ) are generally symmetric and both sided whereas the some other rnvsm x__{i→j}^{k|l}, are asymmetric.

Once is noted that the co-occurrence is one of the measures and indications of the associations between a pair of SC then the rnvsm_x^{k|l}(x=1, 2, . . . ) can further be generalized as a function of individual values significances of the SCs and their association strength measures. Therefore in general the “relational novel value significance measures” can be defined and calculated in the general form of:

rnvsm_x_{i→j}^{k|l}(OSᵢ^{k},OSⱼ^{k})=g₂(vsmᵢ^{k|l},vsmⱼ^{k|l},asm_{i→j}^{k|l},asm_{j→i}^{k|l}), . . . i,j=1,2, . . . N, x=1,2, (64)

wherein g₂ is a predefined or predetermined function.

When there are multiple SCs of interest the pair-wise value significances can be used in combination and perhaps with various weight to achieve the same filtering effect for a set of SCs. For instance

rnvsm_{q→i,j,p}^{k|l}(OSᵢ^{k},OSⱼ^{k},OSₚ^{k})=α₁.rnvsm_x1^{k|l}(OS_{q}^{k},OSᵢ^{k})+α₂.rnvsm_x2^{k|l}(OS_{q}^{k},OSⱼ^{k})+α₃.rnvsm_x3^{k|l}(OS_{q}^{k},OSₚ^{k}) and q=1,2 . . . N (65)

wherein α₁, α₂, and α₃ are predetermined weighting functions such as α₁(OSᵢ^{k})=1/FO(OSᵢ^{k}) or α₁(OSᵢ^{k})=log2(iop(OSᵢ^{k}) etc. or constants and/or normalization factors, and x₁, x₂ and x₃ are indications of the type of the rnvsm (e.g. Eq. 39-45) and “OSₚ^{k}” is the indication of one or more combination of the first SC to the particular target SC. Moreover, Eq. 47 in just one of the notable situations of novelty occurrence and in another instance it might become more useful to multiply the pair-wise rnvsm_x^{k|l} to each other.

All these relationships (i.e. Eq. 57-64) can be written in a matrix form to, once executed numerically, have all combinations of relations between two or more of the OS^{k} pre-calculated and handy.

Again by operating these specialty defined “value significance measures” on the PM one can obtain the respective type of value for the partitions of the compositions, e.g. SCs of order l or OS^{l}, by:

rnvsm_xᵢ_{ₗ}_{→j}_{ₖ}^{l→k|kl}=(pmᵢ_{ₖ}ᵢ_{ₗ}^{kl})^{T}×rnvsm_xᵢ_{ₖ}_{→j}_{ₖ}^{k|l} . . . iₖ,jₖ=1,2, . . . N and iₗ=1,2, . . . M (66)

Or in the matrix form as:

RNVSM_x^{l→k|kl}=(PM^{kl})^{T}×RNVSM_x^{k|l} iₗ=1,2, . . . M and jₖ=1,2, . . . N (67)

wherein the “T” shows the transposition matrix operation and the RNVSM_x^{l→k|kl} is the type x (x=1,2, . . . ) “relational novelty value significance measure” of the partitions or SCs of order l to the SCs of the order k. It is noticed that RNVSM^{l→k|kl} is a M×N matrix indicating the type x (x=1,2, . . . ) “relative novel value significance measure” of OSᵢ^{l} (e.g. a sentence and i=1,2, . . . M) to a OSⱼ^{k} (e.g. a word and j=1,2, . . . N) and RNVSM_x^{k|l} is a N×N matrix indicating the type x (x=1,2, . . . ) “relational novel value significance measure” of OS^{k} with OS^{k}.
In a similar fashion to the previous subsection, there could be calculated a novelty type relationships between the SCs of order l so that to show how each pair of the partitions are related in terms of the significance of the relational novelty to each other as:

RNVSM_x^{→l|kl}=RNVSM_x^{l→k|kl}×RNVSM_x^{k→l|kl} (68)

wherein RNVSM_^{l→l|kl} stands for the “relational novelty value significance measure” of type x between the SCs of the order l, which is a M×M matrix. This measure and the data of such matrix can be used to find a novel partition, exhibiting a predetermined range of “relational novelty value”, for a given partition. Also these measures can be combined with other measures to obtain the desired parts of the compositions that one is looking for (e.g. in response to a query or a question).

### II-IV-VI The Association Type Novelty

Many associations are hidden that when is revealed is obviously a case of novelty existence or occurrence. For instance when two SCs have little direct associations but their association spectrum is highly correlated then there could be a novelty of high value revealed for further investigation. In these instances a measure to hunt for these types of novelty association can be given by:

$$anvsm\_ {1}_{i \to j}^{k \vert l} ( {OS}_{i}^{k} , {OS}_{j}^{k} ) ∝ \frac{( asm\_x {1}_{p \to i}^{k \vert l} \cdot asm\_x {2}_{p \to j}^{k \vert l} )}{asm\_x {3}_{i \to j}^{k \vert l}} , p = 1 , 2 , … N \qquad ( 69 )$$

wherein anvsm_1^{k|l} is indicative of the first type “association novelty value significance measure”, the “.” shows the inner product or SCalar multiplication of the asm_x1_{p→i}^{k|l} and asm_x2_{p→j}^{k|l}, vectors. The indices of x1, x2, x3 (=1,2, . . . etc) are usually equal and can refer, for instance, to the first or the second type association strength measure (given by Eq. 16, and/or 17-26).

This measure of novelty gives a high value to the relational novelty of those pairs that exhibit strong hidden association correlation but they are not explicitly strongly bonded. This measure is particularly useful for detecting hidden relationships between two SCs of interest, i.e. OSᵢ^{k} and OSⱼ^{k} and can be used to spot the cases worthy of further research and investigation (e.g. in scientific discovery, medical, crime investigation, genetics, market research and financial analysis etc.).

Although anvsm_1^{k|l} is also one of the “relational novelty value significance measures” but in here it is preferred to be given a more distinct name as “association novelty value significance measure” (ANVSM) in order to have a distinct category for this kind of “value significance measure” in general.

To further amplify the significance of the novelty of anvsm_1^{k|l} one can further incorporate the intrinsic value significance of one or both of the value significances of the OSᵢ^{k} and OSⱼ^{k} as, for example, the following:

$$anvsm\_ {2}_{i \to j}^{k \vert l} ( {OS}_{i}^{k} , {OS}_{j}^{k} ) ∝ \frac{( vsm\_y {1}_{i}^{k \vert l} \cdot vsm\_y {2}_{j}^{k \vert l} ) \times ( asm\_x {1}_{p \to i}^{k \vert l} \cdot asm\_x {2}_{p \to j}^{k \vert l} )}{asm\_x {3}_{i \to j}^{k \vert l}} , p = 1 , 2 , … N \qquad ( 70 )$$

wherein y1 and y2 indicates the types and numbers of the “value significance measure” used in this formula.

The proportionality factor can be adjusted to account for normalization of the vectors when desired.

Eq. 51 can be re written in matrix form in general terms which is more useful as:

ANVSM_1^{k|l}=[(ASM_x1^{k|l})^{T}×ASM_x2^{k|l}]./ASM_x3^{k|l} (71)

wherein “×” shows the matrix multiplication operator and “./” shows the element-wise division. Usually, in the preferred exemplary embodiment, in the Eq. 53 the ASM_x^{k|l} are column or row normalized.

As can be seen Eq. 51, 52 and 53 are generally the exemplary cases of the general form of:

anvsm_x_{i→j}^{k|l}(OSᵢ^{k},OSⱼ^{k})=g₃(vsm_y1ᵢ^{k|l},vsm_y2ⱼ^{k|l},asm_x1_{p→i}^{k|l},asm_x2_{p→j}^{k|l},asm_x3_{i→j}^{k|l},asm_x4_{i→j}^{k|l}), . . . p,i,j=1,2, . . . N, (72)

wherein g₃ is predetermined or predefined function and y1, y2, x1 . . . x4 etc refer to the selected type of the respective kind and type of the “value significance measure”.

Numerous other forms of “value significance measures” using one or more of the introduced “value significance measures” and the concept behind them can be devised, depends on the applications, which are not further listed here, and in light of the teachings of the present invention become obvious to those skilled in the art.

### II-IV-VII The Intrinsic Novelty

Another important situation of novelty occurrence would be to spot and find the novel SCs and the partitions of the composition regardless of their relationship and just for being intrinsically novel in the context of the composition or convey novelty wherever they appear in the composition or the BOK.

In this case we assign an intrinsic “novelty value significance measure” (NVSM) to each desired SC and then use the NVSM to weight the intrinsic novelty value of other partitions.

The first measure of novelty of course can be derived and defined based on the independent probability of occurrence so that:

nvsm_1ᵢ^{k|l}=h₁(iopᵢ^{k|l}), i=1,2, . . . N (73)

wherein h₁ is a predetermined function such as h₁(x) be a liner function (e.g. ax+b), power of x (e.g. x³ or x^{0.53}), logarithmic (e.g. a/log2(x)), 1/x, etc wherein a or b might be SCalar constant or a vector.

Usually the term “novelty” implies that it should be inversely proportional to the popularity or frequency of occurrence or independent probability of occurrence and therefore nvsm_1ᵢ^{k|l} is usually more justified when the choice of h₁ is such that it decreases as the iopᵢ increases. For instance one good candidate for defining and calculating a “novelty value significance measure” as a vector is:

N (74)

wherein c might be a scalar or a constant vector. In another instance it might be defined as:

nvsm_1_2ᵢ^{k|l}=c/log_{b}(iopᵢ^{k|l}), i=1,2, . . . N (75)

or in another instance:

nvsm_1_3ᵢ^{k|l}=c.log_{b}(1/iopᵢ^{k|l})=c.log_{b}(iopᵢ^{k|l}), i=1,2, . . . N (76)

or yet in another instance:

$$nvsm\_ 1 \_ {4}_{i}^{k \vert l} = - c \cdot \frac{{log}_{b} ( {iop}_{i}^{k \vert l} )}{{iop}_{i}^{k \vert l}} \qquad ( 77 )$$

wherein b is a constant and c could be constant or a vector. For example c can be an auxiliary vector that when multiplies to other vectors it suppresses or dampen the value of particular SCs of the compositions such as the generic words in a textual composition.

Accordingly, by the same manner, there could be defined various “novel value significance measures” if the justification is properly done. For instance with combination of one or more of the nvsm_xᵢ^{k|l} or other variables there could be defined more sensible and useful novelty value significances. As can be seen in Eq. 77 the nvsm_1_4ᵢ^{k|l} is in fact obtained by multiplication of the nvsm_1_1ᵢ^{k|l} and nvsm_1_3ᵢ^{k|l}.

In another aspect the novelty is observed in relation or combination with other SCs since novelty could occurs in a context and therefore in relation to other state components. The stand alone or the intrinsic “novelty value significance value” in this case is defined as sum of the novelty that an SC will have with a desired number of other SCs.

These measures of novelty are intrinsic since it adds up all the pair-wise novelty values for each OS^{k} so that a NVSM type 2 can be defined as:

NVSM_2^{k|l}(OSᵢ^{k})=cΣⱼrnvsm_x_{i→j}^{k|l}(OSᵢ^{k},OSⱼ^{k}) (78)

wherein the pair-wise novelty measures are summed over the column (i.e. the j subscript).

Similarly another type of intrinsic novelty value significance measure can be defined as:

NVSM_3^{k|l}(OSⱼ^{k})=cΣᵢrnvsm_x_{i→j}^{k|l}(OSᵢ^{k},OSⱼ^{k}) (79)

wherein the summation is over the rows (i.e. the i subscript).

The same can be calculated using anvsm_x_{i→j}^{k|l} as:

NVSM_4^{k|l}(OSᵢ^{k})=cΣⱼanvsm_x_{i→j}^{k|l}(OSᵢ^{k},OSⱼ^{k}) (80)

and also:

NVSM_5^{k|l}(OSⱼ^{k})=cΣᵢanvsm_x_{i→j}^{k|l}(OSᵢ^{k},OSⱼ^{k}) (81).

Or in a general form any combination of them can still serve as an intrinsic measure of novelty of the SCs of the composition as:

NVSM_x^{k|l}(OSᵢ^{k})=h(NVSM_1^{k|},NVSM_2^{k|}, . . . NVSM_y^{k|l}), (82)

wherein h is predetermined function and y is the type and number of the particular NVSM^{k|l} used into building other types of NVSM_x^{k|l}.
These various novelty value measures can find and have many applications in variety of applications and compositions which can be employed to investigate such composition to find and investigate the parts or partitions of novelty values. For instance they can be employed for textual composition processing such as question answering, summarization, knowledge discovery, as well as other kind of compositions like detecting novel and valuable parts in a genetic code strings, finding and filtering the junk DNA, as well as other compositions such as image and video compositions and signal processing such as edge detection, compression, deformations, re-composition to name a few.

### II-IV-VIII Other Value Significance Measures

In accordance with another aspect of the invention, the second measure of significance is defined in terms of the “cumulative association strength” of each SC. This measure can carry the important information about the usage pattern and co-occurrence patterns of an SC with others. So the second value significance measure VSM_5ᵢ^{k} for an SCᵢ^{k} is defined versus the cumulative association strength that here is called “Association Significance Number (ASNᵢ^{k})”, will be:

VSM_5ᵢ^{k|l}=ASNᵢ^{k|l}=Σⱼasmⱼᵢ^{k|l} i,j=1 . . . N (83)

The VSM_5ᵢ^{k} is much less noisy than VSM1ᵢ^{k} and fairly simple to calculate. It must be noticed that ASNᵢ^{k} is an indication of how strong other SCs are associated with OSᵢ^{k} and not how strong SCᵢ^{k} is associated with others. Alternatively it would be important to know a total quantity for association strength of an SCᵢ^{k} to others which is Σⱼasmᵢⱼ^{k|l} (the difference here with Eq. 83 is in the ij instead of ji in the summation). This quantity is also an important measure which shows overall association strength of SCᵢ^{k} with others. The difference of Σⱼasmⱼᵢ^{k|l}−Σⱼasmᵢⱼ^{k|l} is also an important indication of the significance of the SCᵢ^{k} in the composition. The latter quantity or number shows the net amount of importance of and SC in terms of association strengths exchanges or forces. This quantity can be visualized by a three dimensional graph representing the quantity Σⱼasmⱼᵢ^{k|l}−Σⱼasmᵢⱼ^{k|l}. A positive number would indicate that other SCs are pushing the OSᵢ^{k} up and negative will show that other SCs have to pull the OSᵢ^{k} up in the three dimensional graph. Those skilled in the art can yet envision other measures of importance and parameters for investigation of importance of an SC in the composition using the concept of association strengths.

As an example of other measures of importance, and in accordance with another aspect of the invention and as yet another measure of value significance we notice that it would be helpful and important if one can know the amount of information that an SC is contributing to the composition and vice versa. To elaborate further on this value significance measure we notice that it is important if one can know that how much information the rest of the composition would have gained if an SC has occurred in the composition, and how much information would be lost when on SC is removed from the composition. Or saying it in another way, how much the composition is giving information about the particular SC and how much that particular SC add to the information of the composition. The concept of conditional entropy is proposed and is applicable here to be used for evaluation of such important value measure. Therefore, we can use the defined conditional occurrence probabilities (COP) to define and calculate “Conditional Entropy Measures (CEMs)” as another value significance measure.

Accordingly, yet a slightly more complicated but useful measure of significance could be sought based on the information contribution of each OSᵢ^{k} or the conditional entropy of OSᵢ^{k} given the rest of OS^{k} s of the composition are known. The third measure of value significance therefore is defined as:

VSM_6ᵢ^{k|l}=CEM1ᵢ^{k|l}=H1ᵢ^{k|l}=Hⱼ(SCᵢ^{k}|SCⱼ^{k})=−Σᵢiopⱼ^{k|l}.cop^{k|l}(i|j)log₂(cop^{k|l}(i|j)), i,j=1 . . . N (84)

wherein Hⱼ stands for Shannon-defined type entropy that operates on j index only. In Eq. 84 any other basis for logarithm can also be used and CEM1ᵢ^{k|l} stands for first type “Conditional Entropy Measure” and H1ᵢ^{k|l} is to distinguish the first type entropy according to the formulations given here (as opposed to the second type entropy which is given shortly). This is the average conditional entropy of SCᵢ^{k} over the M partitions given that SCⱼ^{k|l} has also participated in the partition. That is every time SCᵢ^{k} occurs in any partition we gain H bits of information.
And in accordance with yet another aspect of the invention another value significance measure is defined as:

VSM_7ᵢ^{k|l}=CEM2ᵢ^{k|l}=H2ᵢ^{k|l}=Hⱼ(SCⱼ^{k}|SCᵢ^{k})=−iopᵢ^{k|l}Σⱼcop^{k|l}(j|i)log₂(cop^{k|l}(j|i)), i,j=1 . . . N (85)

where Hⱼ stands for Shannon-defined type entropy that operates on j index only again, and wherein CEM2ᵢ^{k|l} stands for the second type “Conditional Entropy Measure” and H2ᵢ^{k|l} is to distinguish the second type entropy according to the formulations given here. That is the amount of information we gain any time an OS^{k} other than OSᵢ^{k} occurs in a partition knowing first that OSᵢ^{k} has participated in the partition.

And in accordance with another aspect of the invention yet another important measure is defined by:

VSM_8ᵢ^{k|l}=DCEMᵢ^{k|l}=CEM1ᵢ^{k|l}−CEM2ᵢ^{k|l}=VSM3ᵢ^{k|l}−VSM4ᵢ^{k|l}, i=1 . . . N (86)

where DCEMᵢ^{k|l} stands for “Differential Conditional Entropy Measure” of OSᵢ^{k}. The DCEMᵢ^{k|l} and is a vector having N element as is the case for other VSMs. The VSM_8^{k|l} is an important measure showing the net amount of entropy or information that each SC is contributing to or receiving from the composition. Though the total sum of DCEMᵢ^{k|l} over the index i, is zero but a negative value of VSM_8ᵢ^{k|l} (i.e. DCEMᵢ^{k|l}) is an indication that the composition is about those SCs with negative VSM5^{k|l}. The VSM_8^{k|l} is much less nosier than the other value significance measures but is in a very good agreement (but not exactly matched) with VSM_5^{k|l}, i.e. the association significance number (ASN^{k|l}). This is important because calculating ASN is less process intensive yet yields a very good result in accordance with the all important DCEM^{k|l}.
Also important is that either of CEM1^{k|l} or CEM2^{k|l} can be also used (multiplying either one by FOᵢ^{k|l}) for measuring or evaluating the real information of the composition in terms of bits (wherein bit is a unit of information according to the Information Theory) which could be considered as yet another measure of value significance for the whole composition or the partitions therein. For instance, this measure can be used to evaluate the merits of a document among many other similar or any collection of documents. The information value of the SCs or the partitions (by addition the individual information of the its constituent SCs) is a very good and familiar measure of merit and therefore can be another good quantity as an indication of value significance.
Those skilled in the art can use the teachings, concepts, methods and formulations of value significance evaluation of state components and the partitions of the composition with various other alterations and for many applications. We now lunch into describing a number of exemplary embodiments of implementing the methods and the exemplary related systems of performing the methods and some exemplary applications in real life situations.
From the Conditional Occurrence Probability the various combinations of Conditional Entropy Measures, i.e. CEM1, CEM2, DCEM are calculated according to Eq. 11, 12, and 13.

It is noted that obviously one can select only the desirable SCs of any order in building one or more of the matrix objects of the invention. FIG. 4a compares these different measures of significance for an exemplary textual input composition. The VSMs have been evaluated for a short text, actually a research paper, as an example to illustrate the normalized various measures of value significances disclosed in this invention. The SCs of the first order are the words and the second order SCs are the sentences of the text. These data have been calculated from the PM¹² of the exemplary text. This is only to demonstrate the calculation and implementation of the method and algorithm and an exemplary illustrating figure for representing the VSMx (x is 1, 2,3, . . . etc). The results for large bodies of knowledge and corpuses must be more well pronounced and having more meaningful interpretations. The resulting similar figures for different compositions can be substantially different from the depicted exemplary figures presented here. Furthermore, more figures and curves can be made which could be substantially different and/or show various other functions, values, and other desired parameters.

More importantly is the behavior of DCEM, the sum of DCEM is zero but it has negative values for highly popular (large FO) SCs. That means for those popular SCs who have many real associates the net entropy or information contribution is negative while for the less popular is positive. An interpretation could be given that all SCs of the composition are there to describe and give information about the popular SCs who have real (strong enough) associations. It implies that not all the popular SCs are important if they do not have real bounded associates. The real bounding is the reflection of the usage and the patterns of SCs together in the composition. In other words those SCs having a high value significance are usually the popular ones but the reverse is not always true.
Another explanation is that most popular SCs have many associates or have co-occurred with many other SCs. Those many other associates have been used in the composition to describe the most popular SCs. In other words a natural composition (good intentioned composed composition) is mostly about some of the most popular SCs of the composition. So it is not only the Frequency of Occurrence that count here but the pattern of their usage and the strength of their association (which is asymmetric). In conclusion the negative DCEM means other SCs are giving away information about those SCs with negative DCEM. This feature can be useful for keyword extraction or tagging or classification of documents beside that it shows the importance and significance of the SC having negative DCEM.
Those SCs with the negative DCEM or high ASN can be used for classification of compositions. However investigation of the differences in the various VSMs can also reveal the hidden relationships and their significance as well. For example if an SC has gained a better normalized rank in VSM_8ᵢ¹ compared to VSM1ᵢ¹ then that can point to an important novelty or an important substance matter. Therefore those experts in the art can yet envision other measures of significance employing one or more of these VSMs without departing from scope, concepts and the purpose of this invention.
It is also evident that at this stage and in accordance with the method and using one or more of the participation matrix and/or the consequent matrices one can still evaluate the significance of the SCs by building a graph and calculating the centrality power of each node in the graph by solving the resultant eigen-value equation of adjacency matrix of the graph.
The association matrix could be regarded as the adjacency matrix of any graphs such as social graphs or any network of anything. For instance the graphs can be built representing the relations between the concepts and entities or any other desired set of SCs in a special area of science, market, industry or any “body of knowledge”. Thereby the method becomes instrumental at identifying the value significance of any entity or concept in that body of knowledge and consequently be employed for building an automatic ontology. The VSM_1,2, . . . 8^{k|l} and other mathematical objects can be very instrumental in knowledge discovery and research trajectories prioritizations and ontology building by indicating not only the important concepts, entities, parts, or partitions of the body of knowledge but also by showing their most important associations.
Various other value significance measures using one or more functions, matrices and variables can still be proposed without departing from the scope, sprit, and the concepts introduced in this invention. For instance sum of the elements of the Co-Occurrence Matrix (COM) over the row/column can also be considered as yet another VSM.
The VSM has many useful and important applications, for instance the words of a composition with high normalized VSM can be used as the automatic extraction of the keyword and relatedness for that composition. In this way a plurality of compositions and document can be automatically and much more accurately be indexed under the keywords in a database. Another obvious application is in search engines, webpage retrieval, and many more applications such as marketing, knowledge discovery, target advertisement, market analysis, market value analysis of economical enterprises and entities, market research related areas such as market share valuation of products, market volume of the products, credit checking, risk management and analysis, automatic content composing or generation, summarization, distillation, question answering, and many more.

### II-IV-IX-Transformation and Alteration of Data Objects

The parameters, vectors, and matrices of the present invention are transformation of the information hidden in the participation matrix which can be used for different applications with ease, convenience and efficiency to investigate various aspects of interests in the BOK such as extracting the most significant parts or partitions, finding the highly associated concepts or parts and partition, finding the novel part/s or partition/s of the BOK, finding the best piece of informative part of the composition, clustering and categorization of the partitions of the composition or the BOK, ranking and scoring partitions of a composition based on their relatedness to a subject matter (e.g. a query), excluding one or more partitions or SCs of the BOK or suppressing their role in the analysis, and numerous other application.

Moreover the mathematical objects and data arrays can be easily transformed to other forms, filtered out the desired part or segment of a matrix, amplify or suppress the role of one or more of the SCs of the composition and/or their values being altered numerically without needing to manipulate the input composition string or file. For instance in many of the above calculations it will be more useful to have the matrices or vectors being normalized in order to make the comparisons more meaningful in the context of the BOK. Accordingly one or more of such mathematical objects and data arrays (vectors, matrices etc.) can and might be desired to become column or row normalized or further being multiplied by other matrices or vectors as a mask or filter etc.

Moreover all these matrices (e.g. such as PM, COM, ASM/s, RASM, RVSMs NVSM, RNVSMs etc.) can be regarded as an adjacency matrix for a corresponding graph wherein the matrix carry the data of the connectivity between the nodes or objects of the graph. Therefore, from these connectivity matrixes one can proceed to calculate a corresponding eigenvalue equation/s in order to estimate and calculate other types of desirable value significance measure or in general any type of value significance. These measures of value calculated from the corresponding eigenvalue equations of the matrices are generally indication of intrinsic significance values of the SCs. For instance one or more of these matrices have been used to calculate the significance values of the SCs of the composition based on their centralities of the corresponding node in the graph that could be represented by that matrix. The centrality value can be, for instance, be the values of largest eigenvector of the eigenvalue.

### II-IV-X—Special Case Coveyers

In many cases one wants to deliberately amplify and/or dampen or suppress one or more of the values of SC of the BOK in order to achieve the right functionality out of the analysis and investigation. Therefore there could be per-built or pre-determined VSM values (e.g vectors) that can be used when it is desired to alter and influence the significance values of one or more of the SCs of the compositions. For instance these vectors or filter can be designed in such a way to amplify the significances of proper sentences of compositions written in a particular natural language such as English. For example, in another instance, the objective can be to give significance to particular types of partitions of the composition having of particular feature/s, attribute/s, or form/s. For instance when one like to hunt the partitions containing connecting or the concluding remarks then one may construct a vector that assigns a low significance value to every SC except those selected SC (e.g. words or phrases such as “therefore”, “as a result”, “hence”, “consequently”, “so that” . . . etc.). n another instance, one might have list of SCs that it is not desirable to participate in the calculation (e.g. stop words) one can provide a vector over the range of SCs having a value of one expect for those selected SC that must be omitted from the calculation.

These pre-assigned vectors are called “special cases conveyers” herein or “significance value conveyer vectors” as shown in FIG. 6c, that can be used solely or in combinations with other VSM value vectors to obtain the desired functionality from the investigation. These conveyers are assigned and used based upon the goal of investigation. The special conveyers can be designed and altered for various stage of the process and can be used in different stages of calculations and processes.

### II-V-I—PM Transformation

In accordance with another aspect of the methods of investigation of the compositions of state component of the present invention, the participation matrix can, for instance, routinely being transformed to other types of objects or participation matrices by operating one or more vector or matrices on the PM. For example one can multiply the PM by a diagonal matrix (M by M) from the right side whose diagonal values are the reciprocal of the number of constituent SCs of order k in the partitions or the higher order SC of order l (i.e norm1 column normalization of a matrix). The “resulting PM” matrix will become a column normalized PM and values of the entries will become the weighted participation factor. For instance from a binary PM one can get to partial PM in which if a word has participated in a sentence with 5 words then its participation entry in the PM would be ⅕ and if the same word has participated in a sentence with 10 words its participation entry would be 1/10 and so on. In another instance, in a similar situation, it become desirable to have a “resulting PM” with column geometrical unitary (i.e. the length of the column become one), in this case therefore the elements of the diagonal matrix are the inverse of the square-root of the sum of the square of the individual elements of the original respective PM column (or row). Similarly all data objects of the disclosure can be altered (e.g. normalized with various norms, or axis, or by various operators) without departing from the scope and sprit of the current invention.

As another instance of transformation, moreover, the PM matrix can be multiplied from the left side by a diagonal matrix (N by N) whose entries are a vector that will put a value on the SC of the order k so that their participation weight will be altered. For instance if the diagonal of the left matrix is one except for some particular words (such as the generic words of a natural language) for which the corresponding entries are suppressed (e.g. replaced with 0.1) then the role of those particular words (e.g. the generic words) in the computations will be suppressed as well, without having to manipulate the original string of the compositions in order to achieve the same goal of suppressing the role of generic words.

As another instance of transformation and alteration, one or more auxiliary vectors (i.e. filters) can be built to dampen the significance of particular SCs of the composition by multiplying those vectors on the resulting vector objects such as one or more of the different types and number of the “value significance measures” vectors or matrices.

Moreover the method/s can conveniently be used for compositions of different nature such as data file compositions, e.g. audio or video signals, DNA string investigation, textual strings and text files, corporate reports, corporate databases, etc. For instance the investigation method disclosed herein can be readily used to investigate image and video files, such as spotting a novelty in an image or picture or video, edge detection in an image, feature/s extraction, compression of image and video signals, and manipulating the image etc. The disclosed methods of the present invention can readily be applied in applications such as, artificial intelligence, neural network training and learning, network training, machine learning, computer conversation, approximate reasoning, as well as computer vision, robotic vision, object tracking etc.

Numerous other forms of “value significance measures” using one or more of the introduced value significance measures and the concept behind them can be devised and synthesized accordingly, depends on the application, that are not further listed here but in light of the teachings of the present invention become obvious to those skilled in the art.

The disclosed frame work along with the algorithms and methods enables the people in various disciplines, such as artificial intelligence, robotics, information retrieval, search engines, knowledge discovery, genomics and computational genomics, signal and image processing, information and data processing, encryption and compression, business intelligence, decision support systems, financial analysis, market analysis, public relation analysis, and generally any field of science and technology to use the disclosed method/s of the investigation of the compositions of state components and the bodies of knowledge to arrive the desired form of information and knowledge desired with ease, efficiency, and accuracy.

Furthermore, as pointed out before, those skilled in the art can store, process or represent the information of the data objects of the present application (e.g. list of state components of various order, list of subject matters, participation matrix/ex, association strength matrix/ex, and various types of associational, relational, novel, matrices, co-occurrence matrix, participation matrices, and other data objects introduced herein) or other data objects as introduced and disclosed (e.g. association value spectrums, state component map, state component index, list of authors, and the like and/or the functions and their values, association values, counts, co-occurrences of state components, vectors or matrix, list or otherwise, and the like etc.) of the present invention in/with different or equivalent data structures, data arrays or forms without any particular restriction.

For example the PMs, ASMs, SCM or co-occurrences of the state components etc. can be represented by a matrix, sparse matrix, table, database rows, dictionaries and the like which can be stored in various forms of data structures. For instance each layer of the a Pm, ASM, SCM, RNVSM, NVSM, and the like or the state component index, or knowledge database/s can be represented and/or stored in one or more data structures such as one or more dictionaries, one or more cell arrays, one or more row/columns of an SQL database, one or more filing systems, one or more lists or lists in lists, hash tables, tuples, string format, zip format, sequences, sets, counters, or any combined form of one or more data structure, or any other convenient objects of any computer programming languages such as Python, C, Perl, Java., JavaScript etc. Such practical implementation strategies can be devised by various people in different ways.
The detailed description, herein, therefore describes exemplary way(s) of implementing the methods and the system of the present invention, employing the disclosed concepts. They should not be interpreted as the only way of formulating the disclosed concepts, algorithms, and the introducing mathematical or computer implementable objects, measures, parameters, and variables into the corresponding physical apparatuses and systems comprising data/information processing devices and/or units, storage device and/or computer readable storage media, data input/output devices and/or units, and/or data communication/network devices and/or units, etc.
The processing units or data processing devices (e.g. CPUs) must be able to handle various collections of data. Therefore the computing units to implement the system have compound processing speed equivalent of one thousand million or larger than one thousand million instructions per second and a collective memory, or storage devices (e.g. RAM), that is able to store large enough chunks of data to enable the system to carry out the task and decrease the processing time significantly compared to a single generic personal computer available at the time of the present disclosure.”

### II-V-II Few Exemplary Implementation Methods And The Exemplary Systems and Services

The state navigation methods introduced here by building various data objects from one or more data set or body of knowledge can be used in various applications, mostly in making knowledgeable machines that can navigate through spaces both state space and physical spaces. Therefor the applications includes autonomous moving machines, such as vehicles, and robots, as well as machines with utterance ability by navigating through semantic space or knowledge space or their representative universes.

Beside the applications of state navigation for autonomous system as mentioned and described in previous sections, other exemplary applications are illustrated further such as knowledge discovery and investigation of bodies of data or knowledge. The exemplary systems that can be constructed in order to demonstrate the enabling benefits of the deployment of the disclosed method/s of investigation of compositions of state components in various challenging applications and important functionalities.

As was described throughout the description, the goal of the investigation is to produce a useful data, information, and knowledge from a given or accessed composition/s, according to at least one aspect of significance or the goals of the investigation.

The result of the investigation can be represented in various forms and presentation style and various devices of modern information technology (private or public cloud computing, wired or wireless connections, etc.). The interaction between a client and an investigator, employing one or more of the disclosed algorithms, can be facilitated through various forms of data network accessibility to an investigator through various interfaces such as web interfaces, or data transferring facilities. The result of the investigation can be displayed or provided in various forms such as interactive page/device environment, graphs, reports, charts, summaries, maps, interactive navigation maps, email, image, video compositions, voice or vocal compositions, different nature composition such as transformation of a textual composition to visual or vice versa, encoded data, decoded data, data files, etc.

For instance a goal of investigation can be to finding out the SCs of the composition scoring significant enough novelty value in the context of the given BOK or an assembled BOK wherein the SCs of the composition can be words, phrases, sentences, paragraphs, lines, document or the like for the BOK under investigation.

Another exemplary goal of investigation can be to get a summary of the credible statements from a BOK or to modify a part or partitions of a composition (e.g. a document, an image, a video clip etc.). Or another instance of investigation can be to obtain a map of relations between the most significant parts or partitions of the BOK. For instance a patent attorney, inventor, or an examiner can use the disclosed method to plan his/her claim drafting by investigation the application disclosure and get the most valuable or novel part of the disclosure to draft the claims. Or to get the map of relationships between the components (i.e. the state components) of the disclosure in order to draft a summary, an abstract, an argument, one or more claims, litigation, etc. Or the method can be used for examining the application in comparison to one or more collection of one or more patent application disclosures.

In another instance an intelligent being (e.g. a software bot/robot a humanoid, a machine, or an appliances) can use the system and methods internally or by connecting/communicating to a provider of such services to become enabled to interact intelligently with human (e.g. conversing and doing tasks, or entertaining, or assisting in knowledge discover etc.). And many numerous other examples that could be using one or more of the tools, measures and method/s given in this disclosure to get information and finding/composing the knowledge that is being desired or seek after.

Referring to FIG. 1 here, it depicts one general flow process and the system that can provide one or more exemplary investigation's result, as services, utilizing the algorithms and the methods of the present invention. As shown in the diagram, following the above formulations and methods of building the required variables or the mathematical or data objects (e.g. the matrices and the vectors values etc) and building the various filter, one can design, synthesize, and compose an output according to her/his/it's need or goal of investigation or informational requirements and for an input composition. For example if one applications calls for getting the most credible and valuable partitions of an input compositions then she/he/it must chose (or select through an interface) the corresponding filter (i.e. the suitable XY_VSM/s and algorithm/s) for which to obtain such a credible glance or summary of the composition. Moreover the user or the designer of such system and service can synthesize the suitable filter, using the tools, measures and methods of the present invention to provide the desired response, output or the service.

Alternatively, in another instance, if one is looking only to get the novel parts of the input composition then that can also be readily done following the teaching and computational process of the above to get the novel parts or partitions of the composition using the one or more of the novelty value significance measures.

The input composition is used to build or generate the one or more participation matrices while the state components of different orders are grouped, listed, and kept in the short term or more permanent storage media. The actual SCs or the partitions usually are used at the end of the processing and calculations of the desired quantity or quantities, when they are fetched again based on their corresponding value for one or more measures of the values introduced in previous sections. Accordingly after having the PM/s the system will calculate the desired mathematical objects such as COM, ASM/s, the desired VSM/s, one or more RASM if needed for the desired service , one or more RVSMIs if needed for the service, one or more of NVSM/s, or RNVSM/s or ANVSM/s if desired and so on.

These data objects (e.g. matrix/es or vector/s) are used to synthesize the required filter to provide the desired functionality once it operated on the PM. After operating the filter on the PM, the output is further investigated for selection of suitable SCs of the composition for further processing or re-composing or presentation. The output can be presented in predetermined form/s or format, such as a file, displaying on a web-interface or an interactive web-interface, encoded data in a particular format for using by another system or software agent, sending by email, being displayed in a mobile device, projector and the like over a network, or sent to a client over the internet and the like.

For instance if the desired mode of operation is to find out the novel partitions of the composition exhibiting enough novelty value while having enough significance then the corresponding filter will use the RNVSM of the Eq. 39 for finding, scoring and consequently selection of the suitable partitions for this requested service.

In another word after the composition data are transformed or transported into participation matrix/matrices then we only deal with numerical calculations that will determine the value of the members of the listed SCs and (based on their index in the list or based on their row or column number in the participation matrix) once the value for the corresponding measure was calculated then those SCs that exhibited the desirable value or range of values are selected by the selector or a composer that provide the output data or content, e.g. as service, according to predetermined formats for that service.

In references to FIG. 2 now, it involves the conceptualization of the association strength measure/s. As exemplified several times along the disclosure the concept and values of “association strength measure/s” plays an important role in investigation of the composition of state components as well as providing the data that is valuable itself. That is, knowing the association strength of SCs to each other is important and can be used to build many other applications especially in artificial intelligence applications.

Accordingly, in FIG. 2 here, it is shown one general form of conceptualizing and defining the association strength measures and consequently calculating the association strength values for those measures. As seen in this exemplary embodiment the association strength of the SCs of order k that have co-occurred in one or more SCs of order l is given by a function of their number of co-occurrence and the value/s respective of one or more of the “value significance measure/s” (e.g independent probability of occurrence). Several exemplified such association strength measure were given by Eq. 16-24. The FIG. 2 was also illustrated in some details in the section II-III of this disclosure.

Referring to FIG. 3 now, it is to show that any composition of state components can in principal be represented by a graph which in this preferred embodiment shown as an asymmetric graph. The exemplified graph is corresponded to one of the exemplary “association strength matrix”, i.e. an ASM, as representative of its adjacency matrix. The nodes represent the desired group of SCs and the edge or arrows show the link between the associated nodes and the values on the edges are representative of the association strength from one node to the connected one. This figure is to graphically exemplify and depicts that compositions of state components and a network of state components can basically be investigated and dealt with in the same manner according to the teachings of the present invention.

In FIG. 4, there is shown again another embodiment for the process of calculating various value significance measures in more details. As seen the data of the input composition is transformed to calculable quantities and data from which, employing the above methods and formulations, the desired value significance measures are calculated and/or are stored in the storage areas for further use or being used by other processes or programs or clients.

In reference to FIG. 5, it became evident that at this stage, and in accordance with the method, and using one or more of the participation matrix and/or the consequent matrices one can also evaluate the significance of the SCs by building a graph and calculating the centrality power of each node in the graph by solving the resultant Eigen-value equation of adjacency matrix of the graph.

FIG. 5 therefore shows the block diagram of one basic exemplary embodiment in which it demonstrates a method of using the association strengths matrix (ASM) to build an “State component Map (OSM)” or a graph. The map is not only useful for graphical representation and navigation of an input body of knowledge but also can be used to evaluate the value significances of the SCs in the graph. Utilization of the ASM introduced in this application can result in better justified State component Map (OSM) and the resultant calculated significance value of the SCs.

The association strength matrix could be regarded as the adjacency matrix of any graphs such as social graphs or any network of anything. For instance the graphs can be built representing the relations between the concepts and entities or any other desired set of SCs in a special area of science, market, industry or any “body of knowledge”. Thereby the method becomes instrumental at identifying the value significance of any entity or concept in that body of knowledge and consequently be employed for building an automatic ontology. The VSM_1,2, . . . x^{k|l} and other mathematical objects can be very instrumental in knowledge discovery and research trajectories prioritizations and ontology building by indicating not only the important concepts, entities, parts, or partitions of the body of knowledge but also by showing their most important associations.

Referring to FIG. 6a, 6b, 6c now, they show one graphical representation of the concept of the different values of different “value significance measures”. As seen values of different types of value significance measures (labeled as XY_VSM wherein XY is used to show the different types of VSM/s) can be shown as a vector in a multidimensional space. Though XY_VSM/s in general are matrices that might also carry the relational value significances but still any row or column (as shown in FIG. 6a) of them can be shown as discrete vectors in a multidimensional space. These discreet vectors can also be treated as discrete signals in which they can be further be used for investigation of the compositions. Some types of XY_VSM, that are intrinsic, are vectors (e.g. FIG. 6b) for which they can readily be used to weigh other SCs or the partitions of the composition. Also shown in FIG. 6c are some of the vectors that might be “special conveyer vectors” labeled with “significance conveyer vectors” in the FIG. 6c and are usually predefined or predetermined that can be used for filtering out and/or dampening or amplifying and/or shaping/synthesizing the VSMs of one or more of the predetermined SCs of the composition. FIG. 6c demonstrate that special conveyer vectors or VSM have basically the same characteristics as other XY-VSM except the values might have been set in advance.

FIG. 7 shows one way of demonstrating (e.g. schematically) how two exemplary value significance vectors can be extracted from an exemplary “association strength matrix” (asm) which in this instance are also shown to be used to evaluate the associations of SCs of order l (e.g. sentences) to particular SC of order k (e.g. a word or keyword or phrase). Generally FIG. 7 is for further clarification and instantiation of the actual meaning and their use and the way to manipulate and use, deal, and calculate the variables and data or mathematical objects that were introduced in the previous sections. However, the disclosed processes and methods with the given formulations should be enough for those of ordinary skilled in the art to enable them to implement, execute, and apply the teachings of the present invention.

An application of the instance demonstration of FIG. 7 is that an SC of order l, can be selected by the investigator based on its strength of association to one or more SCs of the order k. The calculation and the selection method of SCs of order l can find an important application in document retrieval, question answering, computer conversation, in which a suitable answer or output is being south from a knowledge repository (e.g. a given composition) in response to the input query or composition. As an example, for showing how to utilize the disclosed method/s, an input statement or a query is parsed to its constituent SCs of order k and from the association strength matrix (which might be constructed from and for said knowledge repository) then the mostly related partitions of the stored composition (i.e. the knowledge repository) is retrieved in response of an input query which is a conversational statement or a question. For instance, the mostly related partition of the knowledge repository can be the partition (SC of order l) that has scored the highest average or cumulative association to the constituent SCs of the input query. The mostly related partition of the knowledge repository might have scored the highest, for example, after multiplication of the association strength vectors of the SCs of the input query in the association strength matrix that have been built from the knowledge repository.

Referring to FIG. 8 now, it shows, in schematic, a block diagram of an exemplary system as well as the process of further clarification as how to use the “value significances” data of one or more SCs of particular order to evaluate and calculate the one or more “value significances” of SCs of another order using the one or more XY_VSM and one or more participations matrix. The XY in the FIG. 8 is the indication, and can be replaced with the desired type and number combination, of the desired “value significance measure”. Therefore XY_VSM in FIG. 8 can be replaced with any of the different types of the “value significance measures” (such as RVSM, NVSM, ARASM, RSVM, etc.). The data objects can be stored, if desired, for later use so that the pre-calculated data and objects are pre-made and can easily be retrieved for the corresponding compositions and the desired application. The pre-made stored data can be used to accelerate and speeding up the process of composition investigation in a system that provide such a service/s to one or more clients.

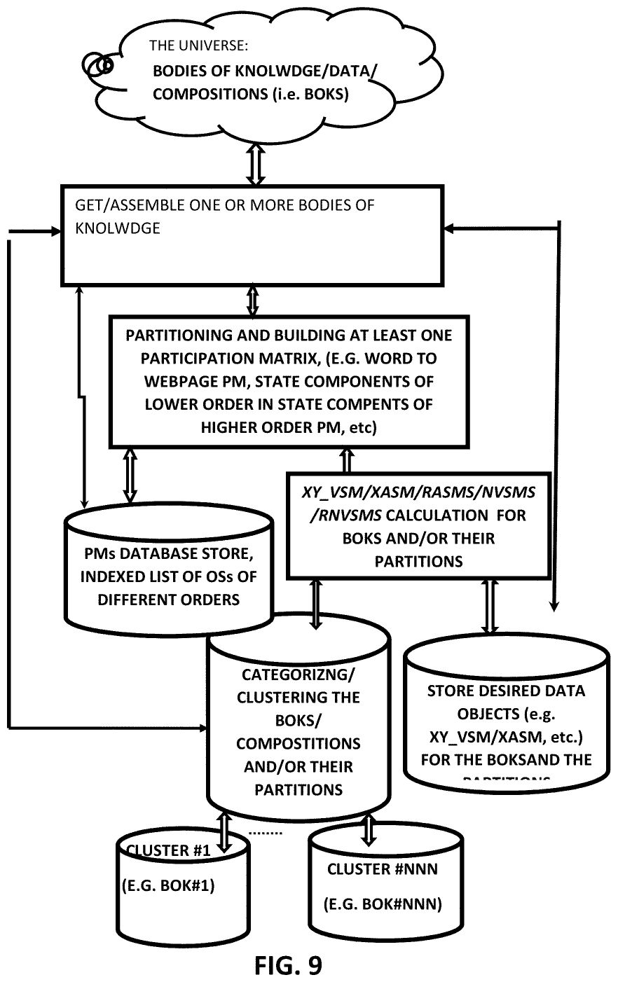

Referring to FIG. 9 now it shows an exemplary system, process and application of the present invention. FIG. 9 shows an instance of clustering and ranking, and sorting of a number of webpages fetched from the internet for example, by crawling the internet. This is to demonstrate the process of indexing and consequently easily and efficiently finding the relevant information related to a keyword or a subject matter. This is the familiar but very important application and example of the present invention to be used in search engines. As seen after crawling a number of webpage or documents from the internet (or from any other repository in fact) the pages/documents/compositions are investigated so that the associations of the desired part or partitions of such collections are calculated to other desired SCs of the collection of the compositions. Now, in such a exemplary search engine, once a client enter a query or a keyword, it would be straightforward to find the most relevant document, page, or composition to the input query, i.e. or a target SC.

Accordingly, as discussed in the previous sections, having one or more of the “association strength matrix/es” (indicated by XASM) or RVSMs etc., using the disclosed algorithms make it possible to retrieve the documents with the highest degrees of relevancy to the input query or the target SC. This is one of the very important applications and implication of the disclosed teachings and materials, since, as is experienced by many users of the commercial search engines; the relevancy of retrieved documents to the input query has been and is a major challenge in improvement of the search engine performance. However, employing the investigation methods of present invention, through its various measures, make it possible to quickly and reliably retrieve the most semantically related document/page to the input query.

Furthermore, some special SCs can be selected for which the association strength of pages are to be calculated. For instance, special SCs can be the content words such as nouns or named entities. Nevertheless there would be no limitation on the selection or choice of the target SC and they can basically be all possible types of words, or even sentences and higher orders partitions.

Moreover, through the investigation of crawled pages, either in one step or in several steps, SCs of high value significance can be identified so that the whole composition (i.e. the whole collection of the documents or pages) can be clustered or categorized into bodies of knowledge under one or more target subject matter or head categories (e.g. the high value SCs of lower order, such as words or phrases).

The target SCs could usually be the keywords or phrases, or the words or any combinations of the characters, such as dates, special names, etc. However in extreme but useful case the target SCs of such composition could be the extracted sentences, phrases, paragraphs, or even a whole document and the like.

As seen from the teachings of the present invention then it becomes readily straightforward to calculate the association and relevancy of each part of such a composition (such as the webpages or documents or their parts thereof) to each possible target SCs. These data are stored and therefore upon receiving a query (such as a keyword or a question in a natural language form, or in the form of a part of text etc.) the system will be able to retrieve the most relevant partitions (e.g. a sentence, and/or paragraph, and/or the webpage) and present it to the user in a predetermined format and order.

Let's exemplify and explain this even in more detail here, when a service provider system such as a search engine, question answering or computer conversing, which comprises or having access to the system of FIG. 9, receives a query from a user, the system can simply parse the input query and extract all or some of the words of the input query (i.e. the SCs of order one) then by having calculated the associations strength of rasm x¹′⁵¹ one can easily calculate the association strength of each of the documents (e.g. web-pages) to the words of the input query, and eventually the documents which have the overall acceptable association strength with the selected words of the input query will be presented to the queries as the most relevant document or content.

In another exemplary simplified method of retrieval using this embodiment the most related document or partition to the input query are identified and retrieved or fetched as follow:

extract the SCs (e.g. words) of the input query,
obtain the rasm x^{1→1|} vector (e.g. the association strength of a words to each other obtained from the investigation of the crawled repository of webpages consisting one or more webpages/documents) for the input words of the query,
make a common association strength spectrum or vector for the input words of the query by, for example, averaging the rasm_x^{1→1|} vectors or multiplying them to each other,
use the common association vector to identify the most related or associated documents, or sentences to the input query by multiplying the common association spectrum with the respective participation matrix (e.g. PM¹⁵ for document retrieval and PM¹² for question answering or conversation as an example).

Moreover most of calculation can be done in advance and even for each target SCs (though not as a condition but usually the intrinsically significant SCs can be used as possible target) and therefore there could be assembled for each possible target SC a body of knowledge pre-made and pre categorized and ready for retrieval upon receiving a query by a system which has access to these data and materials. The degree of relevancy of such retrieved pages to the target SCs (e.g. the user's Queries) is semantically insured and the relevancy of such retrieved materials far exceeds the quality of the currently available search engines.

More importantly in a similar manner the engine can return for instance the document or the web-page that composed of the partitions of high novelty values, either intrinsic or relative, to the target SC/s. Therefore the engine can also filters out and present the documents or webpages that have most relevancy to the desired “significance aspect” based on the user preferences. So if novelty or credibility or information density of a document, in the context of a BOK, is important for the user then these services can readily be implemented in light of the teachings of the present invention.

Referring to FIG. 10 now, it shows schematically a system of composition investigations that can provide numerous useful data and information to a client or user as a service. Such output or services in principal can be endless once combined in various modes for different application. However in the FIG. 10 a few of the exemplary and important and desirable outputs are illustrated. The FIG. 10 illustrates a block diagram system composed of an investigator and/or analyzer and/or a transformer and/or a service provider that can receive or access a composition and provide a plurality of data or content as output. The investigator in fact implement at least one of the algorithms of calculating one of the measures in order to assign a value on the part or partitions of the compositions and based on the assigned value process one or more of the partitions or SCs of the particular order as an output in the form of a service or data. The output could be simply one or more tags or SC/s that the input composition can be characterized with, i.e. significant keywords of the composition. In this instance, the significant keywords or labels are selected based on their values corresponding to at least one of the aspectual XY_VSM, i.e. one of the value significance measures.

As another example, the output or outcome of the investigator of FIG. 10, could be to provide the partitions of the input composition which have exhibited intrinsic value significances of above a predetermined threshold. Another output could be the novel parts or the SCs of the compositions that scored a predetermined level of a particular type of novelty value significance. Or the output could be the noisy part of a composition or a detected spam in a collection of compositions etc.

Several other output or services of the system of FIG. 10 are depicted in the FIG. 10 itself which are, in light of the foregoing, self explanatory.

Referring to FIG. 10-1 now, it shows another instance and application of the present invention in which the process, methods, algorithms and formulations used to investigate a number of news feeds and/or news contents automatically and present the result to a client. In this exemplary but important application system, the news are being first categorized automatically through finding the significant head-categories and consequently clustering and bunching the news into or under such significant head-categories and then select one or more partitions of such cluster to represent the content of that clustered news to a reader. Head-categories can simply being identified, by evaluating at least one of the significance measures introduced in the present invention, from those SCs that have exhibited a predetermined level of significance. The predetermined level of significance can be set dynamically depends on the compositions of the input news.

It is important to notice that some of data in respect to any of these features (e.g. association of SCs) can be obtain from one composition (e.g. a good size of body knowledge) in order to be used in investigation of other compositions. For instance it is possible to calculate the universal association of the concepts by investigation the whole contents of Wikipedia (using, for instance, exemplary teachings of present invention) and use these data/knowledge about the association of concept in calculating a relatedness of SCs of another composition (e.g. a single or multiple documents, or a piece or a bunch of news etc.) to each other or to a query.

Moreover other complimentary representations, such as a navigable state component map/s, can accurately being built and accompany the represented news. Various display method can be used to show the head-categories and their selected representative piece of news or part of the piece of the news so that make it easy to navigate and get the most important and valuable news content for the desired category. Moreover the categorization can be done in more than one steps wherein there could be a predetermined or automatic selection of major categories and then under each major category there could be one or more subcategories so that the news are highly relevant to the head category or the sub-categories or topics.

Furthermore many more forms of services can be performed automatically for this exemplary, but important, application such as identifying the most novel piece of the news or the most novel part of the news related to a head category or, as we labeled in this disclosure, to a target SC. Such services can periodically being updated to show the most updated significant and/or novel news content along with their automatic categorization label and/or navigation tools etc.

The data/information processing or the computing system that is used to implement the method/s, system/s, and teachings of the present invention comprises storage devices with more than 1 (one) Giga Byte of RAM capacity and one or more processing device or units (i.e. data processing or computing devices, e.g. the silicon based microprocessor, quantum computers etc.) that can operate with clock speeds of higher than 1 (one) Giga Hertz or with compound processing speeds of equivalent of one thousand million or larger than one thousand million instructions per second (e.g. an Intel Pentium 3, Dual core, i3, i7 series, and Xeon series processors or equivalents or similar from other vendors, or equivalent processing power from other processing devices such as quantum computers utilizing quantum computing devices and units) are used to perform and execute the method once they have been programmed by computer readable instruction/codes/languages or signals and instructed by the executable instructions. Additionally, for instance according to another embodiment of the invention, the computing or executing system includes or has processing device/s such as graphical processing units for visual computations that are for instance, capable of rendering and demonstrating the graphs/maps of the present invention on a display (e.g. LED displays and TV, projectors, LCD, touch screen mobile and tablets displays, laser projectors, gesture detecting monitors/displays, 3D hologram, and the like from various vendors, such as Apple, Samsung, Sony, or the like etc.) with good quality (e.g. using a NVidia graphical processing units).

Also the methods, teachings and the application programs of the presents invention can be implement by shared resources such as virtualized machines and servers (e.g. VMware virtual machines, Amazon Elastic Beanstalk, e.g. Amazon EC2 and storages, e.g. Amazon S3, and the like etc. Alternatively specialized processing and storage units (e.g. Application Specific Integrated Circuits ASICs, system/s on a chip, field programmable gate arrays (FPGAs) and the like) can be made and used in the computing system to enhance the performance and the speed and security of the computing system of performing the methods and application of the present invention.
Moreover several of such computing systems can be run under a cluster, network, cloud, mesh or grid configuration connected to each other by, data bus/es, communication ports and data transfers apparatuses such as switches, data servers, load balancers, gateways, modems, internet ports, databases servers, graphical processing units, storage area networks (SANs) and the like etc. The data communication network to implement the system and method of the present invention carries, transmit, receive, or transport data at the rate of 10 million bits or larger than 10 million bits per second;”

“Furthermore the terms “storage device, “storage”, “memory”, and “computer-readable storage medium/media” refers to all types of no-transitory computer readable media such as magnetic cassettes, flash memories cards, digital video discs, random access memories (RAMSs), Bernoulli cartridges, optical memories, read only memories (ROMs), Solid state discs, and the like, with the sole exception being a transitory propagating signal.

These applications and systems are presented to exemplify the way that the present invention method of investigation might be employed to perform one or more of the desired processes to get the respective output or the content, answer, data, graphs, analysis, and service/s etc. Several modes of services and further applications are exemplified herebelow.

The processes and systems of FIGS. 8 to 20-2 can be an on premises system, an intelligent being, or a network system of computation and processing, storage medium, displays and interfaces, and the associated software.
In another instance the systems and processes of the FIGS. 8 to 20-2 can be a remote system providing the service in the form of cloud environment for one or more clients providing one or more the services mentioned above.
Yet in another instance the system can be a combination of an on premises private cloud/machine computation facilities connected to a public cloud service provider. These familiar mode of operation characterized as public and/or private and/or hybrid cloud computing environment (either distributed or central, on premises or remote, private or public or hybrid) is known to the skilled to art and the disclosed methods of investigations of compositions of state components can be performed in variety of topologies which is regarded as service provider system employing one or more of the generating methods/s of output data respective of one or more of the disclosed methods of the investigation of a composition of state components.
An interesting mode of service is when for an input composition and after investigation the system yet provides further related compositions or bodies of knowledge to be looked at or being investigated further in relation to the one or more aspect of the input composition investigation. Another service mode is that the system provides various investigation diagnostic services for the input composition from user.
Another mode of use is when an intelligent being make connection or communicate with the system of composition investigation (i.e. the brain) by way of communication networks to provide desired services (e.g. conversing, telling stories, talking, instructing, providing consultancy, generating various content, manufacturing, etc.). In another instance the currently disclosed method/s and system/s is implemented within the intelligent being or used to realize new intelligent beings.
Furthermore the method and the associated system can be used as a platform so that the user can use the core algorithms of the composition investigation to build other applications that need or use the service of such investigation. For instance a client might want to have her/her website being investigated to find out the important aspects of the feedback given by their own users, visitors or clients.
In another application one can use the service to improve or create content after a through investigation of literature.
In another instance the methods and systems of the present invention can be employed to provide a human computer conversation and/or computer/computer conversation such as chat-bots, automatic customer care, question answering, fortunetelling, consulting or any general any type of kind of conversation.
In another mode a user might want to use the service of the such system and platform to compare and investigate her/his created content to find out the most closely related content available in one or more of such content repositories (e.g. a private or public, or subscribed library or knowledge database etc.) or to find out the score of her/his creation in comparison to the other similar or related content. Or to find out the valuable parts of her/his creation, or find a novel part etc.
As seen there could be envisioned numerous instance of use, products, beings, and applications of such process and methods of investigating that can be implemented and utilized by those of skilled in the art without departing from the scope and sprit of the present invention.

### II-V-III Artificial Intelligent Systems Using Neural Networks

A network of objects is considered a composition and vice versa. Accordingly the methods of investigation disclosed here are applied to build new applications, services and products. Accordingly a network of state components can be a representative for a composition and vice versa. In particular artificial neural networks are therefore a form or a representative of a composition of state components itself whose associations of its state components (e.g., connections between nodes of the network) are to be known.

The popularity of the neural networks and the so-called deep learning is due to its potential ability to train a network of connecting nodes to become able to map a certain set of data (e.g., an input dada) to a desired set of data (e.g. the output data).

Currently the connection weight between nodes of a neural network is obtained by various training/optimization algorithms and processing which are generally rooted in stochastic gradient decent type of optimization algorithms.

In training of such system having a good initializing of the sate/s of such network (e.g., the initial weight or weight function between connecting nodes) is of vital importance for the success of the training, ability and overall performance of the trained neural network system.

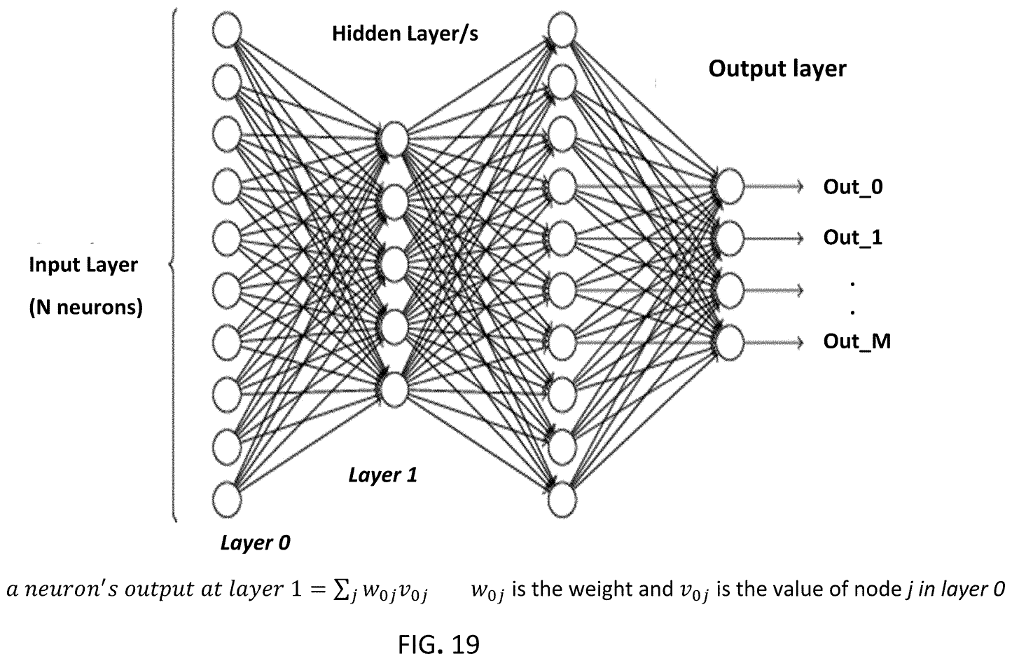

Referring to FIG. 19 now, here we like to use the disclosed methods for building and training an artificial neural network for various e applications such as categorizations, recognition, content generation or utterance generation. In here we show an exemplary multilayer neural network comprises of a number of neurons in each layer. Furthermore, without losing the generality of the exemplary neural network of FIG. 19, the activation function of the neurons, in FIG. 19, can be considered a unity or a linear function. Other forms of activation functions can readily be still considered without decrementing the concepts. The whole network can have very many layers (e.g. hidden layers to provide extra degrees of freedom for optimization) each node can be considered or assigned with a state component of predefined order (e.g. such as each node in the first layer can be representative of a textual word).

Each node (e.g. a neuron or perceptron) in each layer is connected to a number of other nodes in its preceding layer and to a number of nodes on its consequent layer. The role of neural network is to learn the impact of each input/neuron to other neuron in other layers either directly or indirectly (through hidden layers).

The fundamentals of neural networks and more recently deep learning neural networks are straightforward and is known in the literature. Basically the aim of learning/ or training of a neural network is to find or adjust the weight/impact of each node to/from its connecting nodes.

The training of any reasonably useful neural network however is not a trivial undertaking needing a large number of highly specialized processing devices (e.g expensive Graphical Processing Units) and a long training time.

It can be shown that a matrix of N×M will map the N inputs of the network in FIG. 19 to the desired number of outputs (e.g. M outputs).

Let's call such a matrix A which would be a N×M matrix and itself can be decomposed to number of (in fact it can be decomposed to infinite number of other matrixes) other matrices like the followings:

Matrix A with dimension of N×M=A1(dimension: N×M1)×A2(dimensions: M2×M3)× . . . An(dimensions: Mn×M)

wherein A1, A2, . . . An are matrixes with dimensions specified in the above equations. Each intermediate matrix can be corresponded to the connections of nodes of adjacent layers. These intermediate matrixes show the connection and the weight of the connections between nodes of adjacent layer or back propagating connections from other layers. Computationally and in practice training of a neural network starts/initialized with a randomly populated matrixes and the values are changes and varied through various computational algorithms until the desired results are achieved satisfactorily. Such desired results from the network could be that the network become able to classify an image correctly with high degree of probability, or distinguishes an audio signal and extract or convert the audio signal to its corresponded or equivalent text, and/or translating text/voice between languages etc.

Regardless of the application of a neural network, however, each of these intermediate, matrices that will collectively make the whole neural network to perform a task, are to be fund which is the goal of neural networks learning algorithms. It is conceptually easy to see that if a node (i.e. a neuron) is connected to/from another node so they would have some sort of relationships and or, using the terms of this disclosure, some types of associations and relationship with each other.

Accordingly it is easy to see that the goal of neural of network training algorithms is in fact trying to find a degree or a force intensity or influence or in other word the strength of the associations between the nodes that make up the neural network.

Now considers that nodes of the first layer are corresponded to State components of order k and the nodes of a second layer are corresponded or representatives of State components of order l (k and l can be the same or equal) and the next layer is corresponded or representatives of state components of order l+1 and so on.

For instance, in an exemplary embodiment, nodes of the first layer of a neural network can be regarded or been representative of textual words of a natural language such as words of English languages as input to a system of networks of nodes (e.g. Neural Networks, the so called deep learning neural nets, or any other network of objects with some data processing function). The nodes in the second or third layer can be representatives of sentences or English words again (k=l) whereas the nodes of third layer can be representative of word phrases, sentences, paragraphs, textual templates (sentence template, paragraph templates containing one or more words), and so on. Same can be said for other layers between the input and output layer. (Same can be done for various sets of partitions of images and pictures as will be discussed ore specifically in the next section).

Currently to find such relationship between theses nodes the neural net needs to be trained with huge number of data sets and corpuses in order to have relatively a meaningful working neural network and sensible output. Nevertheless, still the weight of the connections between nodes or neurons cannot be interpreted or explained in terms of their actual role or meaning within the whole system of conventional neural networks systems, because no one will know what each node might be representing.

Without going into the details of shortcoming of such training and drawbacks of neural network to perform intelligent tasks, here it is aimed to use the data objects (e.g. various association strength matrices, various significance values etc.) of this disclosure which are obtained or built by exercising the teachings of this disclosure to build a neural networks both in hardware or software shape with the initial connections and weights are obtained by calculating for example ASM of different types and order and if it is needed further train the neural network to even function better. Said neural network further can be implemented as various classes/types of recurrent neural networks, convolutional neural networks, recursive neural networks, neural history compressor, feed forward neural networks and the like.

The advantage of using one or more of ASM/s, as disclosed in this patent application, to build a neural network is threefold as outlined next,

1. First: using the data of ASM/s we would know which nodes has to be connected to each other rather than blindly connecting every node to every other node. Currently to get a satisfactory result one have to have very large number of neurons at each layer (in order of millions to billions) and connecting the nodes to each other as much as possible in order to have enough parameters to play with to eventually synthesize an unknown function (e.g. the artificial intelligent brain).
Using the data of associations from this disclosure therefore can reduce the size of the neural network significantly.
2. Secondly, since the data (e.g. the entries of ASM matrix or connection weight between the nodes) are close to their actual values in really world, further adjustments to improve the performance of the artificial neural network would converge much quicker while the performance of the whole network (as an artificial brain) would be significantly enhances.
3. Thirdly, Since we have introduced various data objects and various types of associations and relationships between the state components of a composition or very large set of compositions the neural network become programmable, explainable, interpretable, and therefore the designer of such systems has control and insight into to working mechanics of the artificial intelligent system (e.g. a robot or self-driving car/robot etc) which employs an artificial network of state components (e.g. neural network). In this way the designer of such system have advance knowledge and expectation from the system whereas currently the neural networks are trained by brute forces and sheer processing power of processing devices such as NVidia graphical processing accelerators.
To summarize this section the disclosure introduces an artificial intelligent system which uses the various data objects of/from the investigator of FIG. 1 or 10 to build and train further a network of state components (a neural net is an instance of network of state components) to perform intelligent tasks and to implement machine learning by investigating one or more bodies of knowledge to learn about the world.
There could be at least two different systems to build the AI system here. One is that the investigator is part of the system and second is that the AI system (e.g. the hardware or software system) uses the data objects of the investigator in order to learn and train itself much faster, using minimal number nodes as necessary and much efficient while become much more affordable.

Such a system then is incorporated into mechanical systems such as special purpose or general purpose robots and intelligent systems and machines.

### II-V-IV Conversant Agents Using Coupled Utterance Modes

An ASM can define a Hilbert space in which each row or column is a point in that space or a numerical vector. In such spaces excitation of one point can cause to excite other points of that space.

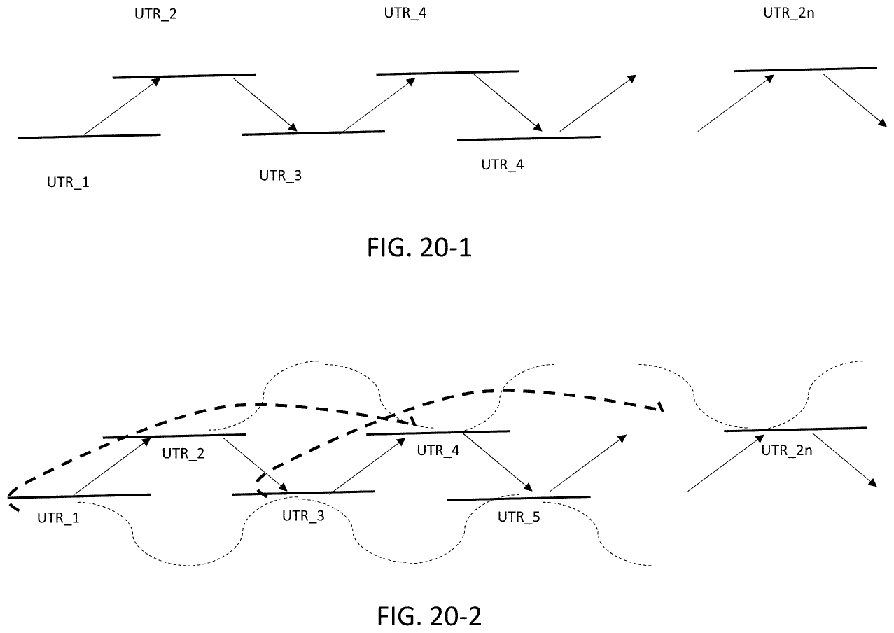

For instance consider we have two conversant agents (one can be a human agent) that try to make conversation. Once the first agent start to utter that utter will cause a relevant utter on the second agent which in turn except another relevant utter from the first agent and so on so that a meaningful conversation can take place. FIG. 20-1 schematically illustrates the conversation of tow conversant agents. To build such conversant agents, one can use the methods of the current disclosure to build a knowledgeable machines capable of meaningful and context aware utterance.
First the knowledgeable system or machine have acquired the knowledge from the investigation of large bodies of textual knowledge (other forms of knowledge can also be transformed to textual bodies of knowledge) by exercising the methods of the present invention to acquire the knowledge about the state component of the real world through the literature and have built the derivative data objects (i.e. various PMs, VSMS, ASMs, COPs RASMs, CASMs, etc.) that make it possible to make the machine be knowledgeable. The knowledgeable machine/system comprises, (among other parts and hardware and software) or has access to these data objects which obtained by processing large enough body of textual data according to the teachings of this disclosure.
For instance, once the first agent utter a statement then the knowledgeable system, through using one or more types of ASMs and/or COPs, CAUSL ASM and/or VSMs etc., can assemble or compute an “association strength spectrum” for this utter (e.g. from asm spectrum of the utter constituents words) to find or compose a most relevant and appropriate response to the first utter according to some desired kind of conversation. By “desired kind of conversation” we mean the type of conversation such as being entertaining, or being informative, or being argumentative etc. Depends on the kind of conversation then deferent types of data objects can be used (such as which ASM, or COP or CAUSAL ASM or which type of VSM.) For instance is conversation is going to be the most informative response which gives the highest knowledge then it might be more appropriate to use COP as the ASM, and if the conversation is going to be for new discovery and argumentative, perhaps a CASAL type ASM is used to find best suited response to the first agent utterances. It is become evident that various kinds of conversation can be combined to make a new kind of conversation such as both entertain and informative, and the like.
Usually there could be many relevant utters which we call it “Utterance Modes” that might get excited in response to an incoming or receiving utter (each utter is a utterance mode and it is different from the kind of conversation). However, in practice non generic words can trigger or excite one or more distinguished utterance mode.
However, again the knowledgeable system (e.g. as the second conversant agent) can use ASM, COPs and CAUSAL ASM (CASM) to assemble or compose a response (i.e. an utter mode) in response to the first agent utter on its own (for instance using COPs or CASMs) and so on. Moreover the second agent utterances can take into accounts previous conversations with the same or weighted influence on the response utter as shown in FIG. 20-2. In this case the spectrums of the previous utterance will be accounted for in the spectrum of the future utterances.
The conversation and the utterance from the knowledgeable machine can also be viewed and model by state transiting of a system as described in section . Therefore again the teaching of present invention for navigating through spaces can readily be used to build intelligent, knowledgeable systems with meaningful utterance abilities.

### II-V-V SUMMARY

The disclosed frame work along with the algorithms, methods, and systems enables people in building knowledgeable machines and more particularly machines and systems with autonomous navigation abilities in the desired space/s. Furthermore, various disciplines, such as artificial intelligence, robotics, information retrieval, search engines, knowledge discovery, genomics and computational genomics, signal and image processing, information and data processing, encryption and compression, business intelligence, decision support systems, financial analysis, market analysis, public relation analysis, and generally any field of science and technology can use the disclosed method/s of the investigation of the compositions of state components and the bodies of knowledge to arrive at the desired form of information and knowledge with ease, efficiency, and accuracy. Since the disclosed underlying theory, methods and applications are universal it is worth to implement the system of executing the methods and products directly on processing chips/devices to further increase the speed and reduce the cost of such investigations of compositions. In one instance, for example, the data processing operations (e.g. vector/matrix manipulations, manipulating data structures, association spectrums calculations and manipulation, etc.) and even storage of the data structures, can be implemented with designs of Application Specific Integrated Circuits (ASICS), or Field-Programmable Gate Arrays, (FPGA), or the system-on-chip, based on any computing and data processing device manufacturing platforms and technologies, such as silicon based, III-IV semiconductors, and quantum computing artifacts to name a few. Similarly, if the disclosed methods of the investigation and applications are going to be used in/with implementing neural or cognitive based type of computations, still one can implement the system on such chips and by said technologies. Accordingly, those competent in the art can implement the disclosed methods for various applications/products in/with various data processing device manufacturing and designs on the physical material level.

The invention also provides a unified and integrated method and systems for investigation of compositions of state components. The method can be implemented language independent and grammar free. The method is not based on the semantic and syntactic roles of symbols, words, or in general the syntactic role of the state components of the composition. This will make the method very process efficient, applicable to all types of compositions and languages, and very effective in finding valuable pieces of knowledge embodied in the compositions. Several valuable applications and services also were exemplified to demonstrate the possible implementation and the possible applications and services. These exemplified applications and services were given for illustration and exemplifications only and should not be construed as limiting application. The invention has broad implication and application in many disciplines that were not mentioned or exemplified herein but in light of the present invention's concepts, algorithms, methods and teaching, they becomes apparent applications with their corresponding systems to those familiar with the art.

Among the many implications and applications, the disclosed systems and methods have numerous applications in autonomous state navigators, knowledgeable machines, knowledge discovery, knowledge visualization, content creation, signal, image, and video processing, genomics and computational genomics and gene discovery, finding the best piece of knowledge, related to a request for knowledge, from one or more compositions, artificial intelligence, realization of artificially or new intelligent begins, computer vision, computer or man/machine conversation, approximate reasoning, as well as many other fields of science and generally state component processing. The invention can serve knowledge seekers, knowledge creators, inventors, discoverer, as well as general public to investigate and obtain highly valuable knowledge and contents related to their subjects of interests. The method and system, thereby, is instrumental in increasing the speed and efficiency of knowledge retrieval, discovery, creation, learning, problem solving, and accelerating the rate of knowledge discovery to name a few.

It is understood that the preferred or exemplary embodiments, the applications, and examples described herein are given to illustrate the principles of the invention and should not be construed as limiting its scope. Those familiar with the art can yet envision, alter, and use the methods and systems of this invention in various situations and for many other applications. Various modifications to the specific embodiments could be introduced by those skilled in the art without departing from the scope and spirit of the invention as set forth in the following claims.

What is claimed is:

1. A system for state navigation comprising:
a first system comprising:
one or more computing or data processing devices, operationally or communicatively coupled to a first one or more non-transitory computer-readable storage medium, said one or more non-transitory computer readable storage medium storing one or more programs comprising instructions, which when executed by the one or more computing or data processing devices, cause the one or more devices to:
accessing a body of data,
decomposing the body of data into plurality of sets of state components each said set of state components assigned with a predefined order,
building a first one or more data structures corresponding to participation of state components of a first order into state components of a second order,
building a second one or more data structures corresponding to association strengths of state components of the first order from said first one or more data structures,
building a third one or more data structures corresponding to conditional occurrence probabilities of one or more state components of the first order given occurrence of one or more state components, of the first order, in a one or more state comments of the second order,
storing at least one of the first, the second, and/or the third data structures in one or more non-transitory storage devices readable by said one or more computing or data processing devices,
outputting, given a state of component of second order, one or more signals corresponding to one or more projected state components, of the first order, that are most likely to occur in another state component of second order, and
a second system comprising:
receiving, and/or accessing, and/or having facilities to obtain, one or more state components of the second order,
wherein navigating the second system based on said one or more projected state components, from the first system, given at least one state component of the second order from the second system.

2. The system of claim 1, wherein said one or more signals control a mobile system, as the second system, to navigate through a space-time state space.

3. The system of claim 2, wherein the mobile system acquis environmental data from one or more arrays of physical sensors providing the environmental state components to said navigation system.

4. The system of claim 1, further comprising conversant systems wherein the projected state components are textual wherein said conversant system compose a state components of the second order based on said projected one or more state component of the first order.

5. The system of claim 1, wherein the projection is done by processing the at least one of the data structures corresponding to at least one measure of association strength between said state components of the first order.

6. The system of claim 1, further comprising calculating information content of state components of a predefined order of the body of knowledge, by processing the one or more data structures corresponding to conditional occurrence probabilities of the state components of said predefined order.

7. A method for identifying causal associations between state components of a body of data comprising:
at least one computing or data processing device, operationally or communicatively coupled to one or more non-transitory computer-readable storage devices,
accessing, by said at least one computing or data processing device, the body of data,
decomposing, by said at least one computing or data processing device, the body of data into plurality of sets of state components each said set of state components assigned with a predefined order,
building, by said at least one computing or data processing device, a first one or more data structures corresponding to a participation matrix (PM) indicating participation of state components of a first order into state components of a second order,
building, by said at least one computing or data processing device, a second one or more data structures, corresponding to causal association strengths of state components of the first order, by performing a method comprising:
building, by said at least one computing or data processing device, a third one or more data structures corresponding to a shifted participation matrix (SPM) by shifting the participation matrix by a desired shift value, and
processing or operating, by said at least one computing or data processing device, on the participation matrix (PM) and the shifted participation matrix(SPM) to calculate the casual association strength between the state component of the body of data, and
storing at least one of the first, the second, the third data structures, and/or said causal association strength between at least two state components, in one or more non-transitory computer readable storage devices or media.

8. The method of claim 7 further comprising outputting, given a state of component of second order, one or more signals corresponding to one or more projected state components, of the first order, that are most likely to occur in another state component of second order.

9. The system of claim 8, wherein said one or more signals control a mobile system, as the second system, to navigate through a space-time state space.

10. The system of claim 9, wherein the mobile system acquire environmental data from one or more arrays of physical sensors providing the environmental physical state components to said navigation system.

11. The system of claim 1, further comprising conversant systems wherein the projected state components are textual wherein said conversant system compose a state components of the second order based on said projected one or more state component of the first order.

12. The method of claim 7 further comprising:
providing an environment to get an input from a client,
uttering a response based on the client's input and the data of one or more of said data structures
corresponding to the causal associations of state components of said body of data.

13. The method of claim 7 further comprising:
a computer implemented method of evaluating one or more of the following values for one or more state components of a composition:
i. a value respective of at least one of a one or more value significance measures,
ii. a value respective of at least one of a one or more association strength measures,
iii. a value respective of at least one of a one or more relative association strength measures,
iv. a value respective of at least one of a one or more relative value significance measures,
v. a value respective of at least one of a one or more novelty value significance measures,
vi. a value respective of at least one of a one or more relative novelty value significance measures,
vii. a value respective of at least one of a one or more causal association strength measures,
viii. a value respective of information content of a state component of the composition, ix.
x. a value respective of at least one or more conditional probability of occurrence of an state component of the composition in a partition of the composition, given participation of another sate component in said partition of the composition,
xi. a value respective of causal value significance.

14. The method of claim 12, wherein said uttered response is further based on at least one of client's previous input or at least one of the previously uttered responses.

15. A visual investigation system comprising:
a first one or more computing or data processing devices, operationally coupled to a first one or more non-transitory computer-readable storage devices;
accessing one or more reference data structures, stored in a second one or more computer-readable non-transitory storage media, corresponding to a previously investigated collection of images, wherein at least one image from said collection of images is at least 100 pixels wide in each image dimension, said one or more reference data structures are built by a system comprising:
i. a second one or more computing or data processing devices, operationally or communicatively accessing to the second one or more non-transitory computer-readable storage devices,
ii. having access to said collection of images,
iii. reading one or more image, from said collection of images, and accessing the one or more images data through the second one or more non-transitory computer-readable storage devices,
iv. partitioning each image of said one or more images into at least two groups of partitions wherein each partition of each of said groups is composed of a predefined number of pixels,
v. accessing one or more sets of image partitions wherein each member of each set of said sets of partitions is composed of a predefined number of pixels, wherein said each set of partitions is premade or is obtained by setting the partitions of at least one of the groups of partitions of the one or more images to form one or more sets of partitions wherein each set is assigned with predefined order and each member of each set is composed of predefined number of pixels,
vi. building one or more participation data structures indicating participations of two or more partitions from one set of partitions, having a first order, into two or more partitions from another set of partitions having a second order,
vii. calculating numerically, by the second one or more computing or data processing devices, association strengths between two or more of the partitions from the set of partitions of the first order or partitions from the set of second order, by processing the data of one or more participation data structures, and build a data structure corresponding to association strength spectrum for at least one of the partitions from one of said sets of partitions, assigned with the first or the second predefined order,
viii. calculating numerically, by the second one or more computing or data processing devices and assigning a value significance number to two or more of the partitions of said first order, said value significance is calculated from combinations of one or more measures of significances comprising:
a. frequency or probability of occurrences of a partition of particular order in one or more images,
b. novelty value significances,
c. associational value significances,
d. relational value significances,
e. relational novelty value significance,
f. intrinsic novelty value significance,
g. association novelty value significance,
ix. recognizing one or more parts of the one or more images based on the value significances and association strength of a number of partitions, having certain range of value significances or association strength to each other,
x. selecting one or more partitions of each recognized parts of the one or more images and build a signature data structure, comprise of association spectrums of said one or more selected partitions, corresponding to said each recognized parts of the one or more images,
xi. grouping or clustering said signature data structures of the one or more recognized parts of the one or more images of said collection of images into one or more clusters of signature data structures, by evaluating association strengths between said one or more signature data structures, and storing at least one of the signature data structure for each of said clusters in the second one or more non-transitory storage media, as the one or more reference data structures,
accessing a given image and recognizing one or more parts of the given image by performing the steps of iii to x,
processing the signature data structure of a recognized part of the given image with said one or more reference data structures, and
outputting a state component corresponding to the one or more recognized parts of the given image, whereby a machine can act upon the one or more recognized parts of the given image, thereby giving the machine the ability to visually become aware of its environment.

16. The visual processing system of claim 15, further comprising one or more computing or data processing devices and executable instructions operable to cause the one or more computing or data processing devices to re-scale at least one of the images to a different cell width and cell height.

17. The visual processing system of claim 15, further comprising executable instructions operable to cause the first one or more computing or data processing devices to cluster said one or more images from the collection of images into at least one cluster by calculating association strengths of each of said set of one or more images to each other, based on at least one measure of association strength.

18. The visual processing system of claim 15, further comprising one or more computing or data processing devices and executable instructions operable to cause the first one or more computing or data processing devices, to evaluate or score or rank the relevancy of an input image to a desired target, wherein said desired target is one or more of: an image, a category, a concept, a function, or a signal.

19. The visual processing system of claim 18, further comprising executable instructions operable to cause the first one or more computing or data processing devices, to instruct a machine to perform a task or operations based on said score of relevancy of the input image to one of said desired targets.

20. The visual processing system of claim 15, further comprising computer vision system and executable instructions operable to cause the first one or more computing or data processing devices to calculate novel type of association or novel relational association between the partitions of said one or more images.
